(19) United States
(12) Patent Application Publication
(10) Pub. No.: US 2025/0355263 A1
(43) Pub. Date: Nov. 20, 2025

(54) POSITIONING, STABILISING, AND INTERFACING STRUCTURES AND SYSTEM INCORPORATING SAME

(71) Applicant: RESMED PTY LTD, Bella Vista (AU)

(72) Inventors: Ashley Taylor CONEN, Sydney (AU); Aaron Samuel DAVIDSON, Sydney (AU); Gregory Kendall KNIGHT, Sydney (AU); Ian Andrew LAW, Sydney (AU); Alexander William ROBINSON, Sydney (AU)

(21) Appl. No.: 19/208,957

(22) Filed: May 15, 2025

(30) Foreign Application Priority Data
May 17, 2024 (AU) 2024901453

(51) Int. Cl. G02B 27/01

(52) U.S. Cl. CPC G02B 27/0176; G02B 2027/0156

(57) ABSTRACT

An interfacing structure for a head-mounted display system has a face engaging portion configured to engage around a periphery of the user's eye region; and a chassis portion configured to support the face engaging portion and to connect to a display unit housing. The interfacing structure has cheek portions configured to engage the user's cheeks, a pair of sphenoid portions configured to engage sphenoid regions of the user's head, and a forehead portion configured to engage the user's forehead. The chassis portion defines at least one opening positioned around the periphery of the user's eye region within the user's field of view. The interfacing structure is configured to be convertible between: a non-immersive mode in which the user is able to see through the opening; and an immersive mode in which light is substantially prevented from passing through the opening.

### 1 CROSS-REFERENCE TO RELATED APPLICATIONS

This application claims priority to Australian Patent Application No. 2024901453, filed 17 May 2024, the entire contents of which is hereby incorporated by reference.

### 2 BACKGROUND OF THE TECHNOLOGY

### 2.1 Field of the Technology

The present technology relates generally to head mounted displays, positioning and stabilizing structures, user interfacing structures, and other components for use in head mounted displays, associated head-mounted display assemblies and systems including a display unit and positioning and stabilizing structure, interfacing structures and or components, and methods. The present technology finds particular application in the use of immersive reality head mounted displays and is herein described in that context. It is to be appreciated that the present technology may have broader application and may be used in any type of head-mounted display arrangement including, but not limited to, virtual reality displays, augmented reality displays, and/or mixed reality displays.

### 2.2 Description of the Related Art

It is to be understood that, if any prior art is referred to herein, such reference does not constitute an admission that the prior art forms a part of the common general knowledge in the art, in Australia or any other country.

### 2.2.1 Immersive Technology

An immersive technology refers to technology that attempts to replicate or augment a physical environment through the means of a digital or virtual environment by creating a surrounding sensory feeling, thereby creating a sense of immersion.

In particular, an immersive technology provides the user visual immersion, and creates virtual objects and/or a virtual environment. The immersive technology may also provide immersion for at least one of the other five senses.

### 2.2.2 Virtual Reality

Virtual reality (VR) is a computer-generated three-dimensional image or environment that is presented to a user. In other words, the environment may be entirely virtual. Specifically, the user observes an electronic screen in order to observe virtual or computer generated images in a virtual environment. Since the created environment is entirely virtual, the user may be blocked and/or obstructed from interacting with their physical environment (e.g., they may be unable to hear and/or see the physical objects in the physical environment that they are currently located).

The electronic screen may be supported in the user's line of sight (e.g., mounted to the user's head). While observing the electronic screen, visual feedback output by the electronic screen and observed by the user may produce a virtual environment intended to simulate an actual environment. For example, the user may be able to look around (e.g., 360°) by pivoting their head or their entire body, and interact with virtual objects observable by the user through the electronic screen. This may provide the user with an immersive experience where the virtual environment provides stimuli to at least one of the user's five senses, and replaces the corresponding stimuli of the physical environment while the user uses the VR device. Typically, the stimuli relates at least to the user's sense of sight (i.e., because they are viewing an electronic screen), but other senses may also be included. The electronic screens are typically mounted to the user's head so that they may be positioned in close proximity to the user's eyes, which allows the user to easily observe the virtual environment.

The VR device may produce other forms of feedback in addition to, or aside from, visual feedback. For example, the VR device may include and/or be connected to a speaker in order to provide auditory feedback. The VR device may also include tactile feedback (e.g., in the form of haptic response), which may correspond to the visual and/or auditory feedback. This may create a more immersive virtual environment, because the user receives stimuli corresponding to more than one of the user's senses.

While using a VR device, a user may wish to limit to block ambient stimulation. For example, the user may want to avoid seeing and/or hearing the ambient environment in order to better process stimuli from the VR device in the virtual environment. Thus, VR devices may limit and/or prevent the user's eyes from receiving ambient light. In some examples, this may be done by providing a seal against the user's face. In some examples, a shield may be disposed proximate to (e.g., in contact or close contact with) the user's face, but may not seal against the user's face. In either example, ambient light may not reach the user's eyes, so that the only light observable by the user is from the electronic screen.

In other examples, the VR devices may limit and/or prevent the user's ears from hearing ambient noise. In some examples, this may be done by providing the user with headphones (e.g., noise cancelling headphones), which may output sounds from the VR device and/or limit the user from hearing noises from their physical environment. In some examples, the VR device may output sounds at a volume sufficient to limit the user from hearing ambient noise.

In any example, the user may not want to become overstimulated (e.g., by both their physical environment and the virtual environment). Therefore, blocking and/or limiting the ambient from stimulating the user assists the user in focusing on the virtual environment, without possible distractions from the ambient.

Different types of VR devices are described below. Generally, a single VR device may include at least two different classifications. For example, the VR device may be classified by its portability and by how the display unit is coupled to the rest of the interface. These classifications may be independent, so that classification in one group (e.g., the portability of the unit) does not predetermine classification into another group. There may also be additional categories to classify VR devices, which are not explicitly listed below.

### 2.2.2.1 Portability

### 2.2.2.1.1 Fixed Unit

In some forms, a VR device may be used in conjunction with a separate device, like a computer or video game console. This type of VR device may be fixed, since it cannot be used without the computer or video game console, and thus locations where it can be used are limited (e.g., by the location of the computer or video game console).

### 2.2.2.1.2 Portable Unit

In some forms, the VR device may be a self-contained unit, which includes a power source and sensors, so that the VR device does not need to be connected to a computer or video game console. This provides the user more freedom of use and movement. For example, the user is not limited to using the VR device near a computer or video game console, and could use the VR device outdoors, or in other environments that do not include computers or televisions.

Since the VR device is not connected to a computer or video game console in use, the VR device is required to support all necessary electronic components. This includes batteries, sensors, and processors. These components add weight to the VR device, which the user must support on their body. Appropriate weight distribution may be needed so that this added weight does not increase discomfort to a user wearing the VR device.

In some forms, the electrical components of the VR device are contained in a single housing, which may be disposed directly in front of the user's face, in use. This configuration may be referred to as a “brick.” In this configuration, the center of gravity of the VR device without the positioning and stabilizing structure is directly in front of the user's face. In order to oppose the moment created by the force of gravity, the positioning and stabilizing structure coupled to the brick configuration must provide a force directed into the user's face, for example created by tension in headgear straps. While the brick configuration may be beneficial for manufacturing (e.g., since all electrical components are in close proximity) and may allow interchangeability of positioning and stabilizing structures (e.g., because they include no electrical connections), the force necessary to maintain the position of the VR device (e.g. tensile forces in headgear) may be uncomfortable to the user. Specifically, the VR device may dig into the user's face, leading to irritation and markings on the user's skin. The combination of forces may feel like “clamping” as the user's head receives force from the display housing on their face and force from headgear on the back of their head. This may make a user less likely to wear the VR device.

As VR and other mixed reality devices may be used in a manner involving vigorous movement of the user's head and/or their entire body (for example during gaming), there may be significant forces/moments tending to disrupt the position of the device on the user's head. Simply forcing the device more tightly against the user's head to tolerate large disruptive forces may not be acceptable as it may be uncomfortable for the user or become uncomfortable after only a short period of time.

In some forms, electrical components may be spaced apart throughout the VR device, instead of entirely in front of the user's face. For example, some electrical components (e.g., the battery) may be disposed on the positioning and stabilizing structure, particularly on a posterior contacting portion. In this way, the weight of the battery (or other electrical components) may create a moment directed in the opposite direction from the moment created by the remainder of the VR device (e.g., the display). Thus, it may be sufficient for the positioning and stabilizing structure to apply a lower clamping force, which in turn creates a lower force against the user's face (e.g., fewer marks on their skin). However, cleaning and/or replacing the positioning and stabilizing structure may be more difficult in some such existing devices because of the electrical connections.

In some forms, spacing the electrical components apart may involve positioning some of the electrical components separate from the rest of the VR device. For example, a battery and/or a processor may be electrically connected, but carried separately from the rest of the VR device. Unlike in the “fixed units” described above, the battery and/or processor may be portable, along with the remainder of the VR device. For example, the battery and/or the processor may be carried on the user's belt or in the user's pocket. This may provide the benefit of reduced weight on the user's head, but would not provide a counteracting moment. The tensile force provided by the positioning and stabilizing structure may still be less than the “brick” configuration, since the total weight supported by the head is less.

### 2.2.2.2 Display Connection

### 2.2.2.2.1 Integrated Display Screen

In some forms, the display screen is an integral piece of the VR device, and generally cannot be detached or removed from the rest of the VR device.

The display screen may be fixed within a housing, and protected from damage. For example, the display screen may be completely covered by the housing, which may reduce the occurrence of scratches. Additionally, integrating display screen with the rest of the VR device eliminates the occurrence of losing the display screen.

In these forms, the display screen functions purely as an immersive technology display. The vast majority of “fixed units” will include an integrated display screen. “Portable units” may include an integrated display screen, or may include a removable display screen (described below).

### 2.2.2.2.2 Removable Display Screen

In some forms, the display screen is a separate structure that can be removed from the VR device, and used separately.

In some forms, a portable electronic device (e.g., a cell phone) may be selectively inserted into a housing of the VR device. The portable electronic device may include most or all of the sensors and/or processors, and may create a virtual environment through a downloadable app.

Portable electronic devices are generally light weight, and may not require the positioning and stabilizing structure to apply a large force to the user's head.

### 2.2.3 Augmented Reality

In some forms, augmented reality (AR) is a computer-generated three-dimensional image or environment that is presented to a user.

While similar to VR, AR differs in that the virtual environment created at least in part by the electronic screen is observed in combination with the user's physical environment. In other words, AR creates virtual objects in order to alter and/or enhance the user's physical environment with elements of a virtual environment. The result of AR is a combined environment that includes physical and virtual objects, and therefore an environment that is both physical and virtual.

For example, images created by the electronic screen may be overlayed into the user's physical environment. Only a portion of an AR combination environment presented to the user includes is virtual. Thus, the user may wish to continue to receive ambient stimulation from their physical environment while using an AR device (e.g., in order to continue to observe the physical or non-virtual component of the combination environment).

Since AR may be used with the user's physical environment, an AR device may not be electrically connected, or otherwise tethered, to a computer or video game console. Instead the AR device may include a battery, or other power source. This may provide the user with the greatest freedom of movement, so that they can explore a variety of physical environments while using the AR device.

This key difference between VR and AR may lead to different types of wearable electronic screens. As described above, a user of a VR device may wish to block ambient light, so the housing of the electronic screen may be opaque in order to limit or prevent ambient light from reaching the user. However, the user of an AR device may want to see the virtual environment blended with their actual environment. The electronic screen in an AR device may be similarly supported in front of the user's eyes, but, screens in AR devices may be transparent or translucent, and the screens may not be supported by an opaque housing (or opaque material may not substantially obstruct the user's line of sight). This may allow the user to continue receiving ambient stimulation, where the virtual environment is simultaneously present. Notwithstanding, some VR devices that do not have a transparent screen through which the user can see their real world surroundings may be configurable for AR by acquiring real-time video of the user's real-world surroundings from the user's perspective (e.g. with cameras on the display housing) and displaying it on the display screen.

Additionally, a person using an AR device may be more mobile than a person using a VR device (e.g., because an AR user can see their physical environment and/or are not tethered to a computer or video game console). Thus, a person using an AR device may wish to wear the device for an extended period of time, while also moving around (e.g., walking, running, biking, etc.). Including components, like batteries, on the AR device may make the AR device uncomfortable for the user's head and/or neck, and may discourage the user from wearing the AR device for long periods of time.

### 2.2.4 Mixed Reality

Mixed reality (MR) is similar to AR but may be more immersive because the MR device may provide the user more ways to interact with virtual objects or environment than an AR device. The virtual reality in MR may also be overlayed and/or blended with the user's physical environment. Unlike AR however, a user may be able to interact with the virtual environment akin to what occurs in VR. In other words, while AR may present only an computer generated image in the physical environment, MR may present the user with the same or similar computer generated image but allow for interaction with the image in the physical environment (e.g., using a hand to “grab” an object produced virtually). Thus, the virtual environment may further merge with a physical environment so that the combined environment better replicates an actual environment.

### 2.2.5 Head-Mounted Display Interface

A head-mounted display interface enables a user to have an immersive experience of a virtual environment and have broad application in fields such as communications, training, medical and surgical practice, engineering, and video gaming.

Different head-mounted display interfaces can each provide a different level of immersion. For example, some head-mounted display interfaces can provide the user with a total immersive experience. One example of a total immersive experience is virtual reality (VR). The head-mounted display interface can also provide partial immersion consistent with using an AR device.

VR head-mounted display interfaces typically are provided as a system that includes a display unit which is arranged to be held in an operational position in front of a user's face. The display unit typically includes a housing containing a display and a user interface structure constructed and arranged to be in opposing relation with the user's face. The user interface structure may extend about the display and define, in conjunction with the housing, a viewing opening to the display. The user interfacing structure may engage with the face and include a cushion for user comfort and/or be light sealing to block ambient light from the display. The head-mounted display system further comprises a positioning and stabilizing structure that is disposed on the user's head to maintain the display unit in position.

Other head-mounted display interfaces can provide a less than total immersive experience. In other words, the user can experience elements of their physical environment, as well as a virtual environment. Examples of a less than total immersive experience are augmented reality (AR) and mixed reality (MR).

AR and/or MR head-mounted display interfaces are also typically provided as a system that includes a display unit which is arranged to be held in an operational position in front of a user's face. Likewise, the display unit typically includes a housing containing a display and a user interface structure constructed and arranged to be in opposing relation with the user's face. The head-mounted display system of the AR and/or MR head-mounted display is also similar to VR in that it further comprises a positioning and stabilizing structure that is disposed on the user's head to maintain the display unit in position. However, AR and/or MR head-mounted displays do not include a cushion that totally seals ambient light from the display, since these less than total immersive experience require an element of the physical environment. Instead, head-mounted displays in augmented and/or mixed allow the user to see the physical environment in combination with the virtual environment.

In any types of immersive technology, it is important that the head-mounted display interface is comfortable in order to allow the user to wear the head-mounted display for extended periods of time. Additionally, it is important that the display is able to provide changing images with changing position and/or orientation of the user's head in order to create an environment, whether partially or entirely virtual, that is similar to or replicates one that is entirely physical.

### 2.2.5.1 Interfacing Structure

The head-mounted displays may include a user interfacing structure. Since it is in direct contact with the user's face, the shape and configuration of the interfacing portion can have a direct impact on the effectiveness and comfort of the display unit.

The design of a user interfacing structure presents a number of challenges. The face has a complex three-dimensional shape. The size and shape of noses and heads varies considerably between individuals. Since the head includes bone, cartilage and soft tissue, different regions of the face respond differently to mechanical forces.

One type of interfacing structure extends around the periphery of the display unit and is intended to seal against the user's face when force is applied to the user interface with the interfacing structure in confronting engagement with the user's face. The interfacing structure may include a pad made of a polyurethane (PU). With this type of interfacing structure, there may be gaps between the interfacing structure and the face, and additional force may be required to force the display unit against the face in order to achieve the desired contact.

The regions not engaged at all by the user interface may allow gaps to form between the facial interface and the user's face through which undesirable light pollution may ingress into the display unit (e.g., particularly when using virtual reality). The light pollution or “light leak” may decrease the efficacy and enjoyment of the overall immersive experience for the user. In addition, previous systems may be difficult to adjust to enable application for a wide variety of head sizes. Further still, the display unit and associated stabilizing structure may often be relatively heavy and may be difficult to clean which may thus further limit the comfort and useability of the system.

Another type of interfacing structure incorporates a flap seal of thin material positioned about a portion of the periphery of the display unit so as to provide a sealing action against the face of the user. Like the previous style of interfacing structure, if the match between the face and the interfacing structure is not good, additional force may be required to achieve a seal, or light may leak into the display unit in-use. Furthermore, if the shape of the interfacing structure does not match that of the user, it may crease or buckle in-use, giving rise to undesirable light penetration.

A user interface may be partly characterised according to the design intent of where the interfacing structure is to engage with the face in-use. Some interfacing structures may be limited to engaging with regions of the user's face that protrude beyond the arc of curvature of the face engaging surface of the interfacing structure. These regions may typically include the user's forehead and cheek bones. This may result in user discomfort at localised stress points. Other facial regions may not be engaged at all by the interfacing structure or may only be engaged in a negligible manner that may thus be insufficient to increase the translation distance of the clamping pressure. These regions may typically include the sides of the user's face, or the region adjacent and surrounding the users nose. To the extent to which there is a mismatch between the shape of the users' face and the interfacing structure, it is advantageous for the interfacing structure or a related component to be adaptable in order for an appropriate contact or other relationship to form.

### 2.2.5.2 Positioning and Stabilizing

To hold the display unit in its correct operational position, the head-mounted display system further comprises a positioning and stabilizing structure that is disposed on the user's head. These structures may be responsible for providing forces to counter gravitational forces of the head-mounted display and/or interfacing structure. In the past these structures have been formed from expandable rigid structures that are typically applied to the head under tension to maintain the display unit in its operational position. Such systems have been prone to exert a clamping pressure on the user's face which can result in user discomfort at localised stress points. Also, previous systems may be difficult to adjust to allow wide application head sizes. Further, the display unit and associated stabilizing structure are often heavy, difficult to clean which further limit the comfort and useability of the system.

Certain other head mounted display systems may be functionally unsuitable for the present field. For example, positioning and stabilizing structures designed for ornamental and visual aesthetics may not have the structural capabilities to maintain a suitable pressure around the face. For example, an excess of clamping pressure may cause discomfort to the user, or alternatively, insufficient clamping pressure on the users' face may not effectively seal the display from ambient light.

Certain other head mounted display systems may be uncomfortable or impractical for the present technology. For example, if the system is used for prolonged time periods.

As a consequence of these challenges, some head mounted displays suffer from being one or more of obtrusive, aesthetically undesirable, costly, poorly fitting, difficult to use, and uncomfortable especially when worn for long periods of time or when a user is unfamiliar with a system. Wrongly sized positioning and stabilizing structures can give rise reduced comfort and in turn, shortened periods of use.

Therefore, an interfacing portion of a user interface used for the fully immersive experience of a virtual environment are subject to forces corresponding to the movement of a user during the experience.

### 2.2.5.3 Materials

Materials used in head mounted display assemblies have included dense foams for contacting portions in the interfacing structures, rigid shells for the housings, and positioning and stabilizing structures formed from rigid plastic clamping structures. These materials have various drawbacks including not permitting the skin covered by the material to breath, being inflexible, difficult to clean and to prone trapping bacteria. As a result, products made with such material may be uncomfortable to wear for extended periods of time, causes skin irritation in some individuals and limit the application of the products.

### 3 BRIEF SUMMARY OF THE TECHNOLOGY

The present technology may be directed toward providing positioning and stabilizing structures used in the supporting, stabilizing, mounting, utilizing, and/or securing of a head-mounted display having one or more of improved comfort, cost, efficacy, ease of use and manufacturability.

A first aspect of the present technology relates to apparatuses used in the supporting, stabilizing, mounting, utilizing, and/or securing of a head-mounted display.

Another aspect of the present technology relates to methods used in the supporting, stabilizing, mounting, utilizing, and/or securing of a head-mounted display.

Another aspect is a positioning and stabilizing structure for a head-mounted display that comprising a rear (or posterior) support structure (or portion) arranged, in use, to contact a posterior region of the user's head.

In some forms, the posterior support portion or at least a portion thereof is disposed posterior of the otobasion superior of the user.

In some forms, the posterior support portion is biased into contact with the occipital region of the user.

In some forms, the positioning and stabilizing structure further comprises opposing connectors that are disposed on opposing sides of, and extending along the temporal regions of, the user's head to interconnect the posterior support portion to the head-mounted display unit. In some forms the positioning and stabilising structure comprises an anterior support portion connecting the posterior support portion to the head-mounted display unit.

The present technology may also be directed toward providing interfacing structures used in the supporting, cushioning, stabilizing, positioning, and/or sealing a head-mounted display in opposing relation with the user's face.

Another aspect relates to apparatuses used in the supporting, cushioning, stabilizing, positioning, and/or sealing a head-mounted display in opposing relation with the user's face.

Another aspect relates to methods used in supporting, cushioning, stabilizing, positioning, and/or sealing a head-mounted display in opposing relation with the user's face.

Another aspect of the present technology comprises an interfacing structure for a head-mounted display system, the interfacing structure configured to attach to a display unit housing of the head-mounted display system comprising a display, the interfacing structure comprising:
a face engaging portion constructed and arranged to engage a user's face around a periphery of the user's eye region in use;
a chassis portion constructed and arranged to support the face engaging portion and constructed and arranged to connect to the display unit housing of the head-mounted display system,
wherein interfacing structure comprises a pair of cheek portions constructed and arranged to engage the user's cheeks in use, a pair of sphenoid portions constructed and arranged to engage sphenoid regions of the user's head in use, and a forehead portion constructed and arranged to engage the user's forehead in use;
wherein the chassis portion defines at least one opening positioned around the periphery of the user's eye region within the user's field of view;
wherein the interfacing structure is constructed and arranged to be convertible between:
   a non-immersive mode in which the user is able to see through the opening; and
   an immersive mode in which light is substantially prevented from passing through the opening.

In examples:
the interfacing structure comprises at least one shield constructed and arranged to block light through the at least one opening, the shield being able to be manipulated by the user to convert the interfacing structure to the non-immersive mode by substantially unblocking the opening and convert the interfacing structure to the immersive mode by substantially blocking the opening;
the shield is attachable to the chassis portion to convert the interfacing structure to the immersive mode, and the shield is removable from the chassis portion to convert the interfacing structure to the non-immersive mode;
the shield is substantially rigid;
the shield is constructed and arranged to form a snap fit connection to the chassis portion during attachment to the chassis portion;
the chassis portion and shield are constructed and arranged so that the shield is magnetically attracted to the chassis portion;
the chassis portion and the shield are constructed and arranged so that the shield is magnetically attracted to the chassis portion at opposite ends of the shield;
the shield comprises at least one magnet positioned to be attracted to a corresponding magnet or ferromagnetic component in or on the chassis portion;
the shield comprises at least one grip portion to aid gripping of the shield by the user;
the grip portion is at least partially formed by a curved portion of the shield forming a ledge able to be gripped by the user;
the curved portion comprises a concave portion;
the shield comprises a pair of grip portions each provided at a respective end of the shield configured to aid the user in gripping the shield with a thumb and forefinger;
the grip portion is at least partially formed by a vent constructed and arranged to allow airflow through the opening when the interfacing structure is in the immersive mode; and/or
the grip portion is at least partially formed by a plurality of vent holes.

In examples:
the shield comprises at least one vent constructed and arranged to allow airflow through the opening when the interfacing structure is in the closed configuration;
the shield comprises a plurality of vents;
the at least one vent is formed by at least one vent hole formed in the shield;
the interfacing structure comprises a vent cover portion constructed and arranged to block light through the at least one vent;
the shield comprises the vent cover portion;
the at least one vent is formed by a plurality of vent holes;
the shield and the chassis portion together define at least one vent opening between the chassis portion and an edge of the shield in the closed configuration, the at least one vent opening forming the at least one vent;
the shield is larger than the opening;
the shield and the chassis portion together form a tortuous path in the closed configuration to allow airflow through the vent while blocking light;
the shield comprises at least one shield protrusion protruding towards the chassis portion to at least partially form the tortuous path; and/or
the chassis portion comprises at least one chassis protrusion protruding towards the shield to at least partially form the tortuous path.

In examples:
the at least one opening comprises a group of openings, the shield constructed and arranged to block light through the group of openings;
the chassis portion comprises one or more bars, each of the one or more bars positioned between and partially defining the openings of the group of openings;
the one or more bars comprise a plurality of bars defining a lattice structure; and/or
the lattice structure is a hexagonal lattice structure.

In examples:
the shield comprises a curtain attached to the chassis portion, at least a portion of the curtain being slidable with respect to the chassis portion to substantially block the opening during conversion of the interfacing structure to the immersive mode and substantially unblock the opening during conversion of the interfacing structure to the non-immersive mode;
the curtain is formed from a textile material;
the curtain is breathable;
the curtain is opaque;
the curtain is elastically stretchable;
the shield is slidable with respect to the chassis portion and is constructed and arranged to be moved to substantially block the opening during conversion of the interfacing structure to the immersive mode and substantially unblock the opening during conversion of the interfacing structure to the non-immersive mode;
the shield comprises one or more rotatable portions rotatably connected to the chassis portion, the one or more rotatable portions being rotatable to a closed configuration to convert the interfacing structure to the immersive mode, and the one or more rotatable portions being rotatable to an open configuration to convert the interfacing structure to the non-immersive mode;
the shield comprises a hinged door openable to convert the interfacing structure to the non-immersive mode and closeable to convert the interfacing structure to the immersive mode;
the hinged door is constructed to fold in on itself so as to be secure in the non-immersive mode; and/or
the opening is filled by an electronic screen, the screen being controllable to be opaque in the immersive mode and substantially transparent in the non-immersive mode.

In examples:
the at least one opening is located in the forehead portion of the interfacing structure;
the at least one opening is located in one of the sphenoid portions of the interfacing structure;
the at least one opening comprises a pair of openings each located in a respective one of the sphenoid portions;
the at least one opening is located in one of the cheek portions of the interfacing structure;
the at least one opening comprises a pair of openings each located in a respective one of the cheek portions;
the at least one opening comprises a lower left opening and a lower right opening, the lower left opening being located in a left cheek portion of the cheek portions and a left sphenoid portion of the sphenoid portions, the lower right opening being located in a right cheek portion of the cheek portions and a right sphenoid portion of the sphenoid portions;
there is no opening in the chassis portion in the forehead portion of the interfacing structure; and/or
there is no opening in chassis portion of the interfacing structure superior to the user's eyes.

Another aspect of the present technology comprises an interfacing structure for a head-mounted display system, the interfacing structure configured to attach to a display unit housing of the head-mounted display system comprising a display, the interfacing structure comprising:
a face engaging portion constructed and arranged to engage a user's face around a periphery of the user's eye region in use;
a chassis portion constructed and arranged to support the face engaging portion and constructed and arranged to connect to the display unit housing of the head-mounted display system,
wherein interfacing structure comprises a pair of cheek portions constructed and arranged to engage the user's cheeks in use, a pair of sphenoid portions constructed and arranged to engage sphenoid regions of the user's head in use, and a forehead portion constructed and arranged to engage the user's forehead in use;
wherein the interfacing structure comprises a nasal portion configured to engage the user's nose, the nasal portion being removable and the interfacing structure being constructed and arranged to be convertible between:
   a non-immersive mode in which the nasal portion is removed from the interfacing structure; and
   an immersive mode in which the nasal portion is attached to the interfacing structure between the cheek portions to engage the user's nose in use and substantially block light from reaching the user's eyes from the user's nose region.

In examples:
the nasal portion of the interfacing structure comprises a nasal face engaging portion and a nasal chassis portion, the nasal chassis portion being constructed to connect to the chassis portion of the interfacing structure to attach the nasal portion to the interfacing structure during conversion to the immersive mode;
the nasal face engaging portion is formed from an elastomeric material;
the nasal chassis portion is substantially rigid;
the nasal portion comprises lateral sides which are shaped and sized to align with the cheek portions in the immersive mode to substantially prevent light passing between the nasal portion and the cheek portions;
the nasal portion comprises an inferior portion positioned proximate the user's pronasale in use;
the inferior portion comprises a concave anteriorly-facing surface;
the inferior portion is dome shaped;
the nasal portion comprises a first flap and a second flap each connected to the inferior portion, the first flap configured to engage a first lateral side of the user's nose in use and the second flap configured to engage a second lateral side of the user's nose in use, the first flap and the second flap being separated by a slot;
the nasal portion is constructed and arranged to contact the user's nose along the nasal ridge;
the nasal portion is constructed and arranged to contact a majority of the user's nasal ridge in use;
the nasal portion is constructed and arranged to extend in an at least partially superior direction at least partially between the user's pronasale and sellion;
and/or
the nasal portion is formed from an elastomeric material.

Another aspect of the present technology relates to a head-mounted display system, comprising:
a head-mounted display unit comprising a display unit housing comprising a display, the head-mounted display unit further comprising an interfacing structure attached to the display unit housing; and
a positioning and stabilising structure structured and arranged to hold the head-mounted display unit in an operable position on the user's head in use,
wherein the head-mounted display unit comprises an interfacing structure according to any one of the aspects or examples above.

Another aspect of the present technology comprises an interfacing structure for a head-mounted display system, the interfacing structure configured to attach to a display unit housing of the head-mounted display system comprising a display, the interfacing structure comprising:
a face engaging portion constructed and arranged to engage a user's face around a periphery of the user's eye region in use;
a chassis portion constructed and arranged to support the face engaging portion,
one or more clips formed separately from the chassis portion;
wherein the one or more clips are attached to the chassis portion and configured to attach the interfacing structure to the display unit housing in use.

In examples:
each of the one or more clips is permanently attached to the chassis portion;
each of the one or more clips is removably attached to the chassis portion;
each of the one or more clips is formed from a thermoplastic material;
each of the one or more clips is formed from metal;
each of the one or more clips comprises a magnet and is configured to magnetically attach to a corresponding magnet or ferromagnetic material provided to the display unit housing;
the chassis portion is formed from a different material to the face engaging portion;
the chassis portion is stiffer than the face engaging portion;
the interfacing structure comprises one or more clip attachment assemblies, each of the one or more clip attachment assemblies comprising a clip attachment portion and a respective one of the one or more clips attached to the clip attachment portion;
in each clip attachment assembly, the clip attachment portion comprises a clip receptacle configured to receive the clip therein;
in each clip attachment assembly, each clip is attached to the clip attachment portion by a pin;
in each clip attachment assembly, the pin is located through a hole in the chassis portion and through a hole in the clip;
each clip and/or pin are glued to the chassis portion;
each clip comprises a first barb configured to form a snap fit connection to the display unit housing;
each clip comprises a second barb configured to form a snap fit connection to the chassis portion;
the interfacing structure comprises at least one clip attached in use to a superior portion of the chassis portion and at least one clip attached in use to an inferior portion of the chassis portion;
the interfacing structure comprises a pair of clips attached in use to a superior portion of the chassis portion;
the interfacing structure comprises a pair of clips attached in use to an inferior portion of the chassis portion;
the face engaging portion comprises a face engaging membrane;
the face engaging membrane is overmoulded to the chassis portion;
the face engaging membrane is formed from an elastomeric material;
the face engaging portion comprises a cushion, the face engaging membrane shaped in transverse cross section to curl at least partially around the cushion; and/or
the cushion is formed from foam.

Another aspect of the present technology relates to a head-mounted display system, comprising:
a head-mounted display unit comprising a display unit housing comprising a display, the head-mounted display unit further comprising an interfacing structure attached to the display unit housing in use, the interfacing structure being constructed and arranged to be in opposing relation to the user's face and provided around a periphery of the user's eye region in use; and
a positioning and stabilising structure structured and arranged to hold the head-mounted display unit in an operable position on the user's head in use,
wherein the interfacing structure comprises:
   a chassis portion;
   a face engaging portion attached to the chassis portion, the face engaging portion being flexible and resilient and configured to engage the user's face in use; and
   one or more clips formed separately from the chassis portion;
   wherein the one or more clips are attached to the chassis portion and configured to attach the interfacing structure to the display unit housing in use.

Another form of the present technology comprises a head mounted display system for a person comprising:
a head-mounted display unit comprising a display;
a control system for operation of the head-mounted display system; and
a positioning and stabilizing structure configured to configured to hold the head-mounted display unit anterior to a user's eyes such that the display is viewable by the user in use.

The head-mounted display system may be helmet mounted, may be configured for virtual reality display, may be configured for augmented reality display, may be configured for mixed reality display.

Another form of the present technology comprises a head-mounted display system for a person comprising:
a head-mounted display unit comprising a display;
a control system for operation of the head-mounted display system; and
a positioning and stabilizing structure comprising an anterior support portion and a posterior support portion, wherein:
   the posterior portion is configured to engage in use a posterior region of the person's head;
   the anterior support portion comprises:
      a left lateral portion configured to interconnect the posterior support portion and the head-mounted display system; and
   a right lateral portion configured to interconnect the posterior portion and the head-mounted display system.

In some examples: a) the head mounted display apparatus further comprises a light shield; b) the light shield is constructed and arranged to substantially obstruct in use the receipt of ambient light upon an eye region of the person; c) the light shield is configured for use in virtual reality display; d) the head-mounted display system comprises an interfacing structure constructed and arranged to contact in use an eye region of the person's face; e) the interfacing structure is constructed from foam, silicone, and/or gel; f) the interfacing structure is constructed from a light absorbing material; and/or g) the interfacing structure is configured to function as a light shield.

Another aspect of one form of the present technology is a positioning and stabilizing structure that is constructed with a shape which is complementary to that of an intended wearer.

Another aspect of one form of the present technology is an interfacing structure that is constructed with a shape which is complementary to that of an intended wearer.

The methods, systems, devices and apparatus described may be implemented so as to improve the functionality of a head-mounted display, such as an electronic display or computer. Moreover, the described methods, systems, devices and apparatus can provide improvements in the technological field of virtual reality, augmented reality, and/or mixed reality.

Of course, portions of the aspects may form sub-aspects of the present technology. Also, various ones of the sub-aspects and/or aspects may be combined in various manners and also constitute additional aspects or sub-aspects of the present technology.

Other features of the technology will be apparent from consideration of the information contained in the following detailed description, abstract, drawings and claims.

### 4 BRIEF DESCRIPTION OF THE DRAWINGS

The present technology is illustrated by way of example, and not by way of limitation, in the figures of the accompanying drawings, in which like reference numerals refer to similar elements including:

### 4.1 Head-Mounted Display Systems

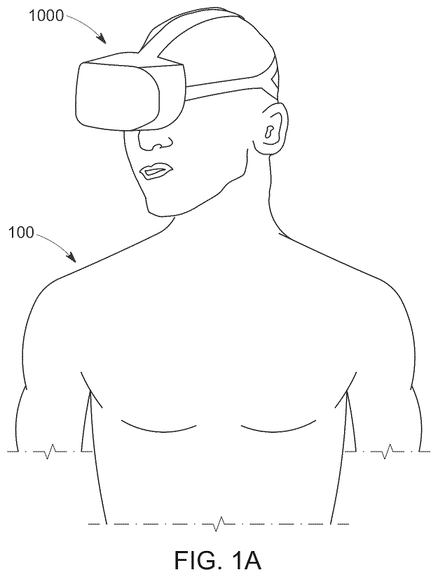

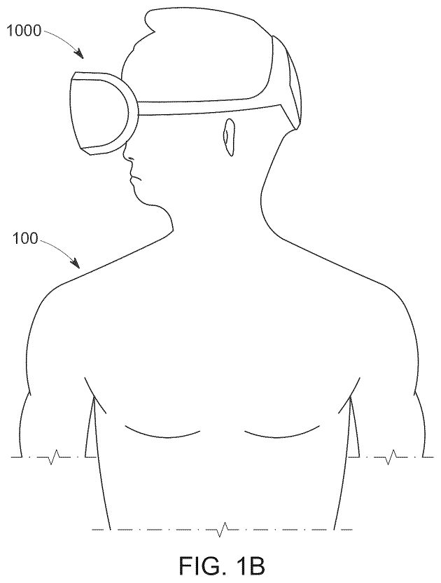

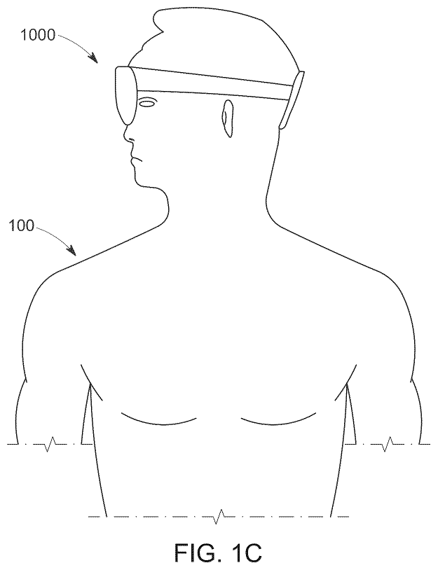

FIG. 1A shows a system including a user 100 wearing a head-mounted display system 1000, in the form of a face-mounted, virtual reality (VR) headset, displaying various images to the user 100. The user is standing while wearing the head-mounted display system 1000.

FIG. 1B shows a system including a user 100 wearing a head-mounted display system 1000, in the form of a floating virtual reality (VR) headset, displaying various images to the user. The user is sitting while wearing the display interface 100.

FIG. 1C shows a system including a user 100 wearing a head-mounted display system 1000, in the form of a floating augmented reality (AR) headset, displaying various images to the user. The user is standing while wearing the head-mounted display system 1000.

### 4.2 Display System and Facial Anatomy

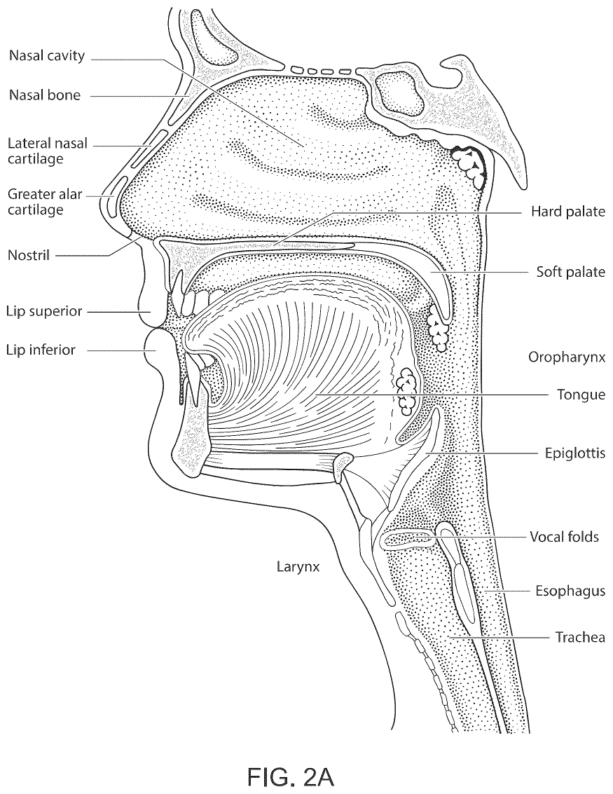

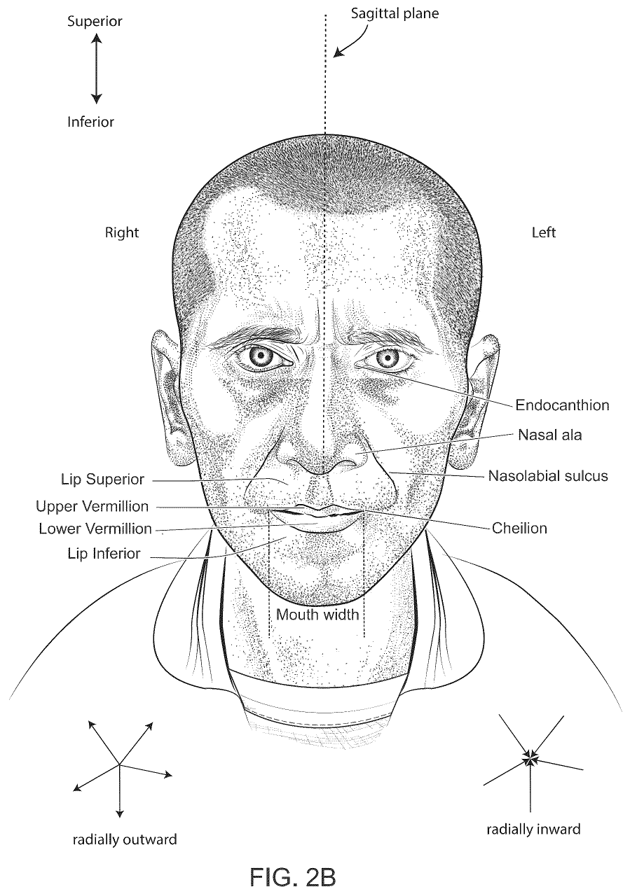

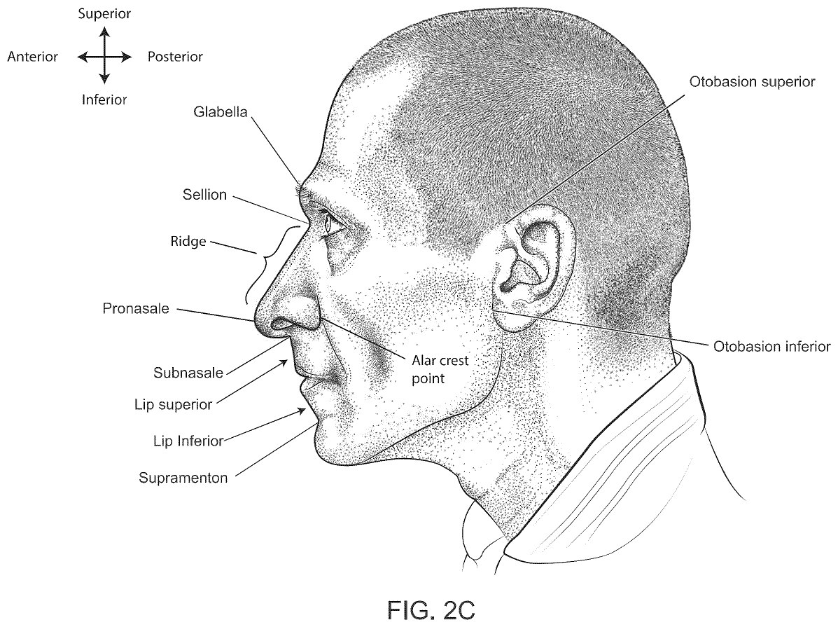

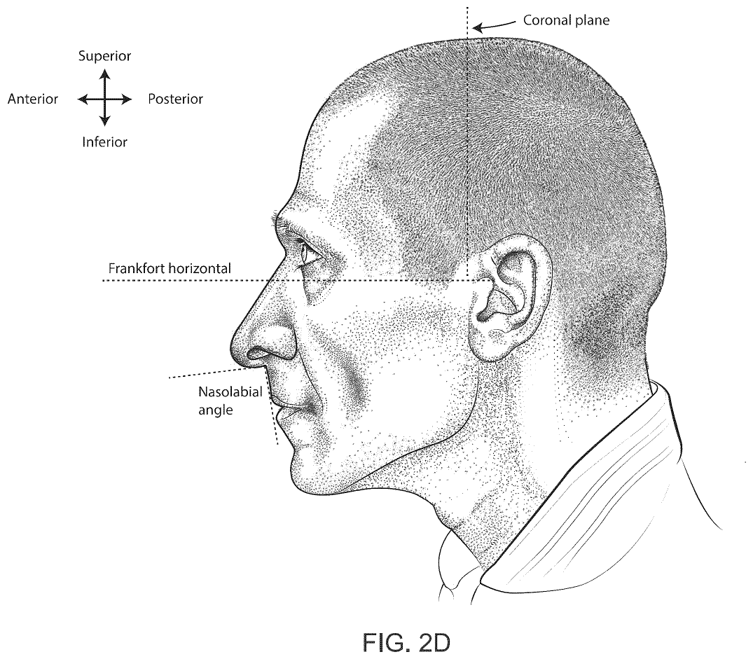

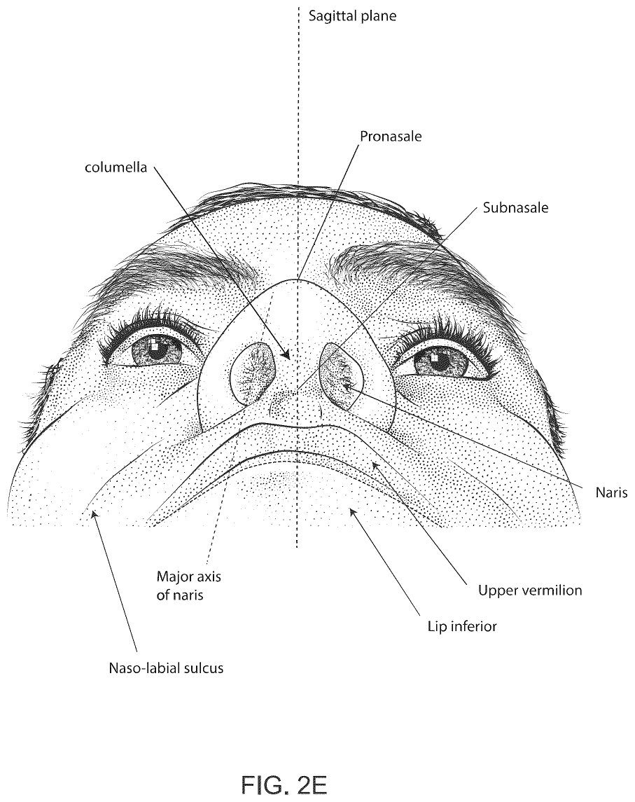

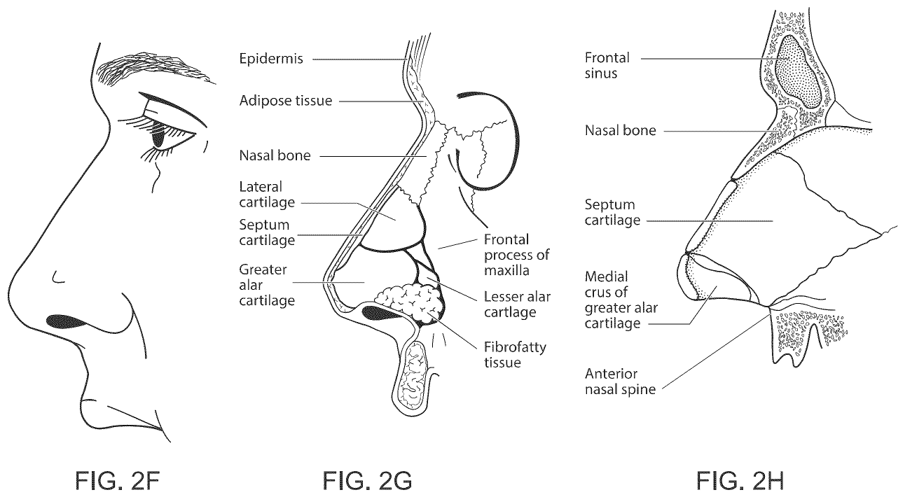

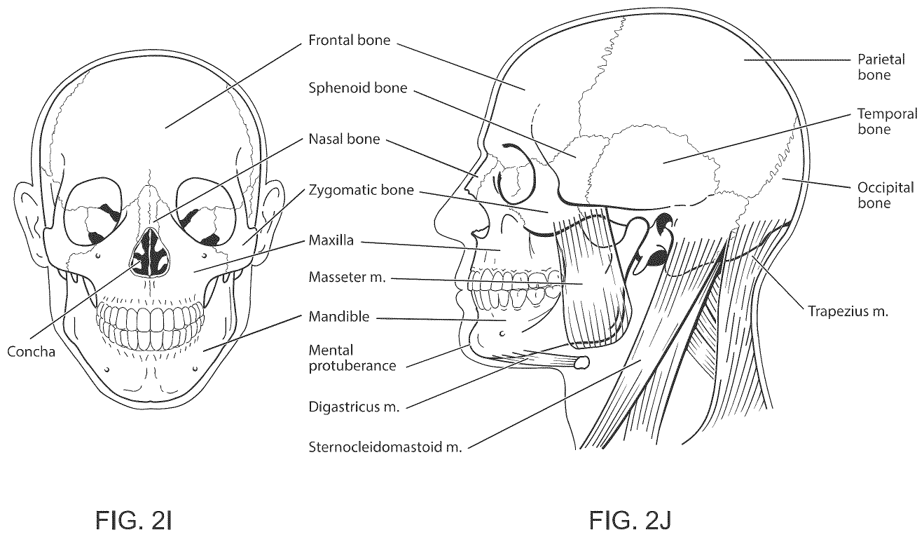

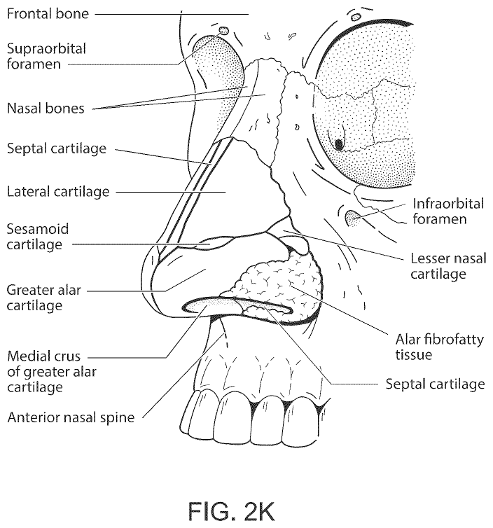

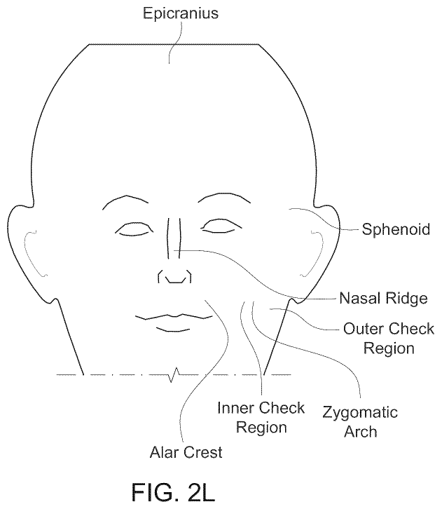

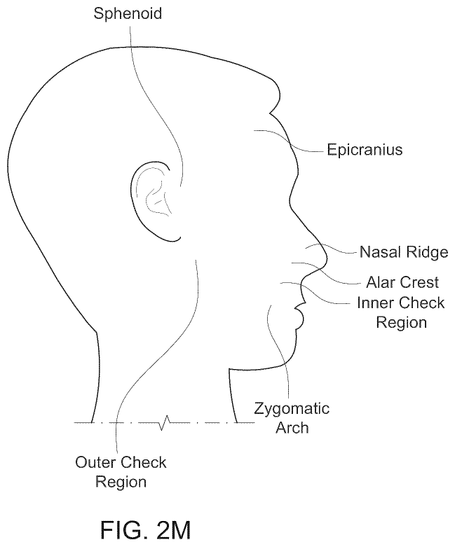

FIG. 2A shows a view of a human upper airway including the nasal cavity, nasal bone, lateral nasal cartilage, greater alar cartilage, nostril, lip superior, lip inferior, larynx, hard palate, soft palate, oropharynx, tongue, epiglottis, vocal folds, oesophagus and trachea.

FIG. 2B is a front view of a face with several features of surface anatomy identified including the lip superior, upper vermilion, lower vermilion, lip inferior, mouth width, endocanthion, a nasal ala, nasolabial sulcus and cheilion. Also indicated are the directions superior, inferior, radially inward and radially outward.

FIG. 2C is a side view of a head with several features of surface anatomy identified including glabella, sellion, pronasale, subnasale, lip superior, lip inferior, supramenton, nasal ridge, alar crest point, otobasion superior and otobasion inferior. Also indicated are the directions superior & inferior, and anterior & posterior.

FIG. 2D is a further side view of a head. The approximate locations of the Frankfort horizontal and nasolabial angle are indicated. The coronal plane is also indicated.

FIG. 2E shows a base view of a nose with several features identified including naso-labial sulcus, lip inferior, upper Vermilion, naris, subnasale, columella, pronasale, the major axis of a naris and the midsagittal plane.

FIG. 2F shows a side view of the superficial features of a nose.

FIG. 2G shows subcutaneal structures of the nose, including lateral cartilage, septum cartilage, greater alar cartilage, lesser alar cartilage, sesamoid cartilage, nasal bone, epidermis, adipose tissue, frontal process of the maxilla and fibrofatty tissue.

FIG. 2H shows a medial dissection of a nose, approximately several millimeters from the midsagittal plane, amongst other things showing the septum cartilage and medial crus of greater alar cartilage.

FIG. 2I shows a front view of the bones of a skull including the frontal, nasal and zygomatic bones. Nasal concha are indicated, as are the maxilla, and mandible.

FIG. 2J shows a lateral view of a skull with the outline of the surface of a head, as well as several muscles. The following bones are shown: frontal, sphenoid, nasal, zygomatic, maxilla, mandible, parietal, temporal and occipital. The mental protuberance is indicated. The following muscles are shown: digastricus, masseter, sternocleidomastoid and trapezius.

FIG. 2K shows an anterolateral view of a nose. The following bones are shown: frontal, supraorbital foramen, nasal, septal cartilage, lateral cartilage, orbit and infraorbital foramen.

FIG. 2L shows another front view of the face with several features of surface anatomy identified including the epicranius, the sphenoid, the nasal ridge, the outer and inner cheek regions, the zygomatic arch, and the alar crest.

FIG. 2M shows another side view of the face with several features of surface anatomy identified including the epicranius, the sphenoid, the nasal ridge, the outer and inner cheek regions, the zygomatic arch, and the alar crest.

### 4.3 Shape of Structures

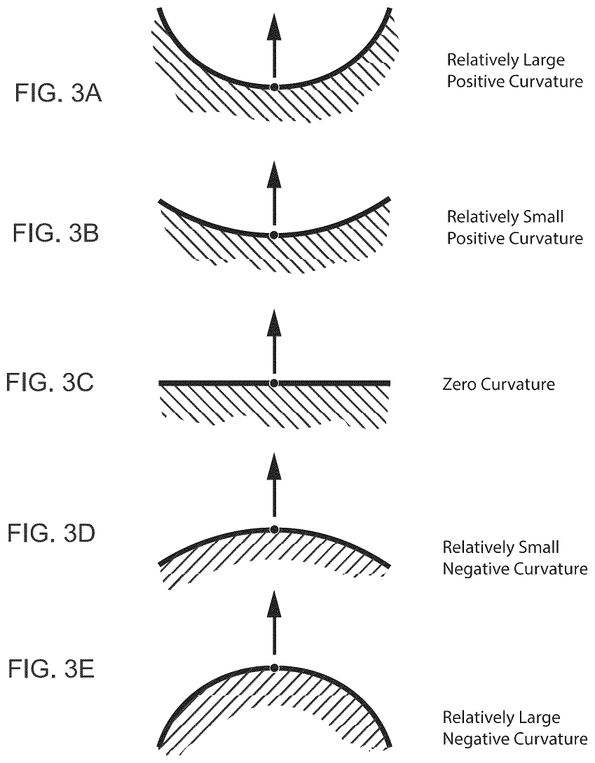

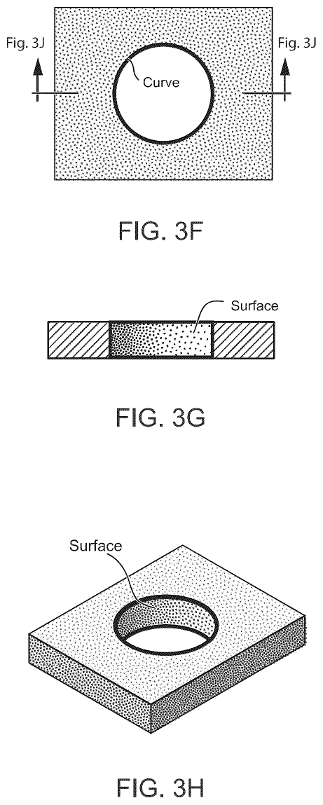

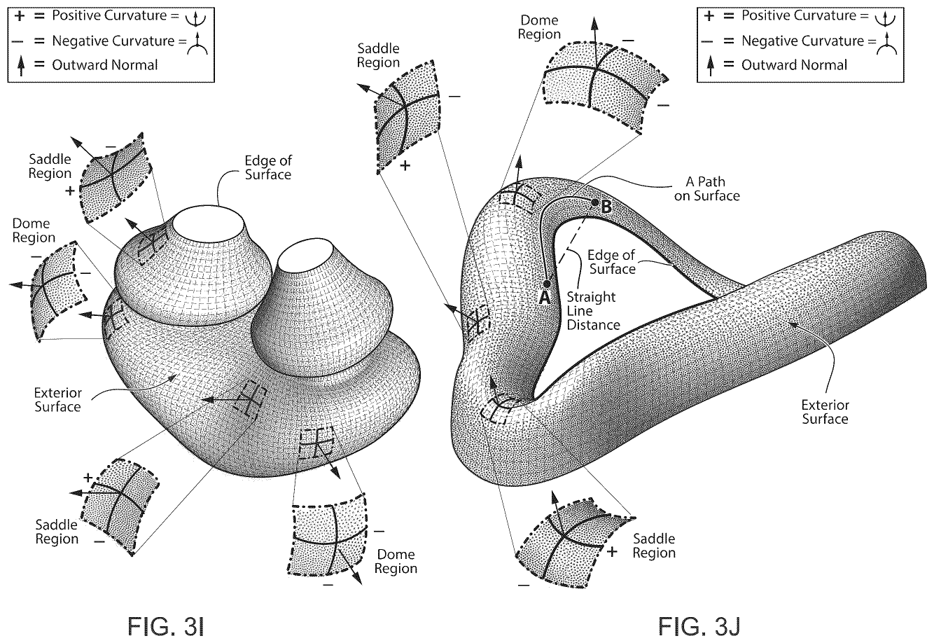

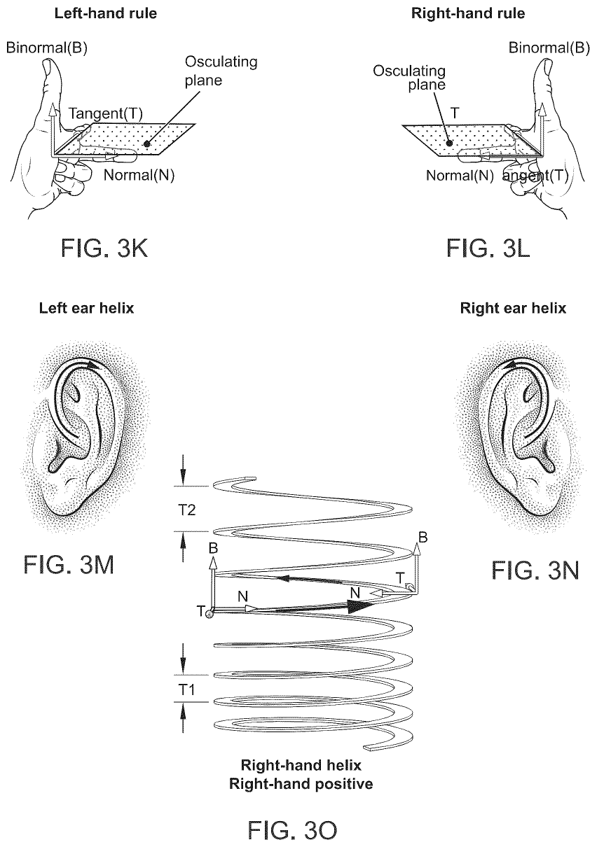

FIG. 3A shows a schematic of a cross-section through a structure at a point. An outward normal at the point is indicated. The curvature at the point has a positive sign, and a relatively large magnitude when compared to the magnitude of the curvature shown in FIG. 3B.

FIG. 3B shows a schematic of a cross-section through a structure at a point. An outward normal at the point is indicated. The curvature at the point has a positive sign, and a relatively small magnitude when compared to the magnitude of the curvature shown in FIG. 3A.

FIG. 3C shows a schematic of a cross-section through a structure at a point. An outward normal at the point is indicated. The curvature at the point has a value of zero.

FIG. 3D shows a schematic of a cross-section through a structure at a point. An outward normal at the point is indicated. The curvature at the point has a negative sign, and a relatively small magnitude when compared to the magnitude of the curvature shown in FIG. 3E.

FIG. 3E shows a schematic of a cross-section through a structure at a point. An outward normal at the point is indicated. The curvature at the point has a negative sign, and a relatively large magnitude when compared to the magnitude of the curvature shown in FIG. 3D.

FIG. 3F shows the surface of a structure, with a one dimensional hole in the surface. The illustrated plane curve forms the boundary of a one dimensional hole.

FIG. 3G shows a cross-section through the structure of FIG. 3F. The illustrated surface bounds a two dimensional hole in the structure of FIG. 3F.

FIG. 3H shows a perspective view of the structure of FIG. 3F, including the two dimensional hole and the one dimensional hole. Also shown is the surface that bounds a two dimensional hole in the structure of FIG. 3F.

FIGS. 3I-3J shows a seal forming structure. An exterior surface of the cushion is indicated. An edge of the surface is indicated. A path on the surface between points A and B is indicated. A straight-line distance between A and B is indicated. Two saddle regions and a dome region are indicated.

FIG. 3K illustrates a left-hand rule.

FIG. 3L illustrates a right-hand rule.

FIG. 3M shows a left ear, including the left ear helix.

FIG. 3N shows a right ear, including the right ear helix.

FIG. 3O shows a right-hand helix.

### 4.4 Head-Mounted Virtual Reality Display

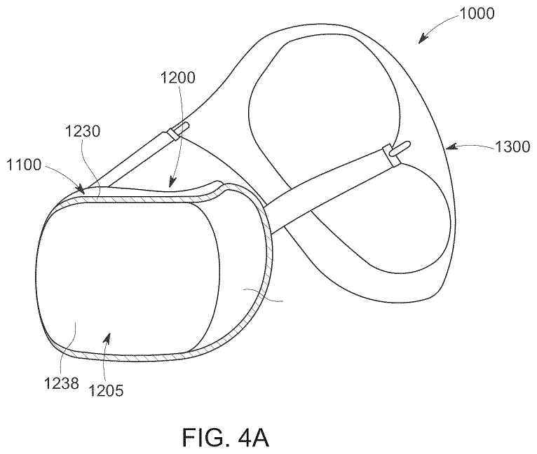

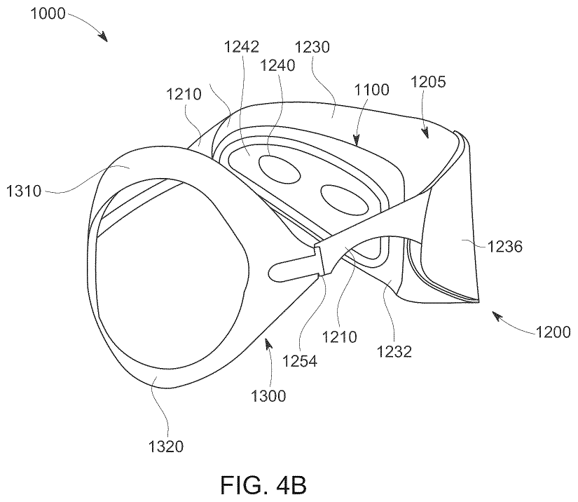

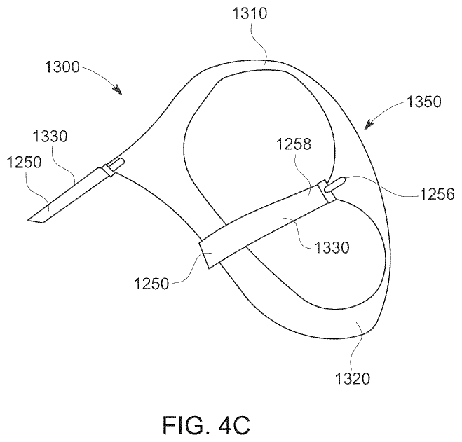

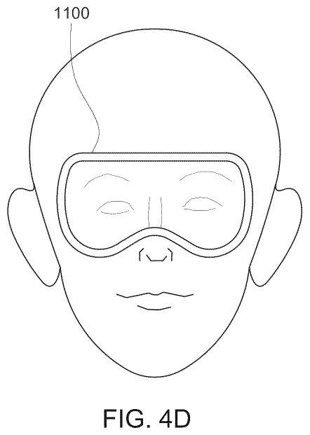

FIG. 4A shows a front perspective view of a head-mounted display interface in accordance with one form of the present technology.

FIG. 4B shows a rear perspective view of the head-mounted display of FIG. 4A.

FIG. 4C shows a perspective view of a positioning and stabilizing structure used with the head-mounted display of FIG. 4A.

FIG. 4D shows a front view of a user's face, illustrating a location of an interfacing structure, in use.

### 4.5 Head-Mounted Augmented Reality Display

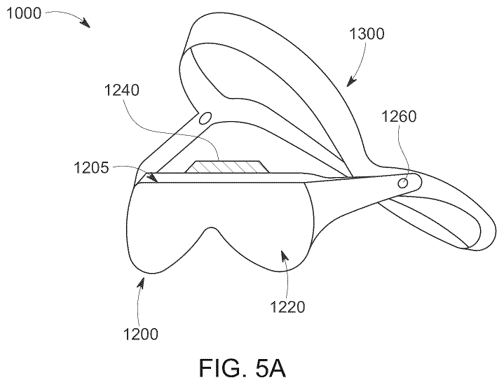

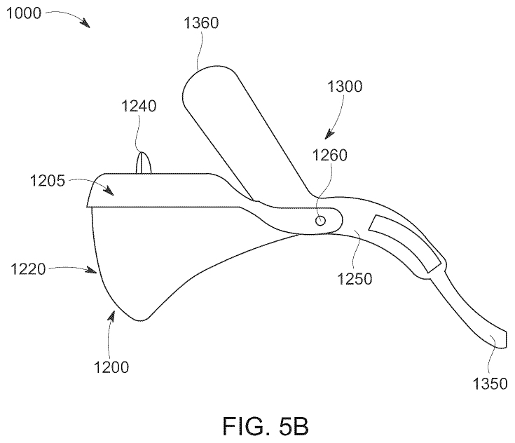

FIG. 5A shows a front perspective view of a head-mounted display interface in accordance with one form of the present technology.

FIG. 5B shows a side view of the head-mounted display interface of FIG. 5A.

### 4.6 Controls

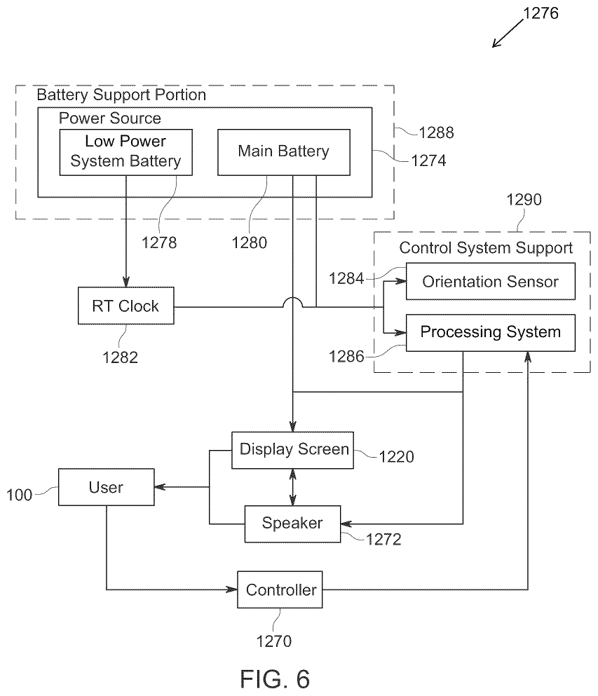

FIG. 6 shows a schematic view of a control system of one form of the present technology.

### 4.7 Interfacing Structure

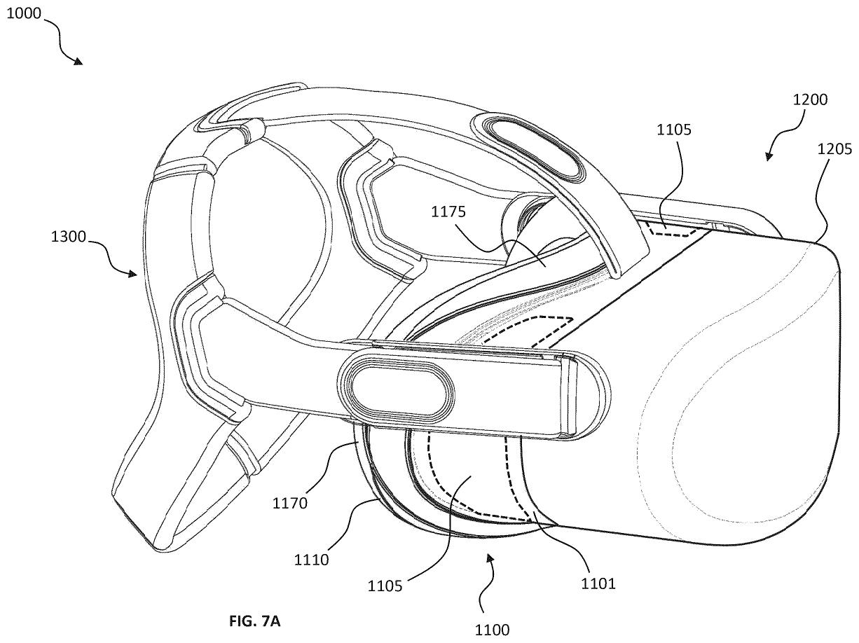

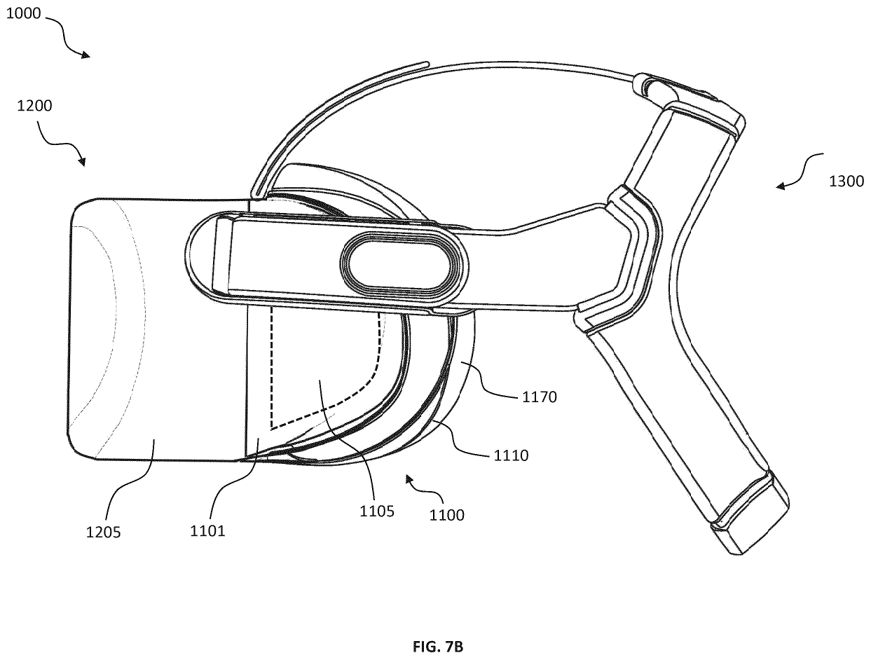

FIG. 7A shows a perspective view illustration of a head-mounted display system according to another example of the present technology.

FIG. 7B shows a side view illustration of the head-mounted display system shown in FIG. 7A.

FIG. 7C shows a superior view illustration of the head-mounted display system shown in FIG. 7A.

FIG. 7D shows an inferior view illustration of the head-mounted display system shown in FIG. 7A.

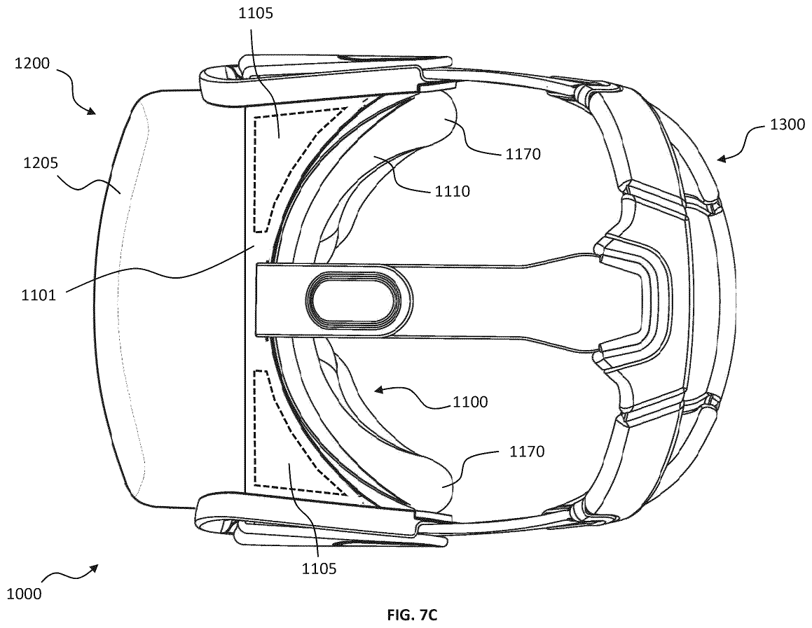

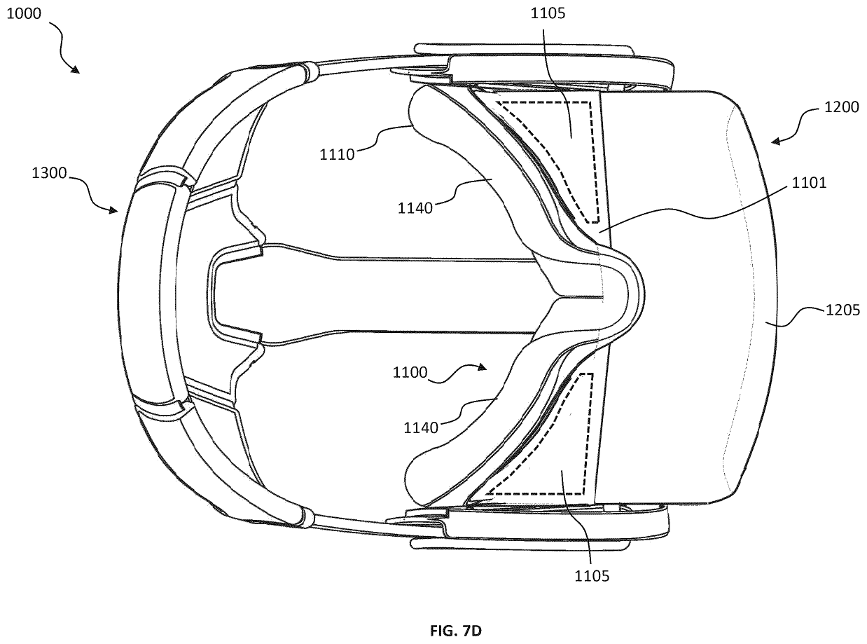

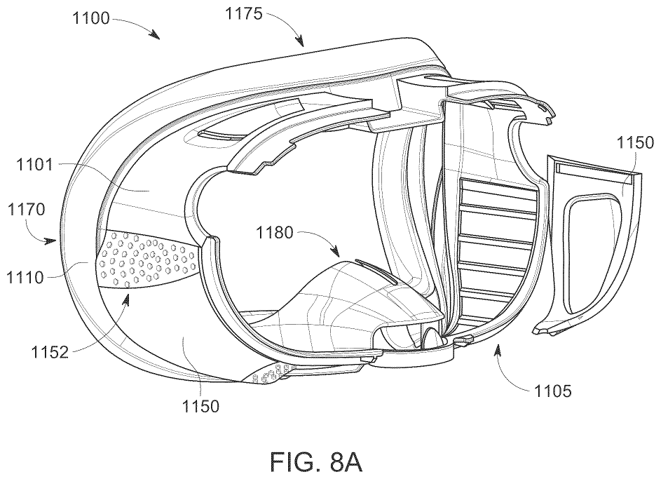

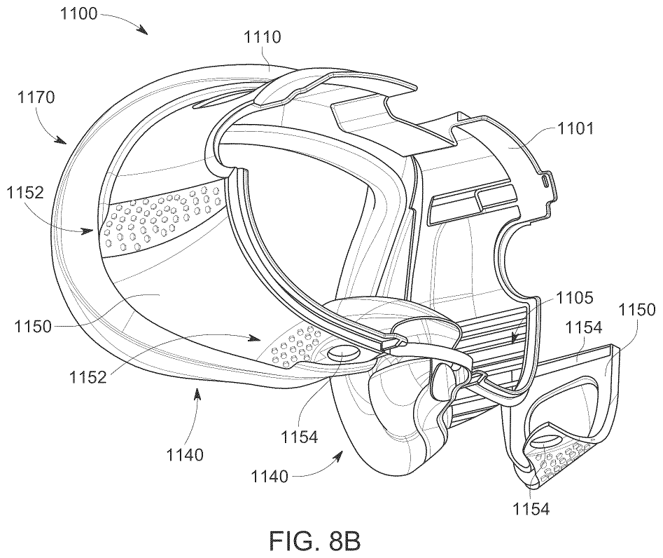

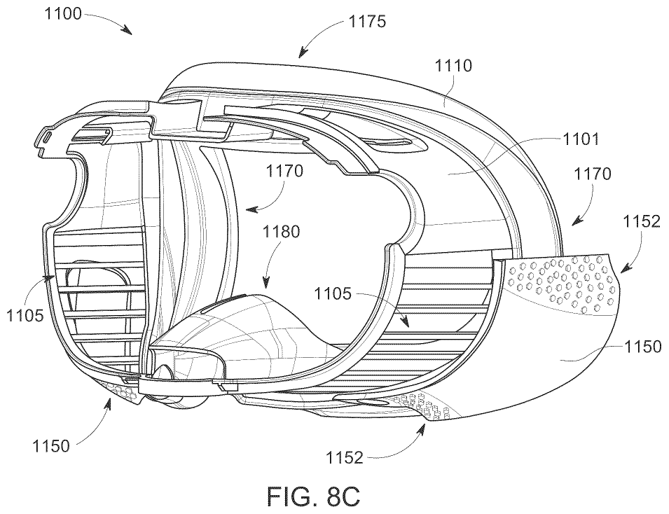

FIG. 8A shows a partially exploded superior right side perspective view illustration of an interfacing structure according to another example of the present technology.

FIG. 8B shows a partially exploded inferior right side perspective view illustration of the interfacing structure shown in FIG. 8A.

FIG. 8C shows a partially exploded left-side perspective view illustration of the interfacing structure shown in FIG. 8A.

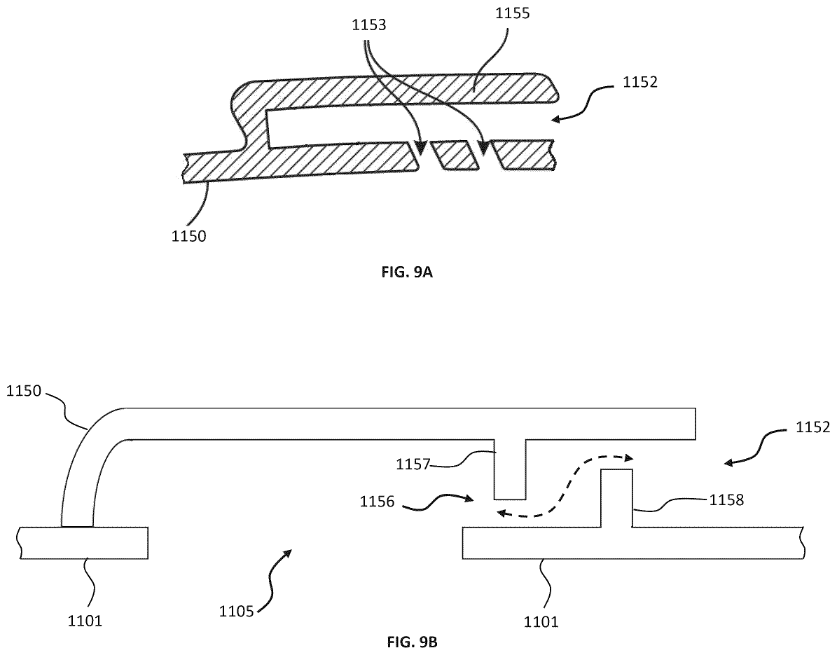

FIG. 9A shows a schematic cross section view through a shield of an interfacing structure according to another example of the present technology.

FIG. 9B shows a schematic cross section view through a chassis portion of an interfacing structure according to another example of the present technology.

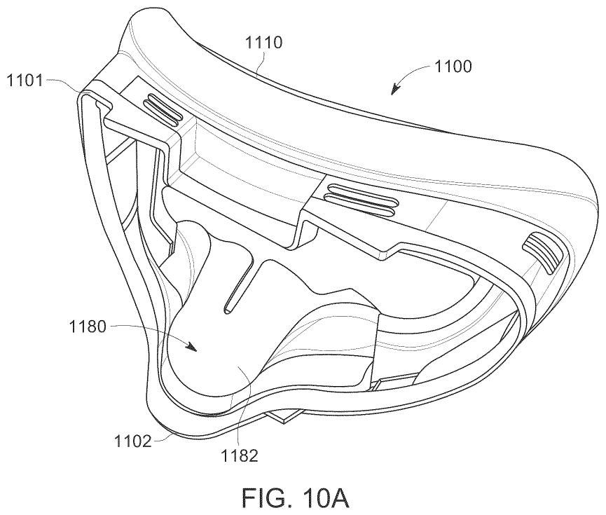

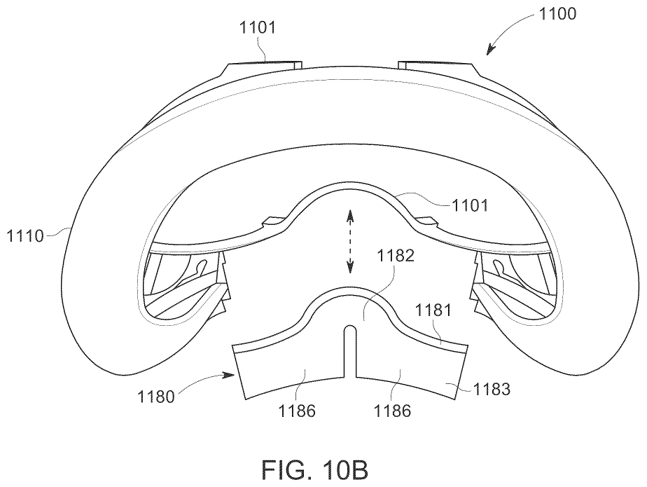

FIG. 10A shows a perspective view of an interfacing structure according to another example of the present technology.

FIG. 10B shows a superior partially exploded schematic view of the interfacing structure shown in FIG. 10A.

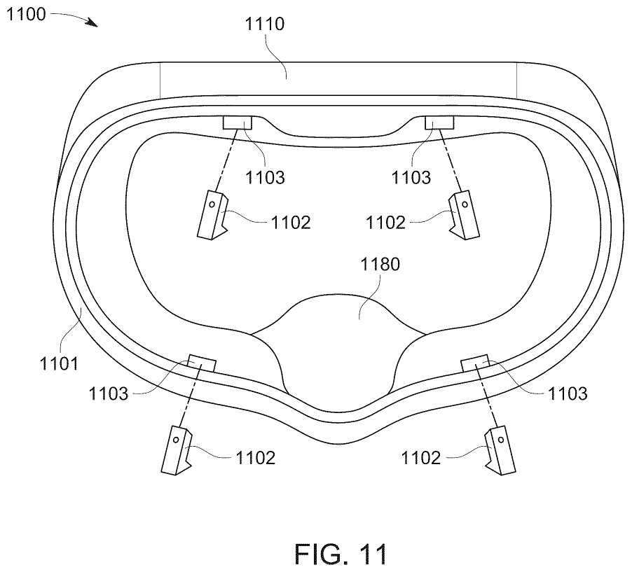

FIG. 11 is an anterior perspective partially exploded view illustration of an interfacing structure according to an example of the present technology.

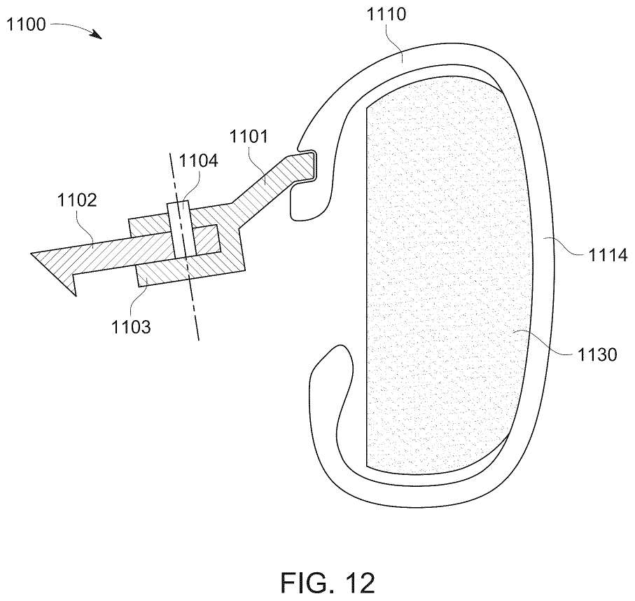

FIG. 12 is a cross section view illustration through a clip attachment assembly of the interfacing structure shown in FIG. 11.

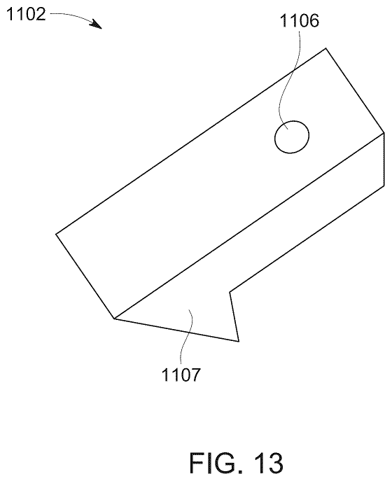

FIG. 13 is a perspective view illustration of a clip of the interfacing structure shown in FIG. 11.

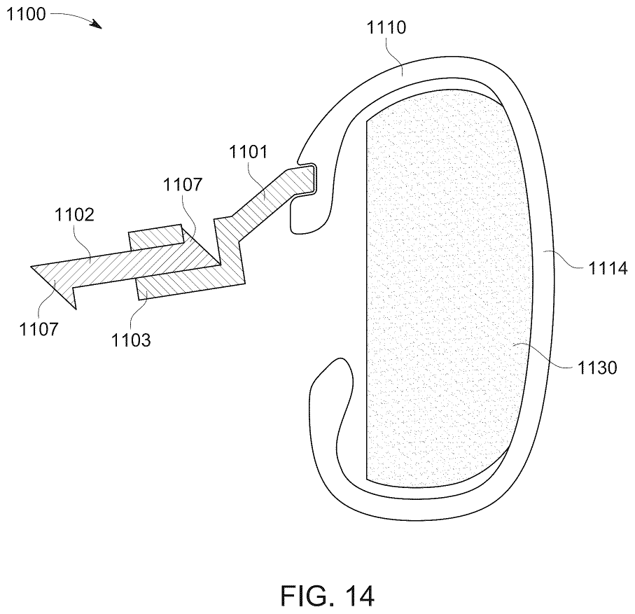

FIG. 14 is a cross section view illustration through another clip attachment assembly according to an example of the present technology.

### 5 DETAILED DESCRIPTION OF EXAMPLES OF THE TECHNOLOGY

Before the present technology is described in further detail, it is to be understood that the technology is not limited to the particular examples described herein, which may vary. It is also to be understood that the terminology used in this disclosure is for the purpose of describing only the particular examples discussed herein, and is not intended to be limiting.

The following description is provided in relation to various examples which may share one or more common characteristics and/or features. It is to be understood that one or more features of any one example may be combinable with one or more features of another example or other examples. In addition, any single feature or combination of features in any of the examples may constitute a further example.

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

### 5.1 Immersive Technologies

Immersive technologies may present a user with a combination of a virtual environment and the user's physical environment, or the real world. The user may interact with the resulting immersive or combined reality.

The device immerses the user by augmenting or replacing stimuli associated with one of the user's five senses with a virtual stimuli. Typically this is a virtual stimuli, although there could be additional stimuli that augment or replace stimuli associated with one of the additional four senses.

In some forms, a particular immersive technology may present a user with a combination of a virtual environment and the user's environment. At least a portion of the resulting environment may include a virtual environment. In some examples, the entire resulting environment may be a virtual environment (e.g., meaning the user's environment may be block from view or otherwise obstructed). In other forms, at least a portion of the user's physical environment may still be visually observable.

In some forms, the user may use different types of immersive technologies, which may include, but are not limited to, virtual reality (VR), augmented reality (AR), or mixed reality (MR). Each type of immersive technology may present the user with a different environment and/or a different way to interact with the environment.

In some forms, a display system may be used with each type of immersive technology. A display screen of the display system may provide a virtual environment component to the combination environment (i.e., the combination of the virtual and user's environments). In certain forms, the display screen may be an electronic screen.

In at least some types of immersive technologies (e.g., VR, AR, MR, etc.), positioning and stabilizing the electronic screen may be useful in operating a respective device. For example, the user may desire the electronic screen to be positioned close enough to their eyes to allow for easy viewing, but far enough away so as not to cause discomfort. Additionally, the electronic screen may need to be spaced far enough away so that users may simultaneously wear corrective lenses, like glasses. In addition, users may seek to maintain the orientation of the electronic screen relative to their eyes. In other words, users who walk, or otherwise move, while using these devices may not want the device to bounce or otherwise move on their head (e.g., particularly relative to their eyes), as this may cause dizziness and/or discomfort to the user. Therefore, these devices may be supported snuggly against the user's head in order to limit relative movement between the user's eyes and the device.

In one form, the present technology comprises a method for using a VR device comprising supporting the device on the user's head proximate to at least one of the user's eyes, and within the user's line of sight.

In certain examples of the present technology, a head-mounted display unit is supported in front of both of the user's eyes in order to block, obstruct, and/or limit ambient light from reaching the user's eyes.

Any features disclosed below in the context of a device configured for VR are to be understood as being applicable to devices configured for AR, unless the context clearly requires otherwise. Likewise features disclosed below in the context of a device configured for AR are to be understood as being applicable to devices configured for VR, unless the context clearly requires otherwise. For the avoidance of doubt, a feature disclosed in the context of a device that does not have a transparent display, through which the user can view the real world, is to be understood as being applicable to a device having such a transparent display unless the context clearly requires otherwise. Likewise a feature disclosed in the context of a device that has a transparent display, through which the real-world can be viewed, is to be understood to be applicable to a device in which the display is electronic and through which the real-world cannot be viewed directly through a transparent material.

### 5.2 Virtual Reality Display System

As shown in FIGS. 4A and 4B, a display apparatus, display system, display interface or head-mounted display system 1000 in accordance with one aspect of the present technology comprises the following functional aspects: an interfacing structure 1100, a head-mounted display unit 1200, and a positioning and stabilizing structure 1300. In some forms, a functional aspect may provide one or more physical components. In some forms, one or more physical components may provide one or more functional aspects. The head-mounted display unit 1200 may comprise a display. In use, the head-mounted display unit 1200 is arranged to be positioned proximate and anterior to the user's eyes, so as to allow the user to view the display.

In other aspects, the head-mounted display system 1000 may also include a display unit housing 1205, an optical lens 1240, a controller 1270, a speaker 1272, a power source 1274, and/or a control system 1276. In some examples, these may be integral pieces of the head-mounted display system 1000, while in other examples, these may be modular and incorporated into the head-mounted display system 1000 as desired by the user.

### 5.2.1 Head-mounted Display Unit

The head-mounted display unit 1200 may include a structure for providing an observable output to a user. Specifically, the head-mounted display unit 1200 is arranged to be held (e.g., manually, by a positioning and stabilizing structure, etc.) in an operational position in front of a user's face.

In some examples, the head-mounted display unit 1200 may include a display screen 1220, a display unit housing 1205, an interfacing structure 1100, and/or an optical lens 1240. These components may be permanently assembled in a single head-mounted display unit 1200, or they may be separable and selectively connected by the user to form the head-mounted display unit 1200. Additionally, the display screen 1220, the display unit housing 1205, the interfacing structure 1100, and/or the optical lens 1240 may be included in the head-mounted display system 1000, but may not be part of the head-mounted display unit 1200.

### 5.2.1.1 Display Screen

Some forms of the head-mounted display unit 1200 include a display, for example a display screen—not shown in FIG. 4B, but provided within the display unit housing 1205. The display screen may include electrical components that provide an observable output to the user.

In one form of the present technology, a display screen provides an optical output observable by the user. The optical output allows the user to observe a virtual environment and/or a virtual object.

The display screen may be positioned proximate to the user's eyes, in order to allow the user to view the display screen. For example, the display screen may be positioned anterior to the user's eyes. The display screen can output computer generated images and/or a virtual environment.

### 5.2.1.2 Display Housing

In some forms of the present technology as shown in FIGS. 4A and 4B, a display unit housing 1205 provides a support structure for the display screen, in order to maintain a position of at least some of the components of the display screen relative to one another, and may additionally protect the display screen and/or other components of the head-mounted display unit 1200. The display unit housing 1205 may be constructed from a material suitable to provide protection from impact forces to the display screen. The display unit housing 1205 may also contact the user's face, and may be constructed from a biocompatible material suitable for limiting irritation to the user.

A display unit housing 1205 in accordance with some forms of the present technology may be constructed from a hard, rigid or semi-rigid material, such as plastic.

In certain forms, the rigid or semi-rigid material may be at least partially covered with a soft and/or flexible material (e.g., a textile, silicone, etc.). This may improve biocompatibility and/or user comfort because the at least a portion of the display unit housing 1205 that the user engages (e.g., grabs with their hands) includes the soft and/or flexible material.

A display unit housing 1205 in accordance with other forms of the present technology may be constructed from a soft, flexible, resilient material, such as silicone rubber.

### 5.2.1.3 Interfacing Structure

As shown in FIGS. 4A and 4B, some forms of the present technology include an interfacing structure 1100 is positioned and/or arranged in order to conform to a shape of a user's face, and may provide the user with added comfort while wearing and/or using the head-mounted display system 1000.

In some forms, the interfacing structure 1100 is coupled to a surface of the display unit housing 1205.

In some forms, the interfacing structure 1100 may extent at least partially around the display unit housing 1205, and may form a viewing opening. The viewing opening may at least partially receive the user's face in use. Specifically, the user's eyes may be received within the viewing opening formed by the interfacing structure 1100.

In some forms, the interfacing structure 1100 in accordance with the present technology may be constructed from a biocompatible material.

In some forms, the interfacing structure 1100 in accordance with the present technology may be constructed from a soft, flexible, and/or resilient material.

In certain forms, the interfacing structure 1100 in accordance with the present technology may be constructed from silicone rubber and/or foam.

In some forms, the interfacing structure 1100 may contact sensitive regions of the user's face, which may be locations of discomfort. The material forming the interfacing structure 1100 may cushion these sensitive regions, and limit user discomfort while wearing the head-mounted display system 1000.

In certain forms, these sensitive regions may include the user's forehead. Specifically, this may include the region of the user's head that is proximate to the frontal bone, like the Epicranius and/or the glabella. This region may be sensitive because there is limited natural cushioning from muscle and/or fat between the user's skin and the bone. Similarly, the ridge of the user's nose may also include little to no natural cushioning.

In some forms, the interfacing structure 1100 may comprise a single element. In some embodiments the interfacing structure 1100 may be designed for mass manufacture. For example, the interfacing structure 1100 may be designed to comfortably fit a wide range of different face shapes and sizes.

In some forms, the interfacing structure 1100 may include different elements that overlay different regions of the user's face. The different portions of the interfacing structure 1100 may be constructed from different materials, and provide the user with different textures and/or cushioning at different regions.

### 5.2.1.3.1 Light Shield

Some forms of the head-mounted display system 1000 may include a light shield that may be constructed from an opaque material and can block ambient light from reaching the user's eyes. The light shield may be part of the interfacing structure 1100 or may be a separate element. In some examples the interfacing structure 1100 may form a light shield by shielding the user's eyes from ambient light, in addition to providing a comfortable contacting portion for contact between the head-mounted display 1200 and the user's face. In some examples a light shield may be formed from multiple components working together to block ambient light.

In certain forms, the light shield can obstruct ambient light from reaching an eye region, which may be formed on regions of the Epicranius, the user's sphenoid, across the outer cheek region between the sphenoid to the left or right zygomatic arch, over the zygomatic arch, across the inner cheek region from the zygomatic arches towards the alar crests, and on the users' nasal ridge inferior to the sellion to enclose a portion of the users' face therebetween.

In one form, the light shield may not contact the user's face around its entire perimeter. For example, the light shield may be spaced from the user's nasal rigid. The width of this spacing may be substantially small, so as to substantially limit the ingress of ambient light. However, the user's nasal ridge may be sensitive and easily irritated. Thus, avoiding direct contact with the user's nasal ridge may improve user comfort while wearing the head-mounted display system 1000.

In certain forms, the light shield may be a portion of the display unit housing 1205, and may be integrally or removably coupled to the display unit housing 1205. In one form, if the display unit housing 1205 is usable with a display screen outputting AR or MR, and VR, the light shield may be removable from the display unit housing 1205, and only coupled to the display unit housing 1205 while using VR.

### 5.2.2 Positioning and Stabilizing Structure

As shown in FIGS. 4A and 4B, the display screen 1220 and/or the display unit housing 1205 of the head-mounted display system 1000 of the present technology may be held in position in use by the positioning and stabilizing structure 1300.

To hold the display screen 1220 and/or the display unit housing 1205 in its correct operational position, the positioning and stabilizing structure 1300 is ideally comfortable against the user's head in order to accommodate the induced loading from the weight of the display unit in a manner that minimise facial markings and/or pain from prolonged use. There is also need to allow for a universal fit without trading off comfort, usability and cost of manufacture. The design criteria may include adjustability over a predetermined range with low-touch simple set up solutions that have a low dexterity threshold. Further considerations include catering for the dynamic environment in which the head-mounted display system 1000 may be used. As part of the immersive experience of a virtual environment, users may communicate, i.e. speak, while using the head-mounted display system 1000. In this way, the jaw or mandible of the user may move relative to other bones of the skull. Additionally, the whole head may move during the course of a period of use of the head-mounted display system 1000. For example, movement of a user's upper body, and in some cases lower body, and in particular, movement of the head relative to the upper and lower body.

In one form the positioning and stabilizing structure 1300 provides a retention force to overcome the effect of the gravitational force on the display screen 1220 and/or the display unit housing 1205.

In one form of the present technology, a positioning and stabilizing structure 1300 is provided that is configured in a manner consistent with being comfortably worn by a user. In one example the positioning and stabilizing structure 1300 has a low profile, or cross-sectional thickness, to reduce the perceived or actual bulk of the apparatus. In one example, the positioning and stabilizing structure 1300 comprises at least one strap having a rectangular cross-section. In one example the positioning and stabilizing structure 1300 comprises at least one flat strap.

In one form of the present technology, a positioning and stabilizing structure 1300 is provided that is configured so as not to be too large and bulky to prevent the user from comfortably moving their head from side to side.

In one form of the present technology, a positioning and stabilizing structure 1300 comprises a strap constructed from a laminate of a textile user-contacting layer, a foam inner layer and a textile outer layer. In one form, the foam is porous to allow moisture, (e.g., sweat), to pass through the strap. In one form, a skin contacting layer of the strap is formed from a material that helps wick moisture away from the user's face. In one form, the textile outer layer comprises loop material to engage with a hook material portion.

In certain forms of the present technology, a positioning and stabilizing structure 1300 comprises a strap that is extensible, e.g. resiliently extensible. For example the strap may be configured in use to be in tension, and to direct a force to draw the display screen 1220 and/or the display unit housing 1205 toward a portion of a user's face, particularly proximate to the user's eyes and in line with their field of vision. In an example the strap may be configured as a tie.

In one form of the present technology, the positioning and stabilizing structure 1300 comprises a first tie, the first tie being constructed and arranged so that in use at least a portion of an inferior edge thereof passes superior to an otobasion superior of the user's head and overlays a portion of a parietal bone without overlaying the occipital bone.

In one form of the present technology, the positioning and stabilizing structure 1300 includes a second tie, the second tie being constructed and arranged so that in use at least a portion of a superior edge thereof passes inferior to an otobasion inferior of the user's head and overlays or lies inferior to the occipital bone of the user's head.

In one form of the present technology, the positioning and stabilizing structure 1300 includes a third tie that is constructed and arranged to interconnect the first tie and the second tie to reduce a tendency of the first tie and the second tie to move apart from one another.

In certain forms of the present technology, a positioning and stabilizing structure 1300 comprises a strap that is bendable and e.g. non-rigid. An advantage of this aspect is that the strap is more comfortable against a user's head.

In certain forms of the present technology, a positioning and stabilizing structure 1300 comprises a strap constructed to be breathable to allow moisture vapour to be transmitted through the strap,

In certain forms of the present technology, a system is provided comprising more than one positioning and stabilizing structure 1300, each being configured to provide a retaining force to correspond to a different size and/or shape range. For example the system may comprise one form of positioning and stabilizing structure 1300 suitable for a large sized head, but not a small sized head, and another suitable for a small sized head, but not a large sized head.

In some forms, the positioning and stabilizing structure 1300 may include cushioning material (e.g., a foam pad) for contacting the user's skin. The cushioning material may provide added wearability to the positioning and stabilizing structure 1300, particularly if positioning and stabilizing structure 1300 is constructed from a rigid or semi-rigid material.

### 5.2.2.1 Temporal Connectors

As shown in FIG. 4C, some forms of the head-mounted display system 1000 or positioning and stabilizing structure 1300 include temporal connectors 1250 or arms, each of which may overlay a respective one of the user's temporal bones in use. A portion of the temporal connectors 1250, in-use, are in contact with a region of the user's head proximal to the otobasion superior, i.e. above each of the user's ears. In some examples, temporal connectors are strap portions of a positioning and stabilising structure 1300. In other examples, temporal connectors are arms of a head-mounted display unit 1200. In some examples a temporal connector of a head-mounted display system 1000 may be formed partially by a strap portion (e.g. a lateral strap portion 1330) of a positioning and stabilising structure 1300 and partially by an arm 1210 of a head-mounted display unit 1200.

The temporal connectors 1250 may be lateral portions of the positioning and stabilizing structure 1300, as each temporal connector 1250 is positioned on either the left or the right side of the user's head.

In some forms, the temporal connectors 1250 may extend in an anterior-posterior direction, and may be substantially parallel to the sagittal plane.

In some forms, the temporal connectors 1250 may be coupled to the display unit housing 1205. For example, the temporal connectors 1250 may be connected to lateral sides of the display unit housing 1205. For example, each temporal connector 1250 may be coupled to a respective one of the lateral left face 1234 and the lateral right face 1236.

In certain forms, the temporal connectors 1250 may be pivotally connected to the display unit housing 1205, and may provide relative rotation between each temporal connector 1250, and the display unit housing 1205.

In certain forms, the temporal connectors 1250 may be removably connected to the display unit housing 1205 (e.g., via a magnet, a mechanical fastener, hook and loop material, etc.).

In some forms, the temporal connectors 1250 may be arranged in-use to run generally along or parallel to the Frankfort Horizontal plane of the head and superior to the zygomatic bone (e.g., above the user's cheek bone).

In some forms, the temporal connectors 1250 may be positioned against the user's head similar to arms of eye-glasses, and be positioned more superior than the anti-helix of each respective ear.

In some forms, the temporal connectors 1250 may have a generally elongate and flat configuration. In other words, each temporal connector 1250 is far longer and wider (direction from top to bottom in the paper plane) than thick (direction into the paper plane).

In some forms, the temporal connectors 1250 may each have a three-dimensional shape which has curvature in all three axes (X, Y and Z). Although the thickness of each temporal connector 1250 may be substantially uniform, its height varies throughout its length. The purpose of the shape and dimension of each temporal connector 1250 is to conform closely to the head of the user in order to remain unobtrusive and maintain a low profile (e.g., not appear overly bulky).

In some forms, the temporal connectors 1250 may be constructed from a rigid or semi-rigid material, which may include plastic, Hytrel (thermoplastic polyester elastomer), or another similar material. The rigid or semi-rigid material may be self-supporting and/or able to hold its shape without being worn. This can make it more intuitive or obvious for users to understand how to use the positioning and stabilizing structure 1300 and may contrast with a positioning and stabilizing structure 1300 that is entirely floppy and does not retain a shape. Maintaining the temporal connectors 1250 in the in-use state prior to use may prevent or limit distortion whilst the user is donning the positioning and stabilizing structure 1300 and allow a user to quickly fit or wear the head-mounted display system 1000.

In certain forms, the temporal connectors 1250 may be rigidizers, which may allow for a more effective (e.g., direct) translation of tension through the temporal connectors 1250 because rigidizers limit the magnitude of elongation or deformation of the arm while in-use.

In certain forms, the temporal connectors 1250 may be at least partially flexible in one direction and may be more rigid in another direction. A user may be able to bend or flex the temporal connector more in one direction than in another direction. For example, the temporal connectors 1250 may be at least partially flexible along an axis substantially parallel to the user's sagittal plane (e.g., in the superior-inferior direction while in use). This may allow the temporal connectors 1250 to conform to the shape of the user's head by moving in lateral directions toward or away from the user's head. The user also may be able to make multiple adjustments along the length of the temporal connectors 1250 to correspond to a variety of structures along the user's head. However, bending along an axis substantially parallel to the user's coronal plane (e.g., extending in the lateral direction in use) may be more difficult. The temporal connectors 1250 may resist bending in the superior-inferior direction.

In certain forms, the positioning and stabilizing structure 1300 may be designed so that the positioning and stabilizing structure 1300 springs ‘out of the box’ and generally into its in-use configuration. In addition, the positioning and stabilizing structure 1300 may be arranged to hold its in-use shape once out of the box (e.g., because rigidizers may be formed to maintain the shape of some or part of the positioning and stabilizing structure 1300). Advantageously, the orientation of the positioning and stabilizing structure 1300 is made clear to the user as the shape of the positioning and stabilizing structure 1300 is generally curved much like the rear portion of the user's head. That is, the positioning and stabilizing structure 1300 is generally dome shaped.

In certain forms, a flexible and/or resilient material may be disposed around the rigid or semi-rigid material of the temporal connectors 1250. The flexible material may be more comfortable against the user's head, in order to improve wearability and provide soft contact with the user's face. In one form, the flexible material is a textile sleeve at is permanently or removably coupled to each temporal connector 1250.

In one form, a textile may be over-moulded onto at least one side of the rigidizer. In one form, the rigidizer may be formed separately to the resilient component and then a sock of user contacting material (e.g., Breath-O-Prene™) may be wrapped or slid over the rigidizer. In alternative forms, the user contacting material may be provided to the rigidizer by adhesive, ultrasonic welding, sewing, hook and loop material, and/or stud connectors.

In some forms, the user contacting material may be on both sides of the rigidizer, or alternatively may only be on the user contacting side (e.g., the user contacting side) of the rigidizer to reduce bulk and cost of materials.

In some forms, the temporal connectors 1250 are constructed from a flexible material (e.g., a textile), which may be comfortable against the user's skin, and may not require an added layer to increase comfort.

### 5.2.2.2 Posterior Support Portion

As shown in FIG. 4C, some forms of the positioning and stabilizing structure 1300 may include a posterior support portion 1350 for assisting in supporting the display screen 1220 and/or the display unit housing 1205 (shown in FIG. 4B) proximate to the user's eyes. The posterior support portion 1350 may assist in anchoring the display screen and/or the display unit housing 1205 to the user's head in order to appropriately orient the display screen proximate to the user's eyes.

In some forms, the posterior support portion 1350 may be coupled to the display unit housing 1205 via the temporal connectors 1250.

In certain forms, the temporal connectors 1250 may be directly coupled to the display unit housing 1205 and to the posterior support portion 1350.

In some forms, the posterior support portion 1350 may have a three-dimensional contour curve to fit to the shape of a user's head. For example, the three-dimensional shape of the posterior support portion 1350 may have a generally round three-dimensional shape adapted to overlay a portion of the parietal bone and the occipital bone of the user's head, in use.

In certain forms, the posterior support portion 1350 may include a superior section 1310 and an inferior section 1320. The superior section 1310 and the inferior section 1320 may be continuous and form a round shape (e.g., circular, elliptical, etc.) of the posterior support portion.

In certain forms, the posterior support portion 1350 may be at least partially rigidized so that the round shape may be maintained even when not worn by the user. This may help the user don the posterior support portion 1350 as the rigidity may limit tangling.

In one form, the rigidity may provide “springiness” to the posterior support portion 1350. For example, the posterior support portion 1350 may “spring-to-life” after being compressed. In other words, the posterior support portion 1350 may be flexible enough to be folded but once a force is removed, the posterior support portion 1350 returns to its original shape (e.g., the three-dimensional round shape).

In some forms, the posterior support portion 1350 may be a posterior portion of the positioning and stabilizing structure 1300. The posterior support portion 1350 may provide an anchoring force directed at least partially in the anterior direction.

In certain forms, the inferior section 1320 of the posterior support portion 1350 is the inferior-most portion of the positioning and stabilizing structure 1300. For example, the posterior support portion 1350 may contact a region of the user's head between the occipital bone and the trapezius muscle. The posterior support portion 1350 may hook against an inferior edge of the occipital bone (e.g., the occiput). The posterior support portion 1350 may provide a force directed in the superior direction and/or the anterior direction in order to maintain contact with the user's occiput.

In certain forms, inferior section 1320 of the posterior support portion 1350 is the inferior-most portion of the entire head-mounted display system 1000. For example, the posterior support portion 1350 may be positioned at the base of the user's neck (e.g., overlaying the occipital bone and the trapezius muscle more inferior than the user's eyes) so that the posterior support portion 1350 is more inferior than the display screen 1220 and/or the display unit housing 1205.

In certain forms, the superior section 1310 may overlay the parietal bones when in contact with the user's head. The round shape of the posterior support portion 1350 may allow the posterior support portion 1350 to sit substantially flat on the user's head while the inferior section 1320 contacts the user's head as described above.

In some forms, the posterior support portion 1350 may include a padded material, which may contact the user's head (e.g., overlaying the region between the occipital bone and the trapezius muscle). The padded material may provide additional comfort to the user, and limit marks caused by the posterior support portion 1350 pulling against the user's head.

In certain forms, the posterior support portion 1350 may be constructed from a textile material and/or a foam material. The materials may be biocompatible and comfortable to a user's head.

In one form, the posterior support portion 1350 may be constructed from a foam material that is at least partially covered by a fabric material. The outer fabric material may provide the comfortable feeling for the user's skin. The inner foam layer may allow the posterior support portion 1350 to compress and improve comfort.

### 5.2.2.3 Forehead Support

Some forms of the positioning and stabilizing structure 1300 may include a forehead support or frontal support portion 1360 configured to contact the user's head superior to the user's eyes, while in use. The positioning and stabilising structure 1300 shown in FIG. 5B includes a forehead support 1360. In some examples the positioning and stabilising structure 1300 shown in FIG. 4A may include a forehead support 1360. The forehead support 1360 may overlay the frontal bone of the user's head. In certain forms, the forehead support 1360 may also be more superior than the sphenoid bones and/or the temporal bones. This may also position the forehead support 1360 more superior than the user's eyebrows.

In some forms, the forehead support 1360 may be an anterior portion of the positioning and stabilizing structure 1300, and may be disposed more anterior on the user's head than any other portion of the positioning and stabilizing structure 1300. The posterior support portion 1350 may provide a force directed at least partially in the posterior direction.

In some forms, the forehead support 1360 may include a cushioning material (e.g., textile, foam, silicone, etc.) that may contact the user, and may help to limit marks caused by the straps of the positioning and stabilizing structure 1300. The forehead support 1360 and the interfacing structure 1100 may work together in order to provide comfort to the user.

In some forms, the forehead support 1360 may be separate from the display unit housing 1205, and may contact the user's head at a different location (e.g., more superior) than the display unit housing 1205.

In some forms, the forehead support 1360 can be adjusted to allow the positioning and stabilizing structure 1300 to accommodate the shape and/or configuration of a user's face.

In some forms, the temporal connectors 1250 may be coupled to the forehead support 1360 (e.g., on lateral sides of the forehead support 1360). The temporal connectors 1250 may extend at least partially in the inferior direction in order to couple to the posterior support portion 1350.

In certain forms, the positioning and stabilizing structure 1300 may include multiple pairs of temporal connectors 1250. For example, one pair of temporal connectors 1250 may be coupled to the forehead support 1360, and one pair of temporal connectors 1250 may be coupled to the display unit housing 1205.

In some forms, the forehead support 1360 can be presented at an angle which is generally parallel to the user's forehead to provide improved comfort to the user. For example, the forehead support 1360 may position the user in an orientation that overlays the frontal bone, and is substantially parallel to the coronal plane. Positioning the forehead support substantially parallel to the coronal plane can reduce the likelihood of pressure sores which may result from an uneven presentation.

In some forms, the forehead support 1360 may be offset from a rear support or posterior support portion that contacts a posterior region of the user's head (e.g., an area overlaying the occipital bone and the trapezius muscle). In other words, an axis along a rear strap would not intersect the forehead support 1360, which may be disposed more inferior and anterior than the axis along the rear strap. The resulting offset between the forehead support 1360 and the rear strap may create moments that oppose the weight force of the display screen 1220 and/or the display unit housing 1205. A larger offset may create a larger moment, and therefore more assistance in maintaining a proper position of the display screen 1220 and/or the display unit housing 1205. The offset may be increased by moving the forehead support 1360 closer to the user's eyes (e.g., more anterior and inferior along the user's head), and/or increasing the angle of the rear strap so that it is more vertical.

In some forms, the forehead support 1360 may be constructed from a compressible material, which may offer support for the user when in use.

In certain forms, the forehead support 1360 may be constructed from silicone, foam, and/or textile. For example, a textile may be used in combination with either the silicone or the foam, although any of the materials may be used independently. When used together, the textile may be an outer layer of the forehead support 1360 and may contact the user's head. The foam and/or silicone may be an inner layer that compresses when the forehead support 1360 is under tension on the user's head.

### 5.2.2.4 Adjustable Straps

As shown in FIG. 4C, portions of the positioning and stabilizing structure 1300 may be adjustable, in order to impart a selective tensile force on the display screen 1220 and/or the display unit housing 1205 in order to secure a position of the display screen 1220 and/or the display unit housing 1205.

In some forms, the display unit housing 1205 may include at least one loop or eyelet 1254 (as shown in FIG. 4B), and at least one of the temporal connectors 1250 may be threaded through that loop, and doubled back on itself. The length of the temporal connector 1250 threaded through the respective eyelet 1254 may be selected by the user in order to adjust the tensile force provided by the positioning and stabilizing structure 1300. For example, threading a greater length of the temporal connector 1250 through the eyelet 1254 may supply a greater tensile force.

In some forms, at least one of the temporal connectors 1250 may include an adjustment portion 1256 and a receiving portion 1258 (as shown in FIG. 4C). The adjustment portion 1256 may be positioned through the eyelet 1254 on the display unit housing 1205, and may be coupled to the receiving portion 1258 (e.g., by doubling back on itself). The adjustment portion 1256 may include a hook material, and the receiving portion 1258 may include a loop material (or vice versa), so that the adjustment portion 1256 may be removably held in the desired position. In some examples, the hook material and the loop material may be Velcro.

In certain forms, adjusting the position of the adjustment portion 1256 relative to the receiving portion 1258 may apply a posterior force to the display screen 1220 and/or the display unit housing 1205, and increase or decrease a sealing force of the light shield against the user's head (e.g., when the light shield acts as a seal-forming structure).

In certain forms, the adjustment portion 1256 may be constructed from a flexible and/or resilient material, which may conform to a shape of the user's head and/or may allow the adjustment portion to be threaded through the eyelet 1254. For example, the adjustment portion(s) 1256 may be constructed from an elastic textile, which may provide an elastic, tensile force. The remainder of the temporal connectors 1250 may be constructed from the rigid or semi-rigid material described above (although it is contemplated that additional sections of the temporal connectors 1250 may also be constructed from a flexible material).

### 5.2.2.4.1 Top Strap

In some forms, the positioning and stabilizing structure 1300 may include a top strap portion, which may overlay a superior region of the user's head. The head-mounted display system 1000 shown in FIG. 1A has a top strap portion, for example.

In some forms, the top strap portion may extend between an anterior portion of the head-mounted display system 1000 and a posterior region of the head-mounted display system 1000.

In some forms, the top strap portion may be constructed from a flexible material, and may be configured to compliment the shape of the user's head.

In certain forms, the top strap portion may be connected to the display unit housing 1205. For example, the top strap portion may be coupled to the superior face 1230. The top strap portion may also be coupled to the display unit housing 1205 proximate to a posterior end of the display unit housing 1205.

In certain forms, the top strap portion may be coupled to the forehead support 1360. For example, the top strap portion may be coupled to the forehead support 1360 proximate to a superior edge. The top strap portion may be connected to the display unit housing 1205 through the forehead support 1360.

In some forms, the top strap portion may be connected to the posterior support portion 1350. For example, the top strap portion may be connected proximate to a superior edge of the posterior support portion 1350.

In some forms, the top strap portion may overlay the frontal bone and the parietal bone of the user's head.

In certain forms, the top strap portion may extend along the sagittal plane as it extends between the anterior and posterior portions of the head-mounted display system 1000.

In certain forms, the top strap portion may apply a tensile force oriented at least partially in the superior direction, which may oppose the force of gravity.

In certain forms, the top strap portion may apply a tensile force oriented at least partially in the posterior direction, which may pull the interfacing structure 1100 toward the user's face (and supply a portion of the sealing force when the light shield acts as a seal-forming structure).

In some forms, the top strap portion may be adjustable in order to impart a selective tensile force on the display screen 1220 and/or the display unit housing 1205 in order to secure a position of the display screen 1220 and/or the display unit housing 1205.

In certain forms, the display unit housing 1205 and/or the forehead support 1360 (as the case may be) may include at least one loop or eyelet 1254, and the top strap portion may be threaded through that eyelet 1254, and doubled back on itself. The length of the top strap portion threaded through the eyelet 1254 may be selected by the user in order to adjust the tensile force provided by the positioning and stabilizing structure 1300. For example, threading a greater length of the top strap portion through the eyelet 1254 may supply a greater tensile force.

In some forms, the top strap portion may include an adjustment portion and a receiving portion. The adjustment portion may be positioned through the eyelet 1254, and may be coupled to the receiving portion (e.g., by doubling back on itself). The adjustment portion may include a hook material, and the receiving portion may include a loop material (or vice versa), so that the adjustment portion may be removably held in the desired position. In some examples, the hook material and the loop material may be Velcro.

### 5.3 Augmented Reality Display Interface

As shown in FIGS. 5A and 5B, a display apparatus or head-mounted display system 1000 in accordance with one aspect of the present technology comprises the following functional aspects: a display screen 1220, a display unit housing 1205, and a positioning and stabilizing structure 1300. In some forms, a functional aspect may provide one or more physical components. In some forms, one or more physical components may provide one or more functional aspects. In use, the display screen 1220 is arranged to be positioned proximate and anterior to the user's eyes, so as to allow the user to view the display screen 1220.

In other aspects, the head-mounted display system 1000 may also include an interfacing structure 1100, a controller 1270, a speaker 1272, a power source 1274, and/or a control system 1276. In some examples, these may be integral pieces of the head-mounted display system 1000, while in other examples, these may be modular and incorporated into the head-mounted display system 1000 as desired by the user.

### 5.3.1 Display Unit

The head-mounted display unit 1200 may include a structure for providing an observable output to a user. Specifically, the head-mounted display unit 1200 is arranged to be held (e.g., manually, by a positioning and stabilizing structure, etc.) in an operational position in front of a user's face.

In some examples, the head-mounted display unit 1200 may include a display screen 1220, a display unit housing 1205, and/or an interfacing structure 1100. These components may be integrally formed in a single head-mounted display unit 1200, or they may be separable and selectively connected by the user to form the head-mounted display unit 1200. Additionally, the display screen 1220, the display unit housing 1205, and/or the interfacing structure 1100 may be included in the head-mounted display system 1000, but may not be part of the head-mounted display unit 1200.

### 5.3.1.1 Display Screen

As shown in FIG. 5A, some forms of the head-mounted display unit 1200 include a display screen 1220. The display screen 1220 may include electrical components that provide an observable output to the user.

In one form of the present technology shown in FIG. 5A and FIG. 5B, a display screen 1220 provides an optical output observable by the user. The optical output allows the user to observe a virtual environment and/or a virtual object.

The display screen 1220 may be positioned proximate to the user's eyes, in order to allow the user to view the display screen 1220. For example, the display screen 1220 maybe positioned anterior to the user's eyes. The display screen 1220 can display computer generated images that can be view by the user in order to augment the user's physical environment (e.g., the computer generated images may appear as though they are present in the user's physical environment).

In certain forms, particularly when using the display screen 1220 in an AR or MR environment, the display screen 1220 may be turned off while the user continues to wear the display screen 1220 and interact with the physical environment. This may allow the user to selectively choose when to receive the virtual stimulation, and when to observe only the physical environment.

In certain forms, the display screen 1220 may be transparent (or translucent). For example, the display screen 1220 may be glass, so the user can see through the display screen 1220. This may be particularly beneficial in AR or MR applications, so that the user can continue to see the physical environment.

### 5.3.1.2 Display Housing

In some forms of the present technology as shown in FIGS. 5A and 5B, a display unit housing 1205 provides a support structure for the display screen 1220, in order to maintain a position of at least some of the components of the display screen 1220 relative to one another, and may additionally protect the display screen 1220 and/or other components of the head-mounted display unit 1200. The display unit housing 1205 may be constructed from a material suitable to provide protection from impact forces to the display screen 1220. The display unit housing 1205 may also contact the user's face, and may be constructed from a biocompatible material suitable for limiting irritation to the user.

A display unit housing 1205 in accordance with some forms of the present technology may be constructed from a hard, rigid or semi-rigid material, such as plastic.

In certain forms, the rigid or semi-rigid material may be at least partially covered with a soft and/or flexible material (e.g., a textile, silicone, foam, etc.). This may improve biocompatibility and/or user comfort because the at least a portion of the display unit housing 1205 that the user engages (e.g., grabs with their hands) includes the soft and/or flexible material.

A display unit housing 1205 in accordance with other forms of the present technology may be constructed from a soft, flexible, resilient material, such as silicone rubber.

In some forms, the display screen 1220 may project at least partially out of the display unit housing 1205. For example, unlike in a VR head-mounted display system 1000, the display screen 1220 in an AR (or MR) head-mounted display system 1000 may not be completely enclosed by the by the display unit housing 1205. The user may be able to directly view the display screen 1220, and may be able to look through the display screen 1220 (e.g., if the display screen 1220 is transparent or translucent).

In certain forms, the display unit housing 1205 may support sensors or other electronics described below. The display unit housing 1205 may provide protection to the electronics without substantially obstructing the user's view of the display screen 1220.

### 5.3.1.3 Interface Structure

As shown in FIGS. 5A and 5B, some forms of the present technology include an interfacing structure 1100 (also identified as an “interface”, “user interface”, “interface structure” or the like) is positioned and/or arranged in order to conform to a shape of a user's face, and may provide the user with added comfort while wearing and/or using the head-mounted display system 1000.

In some forms, the interfacing structure 1100 is coupled to a surface of the display unit housing 1205.

In some forms, the interfacing structure 1100 in accordance with the present technology may be constructed from a biocompatible material.

In some forms, the interfacing structure 1100 in accordance with the present technology may be constructed from a soft, flexible, and/or resilient material.

In certain forms, the interfacing structure 1100 in accordance with the present technology may be constructed from silicone rubber and/or foam.

In some forms, the interfacing structure 1100 may contact sensitive regions of the user's face, which may be locations of discomfort. The material forming the interfacing structure 1100 may cushion these sensitive regions, and limit user discomfort while wearing the head-mounted display system 1000.

In certain forms, these sensitive regions may include the user's forehead. Specifically, this may include the region of the user's head that is proximate to the frontal bone, like the Epicranius and/or the glabella. This region may be sensitive because there is limited natural cushioning from muscle and/or fat between the user's skin and the bone. Similarly, the ridge of the user's nose may also include little to no natural cushioning.

In some forms, the interfacing structure 1100 can comprise a single element. In some embodiments the interfacing structure 1100 may be designed for mass manufacture. For example, the interfacing structure 1100 can be designed to comfortably fit a wide range of different face shapes and sizes.

In some forms, the interfacing structure 1100 may include different elements that overlay different regions of the user's face. The different portions of the interfacing structure 1100 may be constructed from different materials, and provide the user with different textures and/or cushioning at different regions.

In some forms, the interface structure 1100 may include nasal pads (e.g., as used in eye-glasses) that may contact the lateral sides of the user's nose. The nasal pads may apply light pressure to the user's nose to maintain the position of the head-mounted display system 1000, but may not apply a force that causes significant discomfort (e.g., the nasal pads may not receive a posterior directed tensile force).

### 5.3.2 Positioning and Stabilizing Structure

As shown in FIGS. 5A to 5B, the display screen 1220 and/or the display unit housing 1205 of the head-mounted display system 1000 of the present technology may be held in position in use by the positioning and stabilizing structure 1300.

To hold the display screen 1220 and/or the display unit housing 1205 in its correct operational position, the positioning and stabilizing structure 1300 is ideally comfortable against the user's head in order to accommodate the induced loading from the weight of the display unit in a manner that minimise facial markings and/or pain from prolonged use. There is also need to allow for a universal fit without trading off comfort, usability and cost of manufacture. The design criteria may include adjustability over a predetermined range with low-touch simple set up solutions that have a low dexterity threshold. Further considerations include catering for the dynamic environment in which the head-mounted display system 1000 may be used. As part of the immersive experience of a virtual environment, users may communicate, i.e. speak, while using the head-mounted display system 1000. In this way, the jaw or mandible of the user may move relative to other bones of the skull. Additionally, the whole head may move during the course of a period of use of the head-mounted display system 1000. For example, movement of a user's upper body, and in some cases lower body, and in particular, movement of the head relative to the upper and lower body.

In one form the positioning and stabilizing structure 1300 provides a retention force to overcome the effect of the gravitational force on the display screen 1220 and/or the display unit housing 1205.

In one form of the present technology, a positioning and stabilizing structure 1300 is provided that is configured in a manner consistent with being comfortably worn by a user. In one example the positioning and stabilizing structure 1300 has a low profile, or cross-sectional thickness, to reduce the perceived or actual bulk of the apparatus. In one example, the positioning and stabilizing structure 1300 comprises at least one strap having a rectangular cross-section. In one example the positioning and stabilizing structure 1300 comprises at least one flat strap.

In one form of the present technology, a positioning and stabilizing structure 1300 is provided that is configured so as not to be too large and bulky to prevent the user from comfortably moving their head from side to side.

In one form of the present technology, a positioning and stabilizing structure 1300 comprises a strap constructed from a laminate of a textile user-contacting layer, a foam inner layer and a textile outer layer. In one form, the foam is porous to allow moisture, (e.g., sweat), to pass through the strap. In one form, a skin contacting layer of the strap is formed from a material that helps wick moisture away from the user's face. In one form, the textile outer layer comprises loop material to engage with a hook material portion.

In certain forms of the present technology, a positioning and stabilizing structure 1300 comprises a strap that is extensible, e.g. resiliently extensible. For example the strap may be configured in use to be in tension, and to direct a force to draw the display screen 1220 and/or the display unit housing 1205 toward a portion of a user's face, particularly proximate to the user's eyes and in line with their field of vision. In an example the strap may be configured as a tie.

In one form of the present technology, the positioning and stabilizing structure 1300 comprises a first tie, the first tie being constructed and arranged so that in use at least a portion of an inferior edge thereof passes superior to an otobasion superior of the user's head and overlays a portion of a parietal bone without overlaying the occipital bone.

In one form of the present technology, the positioning and stabilizing structure 1300 includes a second tie, the second tie being constructed and arranged so that in use at least a portion of a superior edge thereof passes inferior to an otobasion inferior of the user's head and overlays or lies inferior to the occipital bone of the user's head.

In one form of the present technology, the positioning and stabilizing structure 1300 includes a third tie that is constructed and arranged to interconnect the first tie and the second tie to reduce a tendency of the first tie and the second tie to move apart from one another.

In certain forms of the present technology, a positioning and stabilizing structure 1300 comprises a strap that is bendable and e.g. non-rigid. An advantage of this aspect is that the strap is more comfortable against a user's head.

In certain forms of the present technology, a positioning and stabilizing structure 1300 comprises a strap constructed to be breathable to allow moisture vapour to be transmitted through the strap,

In certain forms of the present technology, a system is provided comprising more than one positioning and stabilizing structure 1300, each being configured to provide a retaining force to correspond to a different size and/or shape range. For example the system may comprise one form of positioning and stabilizing structure 1300 suitable for a large sized head, but not a small sized head, and another suitable for a small sized head, but not a large sized head.

In some forms, the positioning and stabilizing structure 1300 may include cushioning material (e.g., a foam pad) for contacting the user's skin. The cushioning material may provide added wearability to the positioning and stabilizing structure 1300, particularly if positioning and stabilizing structure 1300 is constructed from a rigid or semi-rigid material.

### 5.3.2.1 Temporal Connectors

As shown in FIG. 5B, some forms of the positioning and stabilizing structure 1300 include temporal connectors 1250, each of which may overlay a respective one of the user's temporal bones in use. A portion of the temporal connectors 1250, in-use, are in contact with a region of the user's head proximal to the otobasion superior, i.e. above each of the user's ears.

The temporal connectors 1250 may be lateral portions of the positioning and stabilizing structure 1300, as each temporal connector 1250 is positioned on either the left or the right side of the user's head.

In some forms, the temporal connectors 1250 may extend in an anterior-posterior direction, and may be substantially parallel to the sagittal plane.

In some forms, the temporal connectors 1250 may be coupled to the display unit housing 1205. For example, the temporal connectors 1250 may be connected to lateral sides of the display unit housing 1205.

In some forms, the temporal connectors 1250 may be arranged in-use to run generally along or parallel to the Frankfort Horizontal plane of the head and superior to the zygomatic bone (e.g., above the user's cheek bone).

In some forms, the temporal connectors 1250 may be positioned against the user's head similar to arms of eye-glasses, and be positioned more superior than the anti-helix of each respective ear.

In some forms, the temporal connectors 1250 may have a generally elongate and flat configuration. In other words, each temporal connector 1250 is far longer and wider (direction from top to bottom in the paper plane) than thick (direction into the paper plane).

In some forms, the temporal connectors 1250 may each have a three-dimensional shape which has curvature in all three axes (X, Y and Z). Although the thickness of each temporal connector 1250 may be substantially uniform, its height varies throughout its length. The purpose of the shape and dimension of each temporal connector 1250 is to conform closely to the head of the user in order to remain unobtrusive and maintain a low profile (e.g., not appear overly bulky).

In some forms, the temporal connectors 1250 may be constructed from a rigid or semi-rigid material, which may include plastic, Hytrel (thermoplastic polyester elastomer), or another similar material. The rigid or semi-rigid material may be self-supporting and/or able to hold its shape without being worn. This can make it more intuitive or obvious for users to understand how to use the positioning and stabilizing structure 1300 and may contrast with a positioning and stabilizing structure 1300 that is entirely floppy and does not retain a shape. Maintaining the temporal connectors 1250 in the in-use state prior to use may prevent or limit distortion whilst the user is donning the positioning and stabilizing structure 1300 and allow a user to quickly fit or wear the head-mounted display system 1000.

In certain forms, the temporal connectors 1250 may be rigidizers, which may allow for a more effective (e.g., direct) translation of tension through the temporal connectors 1250 because rigidizers limit the magnitude of elongation or deformation of the arm while in-use.

In certain forms, the temporal connectors 1250 may be at least partially flexible in one direction and may be more rigid in another direction. A user may be able to bend or flex the temporal connector more in one direction than in another direction. For example, the temporal connectors 1250 may be at least partially flexible along an axis substantially parallel to the user's sagittal plane (e.g., in the superior-inferior direction while in use). This may allow the temporal connectors 1250 to conform to the shape of the user's head by moving in lateral directions toward or away from the user's head. The user also may be able to make multiple adjustments along the length of the temporal connectors 1250 to correspond to a variety of structures along the user's head. However, bending along an axis substantially parallel to the user's coronal plane (e.g., extending in the lateral direction in use) may be more difficult. The temporal connectors 1250 may resist bending in the superior-inferior direction.

In certain forms, the positioning and stabilizing structure 1300 may be designed so that the positioning and stabilizing structure 1300 springs ‘out of the box’ and generally into its in-use configuration. In addition, the positioning and stabilizing structure 1300 may be arranged to hold its in-use shape once out of the box (e.g., because rigidizers may be formed to maintain the shape of some or part of the positioning and stabilizing structure 1300). Advantageously, the orientation of the positioning and stabilizing structure 1300 is made clear to the user as the shape of the positioning and stabilizing structure 1300 is generally curved much like the rear portion of the user's head. That is, the positioning and stabilizing structure 1300 is generally dome shaped.

In certain forms, a flexible and/or resilient material may be disposed around the rigid or semi-rigid material of the temporal connectors 1250. The flexible material may be more comfortable against the user's head, in order to improve wearability and provide soft contact with the user's face. In one form, the flexible material is a textile sleeve at is permanently or removably coupled to each temporal connector 1250.

In one form, a textile may be over-moulded onto at least one side of the rigidizer. In one form, the rigidizer may be formed separately to the resilient component and then a sock of user contacting material (e.g., Breath-O-Prene™) may be wrapped or slid over the rigidizer. In alternative forms, the user contacting material may be provided to the rigidizer by adhesive, ultrasonic welding, sewing, hook and loop material, and/or stud connectors.

In some forms, the user contacting material may be on both sides of the rigidizer, or alternatively may only be on the user contacting side (e.g., the user contacting side) of the rigidizer to reduce bulk and cost of materials.

In some forms, the temporal connectors 1250 are constructed from a flexible material (e.g., a textile), which may be comfortable against the user's skin, and may not require an added layer to increase comfort.

Some forms of the positioning and stabilizing structure 1300 may include only temporal connectors 1250. The temporal connectors 1250 may be shaped like temples or arms of eye-glasses, and may rest against the user's head in a similar manner. For example, the temporal arms 1250 may provide a force directed into lateral sides of the user's head (e.g., toward the respective temporal bone).

### 5.3.2.2 Posterior Support Portion

As shown in FIG. 5B, some forms of the positioning and stabilizing structure 1300 may include a rear support, e.g. a posterior support portion 1350 for assisting in supporting the display screen 1220 and/or the display unit housing 1205 proximate to the user's eyes. The posterior support portion 1350 may assist in anchoring the display screen 1220 and/or the display unit housing 1205 to the user's head in order to appropriately orient the display screen 1220 proximate to the user's eyes.

In some forms, the posterior support portion 1350 may be coupled to the display unit housing 1205 via the temporal connectors 1250.

In certain forms, the temporal connectors 1250 may be directly coupled to the display unit housing 1205 and to the posterior support portion 1350.

In some forms, the posterior support portion 1350 may have a three-dimensional contour curve to fit to the shape of a user's head. For example, the three-dimensional shape of the posterior support portion 1350 may have a generally round three-dimensional shape adapted to overlay a portion of the parietal bone and the occipital bone of the user's head, in use.

In certain forms, the posterior support portion 1350 may include a three-dimensional shape that is curved about at least two axes. For example, a rearmost portion of the posterior support portion 1350 (e.g., the portion configured to overlay the user's occipital bone) may include a concave shape with respect to the user's occipital bone. This may assist the posterior support portion 1350 in “cupping” the rear of the user's head in order to provide a secure fit. Additionally, the posterior support portion 1350 may be curved about an axis substantially parallel to the user's coronal plane. For example, this second curvature may be about an axis that is substantially perpendicular to an axis of the first curvature (i.e., the section of the posterior support configured to overlay the user's occipital bone). The section with the second curvature may extend from the respective temporal connector 1250. This section may therefore overlay the user's temporal bone and/or the user's occipital bone. As viewed from the side (e.g., in FIG. 5B), the second curvature may be positive (e.g., “concave up”). This may be opposite of the curvature in the temporal connector 1250, although the curvatures may be about substantially parallel axes. For example, the curvature of the temporal connectors 1250 may be negative (e.g., “concave down”) as viewed in FIG. 5B. This may allow each temporal connector 1250 to curve about the respective user's ear.

In certain forms, the posterior support portion 1350 may be at least partially rigidized so that the round shape may be maintained even when not worn by the user. This may help the user don the posterior support portion 1350 as the rigidity may limit tangling.

In one form, the rigidity may provide “springiness” to the posterior support portion 1350. For example, the posterior support portion 1350 may “spring-to-life” after being compressed. In other words, the posterior support portion 1350 may be flexible enough to be folded but once a force is removed, the posterior support portion 1350 returns to its original shape (e.g., the three-dimensional round shape).

In some forms, the posterior support portion 1350 may be a posterior portion of the positioning and stabilizing structure 1300. The posterior support portion 1350 may provide an anchoring force directed at least partially in the anterior direction.

In certain forms, the inferior section 1320 the posterior support portion 1350 is the inferior-most portion of the positioning and stabilizing structure 1300. For example, the posterior support portion 1350 may contact a region of the user's head between the occipital bone and the trapezius muscle. The posterior support portion 1350 may hook against an inferior edge of the occipital bone (e.g., the occiput). The posterior support portion 1350 may provide a force directed in the superior direction and/or the anterior direction in order to maintain contact with the user's occiput.

In certain forms, the inferior section 1320 the posterior support portion 1350 is the inferior-most portion of the entire head-mounted display system 1000. For example, the posterior support portion 1350 may be positioned at the base of the user's neck (e.g., overlaying the occipital bone and the trapezius muscle more inferior than the user's eyes) so that the posterior support portion 1350 is more inferior than the display screen 1220 and/or the display unit housing 1205.

In certain forms, the superior section 1310 may overlay the parietal bones when in contact with the user's head. The round shape of the posterior support portion 1350 may allow the posterior support portion 1350 to sit substantially flat on the user's head while the inferior section 1320 contacts the user's head as described above.

In some forms, the posterior support portion 1350 may include a padded material, which may contact the user's head (e.g., overlaying the region between the occipital bone and the trapezius muscle). The padded material may provide additional comfort to the user, and limit marks caused by the posterior support portion 1350 pulling against the user's head.

In certain forms, the posterior support portion 1350 may be constructed from a textile material and/or a foam material. The materials may be biocompatible and comfortable to a user's head.

In one form, the posterior support portion 1350 may be constructed from a foam material that is at least partially covered by a fabric material. The outer fabric material may provide the comfortable feeling for the user's skin. The inner foam layer may allow the posterior support portion 1350 to compress and improve comfort.

### 5.3.2.3 Forehead Support

As shown in FIGS. 5A and 5B, some forms of the positioning and stabilizing structure 1300 may include a forehead support 1360 that can contact the user's head superior to the user's eyes, while in use. For example, the forehead support 1360 may overlay the frontal bone of the user's head. In certain forms, the forehead support 1360 may also be more superior than the sphenoid bones and/or the temporal bones. This may also position the forehead support 1360 more superior than the user's eyebrows.

In some forms, the forehead support 1360 may be an anterior portion of the positioning and stabilizing structure 1300, and may be disposed more anterior on the user's head than any other portion of the positioning and stabilizing structure 1300. The posterior support portion 1350 may provide a force directed at least partially in the posterior direction.

In some forms, the forehead support 1360 may include a cushioning material (e.g., textile, foam, silicone, etc.) that may contact the user, and may help to limit marks caused by the straps of the positioning and stabilizing structure 1300. The forehead support 1360 and the interfacing structure 1100 may work together in order to provide comfort to the user.

In some forms, the forehead support 1360 may be separate from the display unit housing 1205, and may contact the user's head at a different location (e.g., more superior) than the display unit housing 1205.

In some forms, the forehead support 1360 can be adjusted to allow the positioning and stabilizing structure 1300 to accommodate the shape and/or configuration of a user's face.

In some forms, the temporal connectors 1250 may be coupled to the forehead support 1360 (e.g., on lateral sides of the forehead support 1360). The temporal connectors 1250 may extend at least partially in the inferior direction in order to couple to the posterior support portion 1350.

In certain forms, the positioning and stabilizing structure 1300 may include multiple pairs of temporal connectors 1250. For example, one pair of temporal connectors 1250 may be coupled to the forehead support 1360, and one pair of temporal connectors 1250 may be coupled to the display unit housing 1205.

In some forms, the forehead support 1360 can be presented at an angle which is generally parallel to the user's forehead to provide improved comfort to the user. For example, the forehead support 1360 may position the user in an orientation that overlays the frontal bone, and is substantially parallel to the coronal plane. Positioning the forehead support substantially parallel to the coronal plane can reduce the likelihood of pressure sores which may result from an uneven presentation.

In some forms, the forehead support 1360 may be offset from a rear support that contacts a posterior region of the user's head (e.g., an area overlaying the occipital bone and the trapezius muscle). In other words, an axis along a rear strap would not intersect the forehead support 1360, which may be disposed more inferior and anterior than the axis along the rear strap. The resulting offset between the forehead support 1360 and the rear strap may create moments that oppose the weight force of the display screen 1220 and/or the display unit housing 1205. A larger offset may create a larger moment, and therefore more assistance in maintaining a proper position of the display screen 1220 and/or the display unit housing 1205. The offset may be increased by moving the forehead support 1360 closer to the user's eyes (e.g., more anterior and inferior along the user's head), and/or increasing the angle of the rear strap so that it is more vertical.

### 5.3.2.4 Adjustable Straps

Portions of the positioning and stabilizing structure 1300 may be adjustable, in order to impart a selective tensile force on the display screen 1220 and/or the display unit housing 1205 in order to secure a position of the display screen 1220 and/or the display unit housing 1205.

In some forms, the display unit housing 1205 may include at least one loop or eyelet 1254, and at least one of the temporal connectors 1250 may be threaded through that loop, and doubled back on itself (e.g., illustrated in FIG. 4B but applicable to FIGS. 5A and 5B). The length of a strap of the positioning and stabilizing structure 1300 threaded through the respective eyelet 1254 may be selected by the user in order to adjust the tensile force. For example, threading a greater length through the eyelet 1254 may supply a greater tensile force.

In some forms, at least one of the temporal connectors 1250 may include an adjustment portion 1256 and a receiving portion 1258. The adjustment portion 1256 may be positioned through the eyelet 1254 on the display unit housing 1205, and may be coupled to the receiving portion 1258 (e.g., by doubling back on itself). The adjustment portion 1256 may include a hook material, and the receiving portion 1258 may include a loop material (or vice versa), so that the adjustment portion 1256 may be removably held in the desired position. In some examples, the hook material and the loop material may be Velcro.

In certain forms, the strap may be constructed at least partially from a flexible and/or resilient material, which may conform to a shape of the user's head and/or may allow the adjustment portion to be threaded through the eyelet 1254. For example, the adjustment portion(s) 1256 may be constructed from an elastic textile, which may provide an elastic, tensile force. The remained of the temporal connectors 1250 may be constructed from the rigid or semi-rigid material described above (although it is contemplated that additional sections of the temporal connectors 1250 may also be constructed from a flexible material).

### 5.3.2.4.1 Top Strap Portion

In some forms, the positioning and stabilizing structure 1300 may include a top strap portion, which may overlay a superior region of the user's head.

In some forms, the top strap portion may extend between an anterior portion of the head-mounted display system 1000 and a posterior region of the head-mounted display system 1000.

In some forms, the top strap portion may be constructed from a flexible material, and may be configured to compliment the shape of the user's head.

In certain forms, the top strap portion may be connected to the display unit housing 1205. For example, the top strap portion may be coupled to the superior face 1230. The top strap portion may also be coupled to the display unit housing 1205 proximate to a posterior end of the display unit housing 1205.

In certain forms, the top strap portion may be coupled to the forehead support 1360. For example, the top strap portion may be coupled to the forehead support 1360 proximate to a superior edge. The top strap portion may be connected to the display unit housing 1205 through the forehead support 1360.

In some forms, the top strap portion may be connected to the posterior support portion 1350. For example, the top strap portion may be connected proximate to a superior edge of the posterior support portion 1350.

In some forms, the top strap portion may overlay the frontal bone and the parietal bone of the user's head.

In certain forms, the top strap portion may extend along the sagittal plane as it extends between the anterior and posterior portions of the head-mounted display system 1000.

In certain forms, the top strap portion may apply a tensile force oriented at least partially in the superior direction, which may oppose the force of gravity.

In some forms, the top strap portion may be adjustable in order to impart a selective tensile force on the display screen 1220 and/or the display unit housing 1205 in order to secure a position of the display screen 1220 and/or the display unit housing 1205.

In certain forms, the display unit housing 1205 and/or the forehead support 1360 may include at least one loop or eyelet 1254, and the top strap portion may be threaded through that eyelet 1254, and doubled back on itself. The length of the top strap portion threaded through the eyelet 1254 may be selected by the user in order to adjust the tensile force provided by the positioning and stabilizing structure 1300. For example, threading a greater length of the top strap portion through the eyelet 1254 may supply a greater tensile force.

In some forms, the top strap portion may include an adjustment portion and a receiving portion. The adjustment portion may be positioned through the eyelet 1254, and may be coupled to the receiving portion (e.g., by doubling back on itself). The adjustment portion may include a hook material, and the receiving portion may include a loop material (or vice versa), so that the adjustment portion may be removably held in the desired position. In some examples, the hook material and the loop material may be Velcro.

### 5.4 Interfacing Structure

FIGS. 7A-7D show a head-mounted display system 1000 according to one example of the present technology. The head-mounted display system 1000 comprises a head-mounted display unit 1200 comprising a display unit housing 1205 comprising a display. The display may be as described elsewhere herein. The head-mounted display unit 1200 further comprises an interfacing structure 1100 attached to the display unit housing 1205 and which may be constructed and arranged to be in opposing relation to the user's face in use. The head-mounted display system 1000 further comprises a positioning and stabilising structure 1300 which may be structured and arranged to hold the head-mounted display unit 1200 in an operable position on the user's head in use. The head-mounted display system 1000 may otherwise have any of the features, configurations, aspects, functions and the like as described elsewhere herein. FIGS. 8A-8C show views of the interfacing structure 1100 of one example of the present technology. The interfacing structure 1100 may be configured to attach to the display unit housing 1205 of the head-mounted display system 1000 and may be removably attachable to the display unit housing 1205. The interfacing structure 1100 may be provided around a periphery of the user's eye region in use, for examples around substantially the entire periphery.

### 5.4.1 Face Engaging Portion and Chassis Portion

The interfacing structure 1100 may comprise a face engaging portion 1110 configured to engage the user's face in use. The face engaging portion 1110 may be flexible and resilient. In some examples, the face engaging portion 1110 is formed at least partially from an elastomeric material, such as silicone or a TPE, for example. The face engaging portion 1110 may comprise one or more cushions, which may be formed from foam for example. The face engaging portion 1110 may comprise a face engaging membrane which may at least partially surround or may cover the cushion. The face engaging membrane 1116 may be formed from an elastomeric material, such as silicone or a TPE.

Any suitable face engaging portion 1110 is contemplated for the head-mounted display system 1000. It is to be understood that, unless context requires otherwise, any features of a face engaging portion (such as described with reference to FIGS. 4A-4B or FIGS. 5A-5B) described elsewhere herein may be applied to an interfacing structure 1100 shown in FIGS. 7A-7D or 8A-8C.

The interfacing structure 1100 may also comprise a chassis portion 1101 constructed and arranged to support the face engaging portion 1110. The chassis portion 1101 may be constructed and arranged to connect to the display unit housing 1205 of the head-mounted display system 1000. The chassis portion 1101 may be attached in use to the display unit housing 1205, for example by a releasable snap fit, press fit or permanent attachment. The face engaging portion 1110 is attached to the chassis portion 1101 in the illustrated example. In the case of an interfacing structure 1100 that is provided around an entire periphery of the user's eye region in use, the chassis portion 1101 may also be provided around the entire periphery of the user's eye region. More generally, the chassis portion 1101 may have a shape corresponding to a shape of the face engaging portion 1110 and may have a portion aligned in use with the user's forehead, portions aligned with the sides of the user's face lateral of the user's eyes, portions aligned with the user's cheeks and, in the case of the example shown in FIGS. 7A-7D, the chassis portion 1101 also comprises a portion corresponding to the user's nose region. The chassis portion 1101 in this example extends along a path medially with respect to the cheek portions 1140 and intersects the mid-sagittal plane in use, for example proximate the user's pronasale.

The face engaging portion 1110, or a portion thereof, may be overmoulded to the chassis portion 1101. The face engaging portion 1110 or a portion thereof may be formed from an elastomeric material such as silicone or TPE and may be overmoulded to the chassis portion 1101. The chassis portion 1101 may be formed from a substantially rigid or semi rigid material such as polycarbonate, polyethylene, ABS, polypropylene, nylon or the like. In other examples, the face engaging portion 1110 may be attached to the chassis portion 1101 by a means other than overmoulding, such as by an adhesive or other bond, snap fit, press fit, hook and loop connections, or any other suitable connection.

The chassis portion 1101 may be constructed to support the face engaging portion 1110, and may be stiffer than the face engaging portion 1110. The chassis portion 1101 may be formed from a stiffer material than the material(s) forming chassis portion 1101. The chassis portion 1101 may additionally or alternatively comprise a shape that requires a greater force to deform than the face engaging portion 1110.

The face engaging portion 1110 and chassis portion 1101 may together form a component that can be releasably attached to the head-mounted display unit 1200, may be replaceable and which may made available to users in different sizes and/or configurations.

With particular reference to FIGS. 7A-7D and 8A-8C, the interfacing structure 1100 in this example comprises a pair of cheek portions 1140 constructed and arranged to engage the user's cheeks in use. In this example, the face engaging portion 1110 is also configured engage the sides of the user's face lateral of the user's eyes and also configured to engage the user's forehead in use. The portions which engage the sides of the user's face lateral of the user's eyes may be identified as sphenoid portions 1170. That is, the interfacing structure 1100 may comprise a pair of sphenoid portions 1170 configured to engage sphenoid regions of the user's face in use. The portion which engages the user's forehead may be identified as a forehead portion 1175. That is, the interfacing structure 1100 may comprise a forehead portion constructed and arranged to engage the user's forehead in use. The face engaging portion 1110 may engage the user's face at regions overlying the user's nose, maxilla, zygomatic bones, sphenoid bones and frontal bones. The face engaging portion 1110 may engage the user's face in region shown in FIG. 4D, for example.

### 5.4.2 Immersive and Non-Immersive Modes

In some examples of the present technology, the chassis portion 1101 defines at least one opening 1105 positioned around the periphery of the user's eye region within the user's field of view. The interfacing structures 1100 shown in FIGS. 7A-7D and 8A-8C include openings 1105. The interfacing structure 1100 may be constructed and arranged to be convertible between a non-immersive mode and an immersive mode. In the non-immersive mode, the user may be able to see through the opening 1105. In the immersive mode, light may be substantially prevented from passing through the opening 1105.

The ability to switch between a non-immersive and an immersive mode may advantageously enhance the user's experience when the user switches between use of the head-mounted display system 1000 for virtual reality and augmented or mixed reality. In some scenarios, the head-mounted display system 1000 may be used in non-immersive applications for viewing the world around the user through the display in the head-mounted display system 1000, for example during augmented reality or mixed reality applications. However, during such use, an interfacing structure 1100 which is fully enclosed around the periphery of the user's eye region and which does not allow for peripheral vision, could in some users result in motion sickness and/or excessive fog, sweat and/or heat, especially during vigorous use such as gaming and exercising. Additionally, or alternatively, the lack of peripheral vision may prevent or make it more difficult for the user to interact with their surroundings, for example when using a keyboard and mouse while using the head-mounted display system 1000. Conversely, in scenarios in which the head-mounted display system 1000 is used for immersive applications in which the real world is not intended to be viewed, light from the outside world reaching the user's eyes, or the ability for the user to see the real world with peripheral vision, may adversely affect the user's immersion in the experience.

One approach to addressing the above is to use a separate head-mounted display system 1000 or interfacing structure 1100 tailored for each application, e.g. an “open” interfacing structure 1100 for non-immersive use and a “closed” interfacing structure 1100 for immersive use. However, this requires the user to have multiple head-mounted display systems 1000 or interfacing structures 1100 and it may be time consuming or inconvenient to switch between the two. The head-mounted display system 1000 or interfacing structure 1100 according to examples of the present technology may advantageously allow the user to quickly switch between immersivity and non-immersivity without removing the head-mounted display system 1000.

### 5.4.3 Shield for Opening

In some examples, such as the examples shown in FIGS. 7A-7D and 8A-8C, the interfacing structure 1100 may comprise at least one shield 1150 constructed and arranged to block light through the at least one opening 1105. The shield 1150 may be able to be manipulated by the user to convert the interfacing structure 1100 to the non-immersive mode by substantially unblocking the opening 1105. Additionally, the shield 1150 may be able to be manipulated by the user to convert the interfacing structure 1100 to the immersive mode by substantially blocking the opening 1105.

Referring to FIGS. 8A-8C in particular, the shield 1150 may be attachable to the chassis portion 1101 to convert the interfacing structure 1100 to the immersive mode. The shield 1150 may also be removable from the chassis portion 1101 to convert the interfacing structure 1100 to the non-immersive mode. The shield 1150 may be substantially rigid. In examples, the shield 1150 may be formed from one of polycarbonate, polyethylene, ABS, polypropylene, nylon or the like. Alternatively the shield 1150 may be semi-rigid or flexible. In other examples the shield 1150 may be formed from an elastomeric material such as silicone or a TPE. The shield 1150 may be formed from the same material as the chassis portion 1101 or may be formed from a different material.

The shield 1150 may be constructed and arranged to form a snap fit connection to the chassis portion 1101 during attachment to the chassis portion 1101. Additionally, or alternatively, the chassis portion 1101 and shield 1150 are constructed and arranged so that the shield 1150 is magnetically attracted to the chassis portion 1101. In the example shown in FIGS. 8A-8C, the shield 1150 is magnetically attracted to the chassis portion 1101 to aid in alignment of the shield 1150 to the chassis portion 1101, and the shield 1150 is also constructed to form a snap fit connection to the chassis portion 1101. Advantageously the magnetic attraction may prevent or at least lessen any difficulty in aligning the shield 1150 to the opening 1105 which may occur due to the user being unable to see the outside of the interfacing structure 1100 while wearing the head-mounted display system 1000. After alignment and attachment, a mechanical snap fit attachment may hold the shield 1150 securely to the chassis portion 1101. In other examples, there may be only a snap fit attachment, or only a magnetic attachment (for example if the magnetic attraction is sufficiently strong). In further examples, an alternative manner of connection between the shield 1150 and the chassis portion 1101 may be provided, such as a hook-and-loop connection or a latch or clip connection.

The shield 1150 may comprise at least one magnet 1154 (see FIG. 8B). The magnet 1154 may be positioned to be attracted to a corresponding magnet or ferromagnetic component in or on the chassis portion 1101. In the example shown in FIGS. 8A-8C, the chassis portion 1101 and the shield 1150 are constructed and arranged so that the shield 1150 is magnetically attracted to the chassis portion 1101 at opposite ends of the shield 1150. In this example each shield 1150 comprises a magnet 1154 at each respective end thereof.

In some examples, the shield 1150 comprises at least one grip portion 1159 to aid gripping of the shield 1150 by the user. The grip portion 1159 may be a portion of the shield 1150 structured to make it easier for a user to grip the shield 1150, such as a portion shaped to form a ledge, or a portion with a surface or feature that provides for high friction when gripped. In the example shown in FIGS. 8A-8C, the grip portion 1159 is at least partially formed by a curved portion of the shield 1150 forming a ledge able to be gripped by the user. The curved portion is this particular example comprises a concave portion. The curved portion may be shaped to be easily gripped by a thumb or forefinger. The curved portion may also include or be adjacent to a convex portion, which may form a ledge also able to be gripped or engaged by a user's thumb or forefinger. In the example shown in FIGS. 8A-8C, the shield 1150 comprises a pair of grip portions 1159 each provided at a respective end of the shield 1150 configured to aid the user in gripping the shield 1150 with a thumb and forefinger. This may advantageously provide for a shield 1150 that is easily manipulated (e.g. removed or attached) with just two fingers on one hand, providing for good usability.

Also in the example shown in FIGS. 8A-8C, the grip portion 1159 is at least partially formed by a vent 1152 constructed and arranged to allow airflow through the opening 1105 when the interfacing structure 1100 is in the immersive mode. The grip portion 1159 may be at least partially formed by a plurality of vent holes, forming the vent 1152. The vent holes may be constructed to provide texture to the grip portions 1159 which make the grip portions easy to grip. The vent holes may provide increased friction in comparison to a smooth surface, which may advantageously increase the ease with which the user is able to grip the grip portion 1159.

### 5.4.4 Venting

In some examples of the present technology, the interfacing structure comprises one or more vents 1152. The one or more vents 1152 may advantageously allow for heat and/or moisture dissipation from within the interior of the interfacing structure 1100. This may be highly desirable during vigorous use of the head-mounted display system 1000.

In some examples, the shield 1150 comprises at least one vent 1152 constructed and arranged to allow airflow through the opening 1105 when the interfacing structure 1100 is in the closed configuration. In some examples, a shield 1150 may comprise a plurality of vents 1152. In the example shown in FIGS. 8A-8C, each shield 1150 comprises two vents 1152. One vent 1152 is provided at an upper end of each shield 1150 and another vent 1152 is provided at a lower end of each shield 1150, in this example.

A vent 1152 may be formed by at least one vent hole formed in the shield 1152. In some examples, such as the example shown in FIGS. 8A-8C, each vent 1152 is formed by a plurality of vent holes.

In some forms of the present technology, the interfacing structure 1100 may comprise a vent cover portion 1155 constructed and arranged to block light through the at least one vent 1152, either by blocking light from reaching the vent 1152 or by blocking light after it passes through the vent 1152. The vent cover portion 1155 may take a range of forms and positions in various examples. The vent cover portion 1155 may prevent light from reaching the user's eyes via the vent 1152. In some examples, the shield may comprise the vent cover portion 1155. FIG. 9A shows a schematic cross section view of a shield 1150 comprising a vent cover portion 1155. The vent cover portion 1155 in this example is a portion of the shield 1150 which lies over vent holes forming the vent 1152, blocking light from passing through the vent holes 1152. In other example, the vent cover portion 1155 may block light that passes through the vent holes 1152. When the interfacing structure 1100 is in the immersive mode, light leak into the interior of the interfacing structure 1100 may interfere with the experience of using the head-mounted display system 1000. Advantageously, the vent cover portion 1155 blocks light through the vent 1152 while still allowing air flow in and out of the vent 1152.

The vent cover portion 1155 may be positioned on the outside of the vent 1152 with respect to the periphery of the user's eye region, or may be positioned inside of the vent 1152 with respect to the periphery of the user's eye region. FIG. 9A illustrates an example in which the vent cover portion 1155 is provided exteriorly to the vent holes forming the vent 1152. In the example shown in FIGS. 8A-8C the vent cover portion 1155 is provided on the inside of the vent 1152. As illustrated, the vent holes forming the vent 1152 are visible on the outside of the interfacing structure 1100 and the vent cover portion 1155 is located inside with respect to the periphery of the user's eye region.

In some examples, the vent cover portion 1155 is integrally formed with the shield 1150. For example, the vent cover portion 1155 may be moulded together with the remainder of the shield 1150 in a single moulding operation/shot. In other examples, the vent cover portion 1155 may be formed separately and attached to the shield 1150.

In other examples of the present technology, the shield 1150 and the chassis portion 1101 together define at least one vent opening between the chassis portion 1101 and an edge of the shield 1150 in the closed configuration. The at least one vent opening may form the at least one vent 1152 in such a configuration. FIG. 9B shows an example of this arrangement. In this example the shield 1150 is larger than the opening 1105. The shield 1150 is depicted schematically as attached to the chassis portion 1101 but in practice may be attached to the chassis portion 1101 in any suitable manner, such as by way of a mechanical (e.g. snap fit) or magnetic connection. In this example the shield 1150 and the chassis portion 1101 together form a tortuous path 1156 in the closed configuration to allow airflow through the vent 1152 while blocking light from passing from the exterior of the interfacing structure 1100 to the interior thereof and affecting the immersivity of the head-mounted display system 1000.

In the example shown in FIG. 9B, the shield 1150 comprises at least one shield protrusion 1157 protruding towards the chassis portion 1101 to at least partially form the tortuous path 1156. Also in this example, the chassis portion 1101 comprises at least one chassis protrusion 1158 protruding towards the shield 1150 to at least partially form the tortuous path 1156. In other examples there may be more protrusions from the chassis portion 1101 and/or shield 1150, or the tortuous path 1156 may be formed in another way, such as by other complimentary shapes of the chassis portion 1101 and the shield 1150 forming a winding path that allows airflow but prevents light from reaching the user's eyes.

### 5.4.5 Structure and Location of Opening

In some forms of the present technology, the at least one opening 1105 comprises a group of openings. In such examples, the shield 1150 may be constructed and arranged to block light through the group of openings. An opening 1105 may be a single opening or a group of openings. In some examples, the chassis portion may comprise one or more bars, each of the one or more bars positioned between and partially defining the openings of a group of openings. In the example shown in FIGS. 8A-8C, each opening 1105 is in the form of a group of openings and the chassis portion 1101 comprise a plurality of bars partially defining the openings. In some examples, the chassis portion 1101 comprises a plurality of bars defining a lattice structure. The lattice structure may a hexagonal lattice structure, for example, or alternatively may be any other suitable structure. The bars, or other members or portions of the chassis portion 1101 which split what would otherwise be a single large opening 1105 into a group of openings, may also advantageously provide strength and/or stiffness to the chassis portion 1101 in the region of the opening 1105. This may advantageously allow the chassis portion 1101 to hold its shape and provide the necessary support to the face engaging portion 1110 while also providing an opening 1105 to allow the user to use the interfacing structure 1100 in a non-immersive mode.

The opening 1105 or openings 1105, as the case may be, may be positioned in various locations around the interfacing structure 1100. In some examples, at least one opening 1105 is located in the forehead portion 1175 of the interfacing structure 1100. As shown in FIG. 7C, the interfacing structure 1100 comprises a pair of openings 1105, one on either lateral side of the interfacing structure 1100 in the forehead portion 1175. Advantageously, this may allow the user to have at least partially unobstructed peripheral vision in the superior direction. In some examples, at least one opening 1105 is located in one of the sphenoid portions 1170 of the interfacing structure 1100. In some examples, such as that shown in FIGS. 7A and 7B, the interfacing structure 1100 comprises a pair of openings 1105 each located in a respective one of the sphenoid portions 1170. Advantageously, this may allow the user to have at least partially unobstructed peripheral vision in the lateral directions. In some examples, at least one opening 1105 is located in one of the cheek portions 1140 of the interfacing structure 1100. As shown in FIG. 7D for example, the interfacing structure 1100 comprises a pair of openings 1105 each located in a respective one of the cheek portions 1140. Advantageously, this may allow the user to have at least partially unobstructed peripheral vision in the inferior direction. At least some peripheral vision in the inferior direction may be particularly advantageous as it may enable the user to more easily perform certain tasks in the non-immersive mode, such as interacting with objects below their eye level such as a keyboard or mouse while viewing items or content at their eye level.

In some examples, such as the example shown in FIGS. 8A-8C, the interfacing structure 1100 may comprise comprises a lower left opening 1105 and a lower right opening 1105. The lower left opening 1105 may be located in a left cheek portion 1140 of the cheek portions and a left sphenoid portion 1170 of the sphenoid portions. Similarly, the lower right opening 1105 may be located in a right cheek portion 1140 of the cheek portions and a right sphenoid portion 1170 of the sphenoid portions. Advantageously, in this arrangement the openings 1105 may each provide for peripheral vision in lateral, inferior and latero-inferior directions. In some further examples the interfacing structure 1100 may comprise a pair of openings 1105, each opening 1105 positioned on a respective lateral side of the interfacing structure 1100 and each being positioned with the forehead portion 1175 as well as within a respective sphenoid portion 1170 and a respective cheek portion 1140.

In some examples, such as the example shown in FIGS. 8A-8C, there is no opening 1105 in the chassis portion 1101 in the forehead portion 1175 of the interfacing structure 1100. Furthermore, in this particular example, there is no opening 1105 in the chassis portion 1101 of the interfacing structure 1101 superior to the user's eyes. An interfacing structure 1100 comprising generous openings 1105 inferior to the user's eyes, e.g. in the lower portions of the sphenoid portions 1175 and in the cheek portions 1140, but no opening superior to the user's eyes, may advantageously provide for peripheral vision, situational awareness and grounding, while also blocking light from above.

In other examples, the interfacing structure 1100 comprises openings 1105 superior to the user's eyes separate to the openings 1105 inferior to the user's eyes, to enable the user to block light from above while allowing peripheral vision below, if desired.

Regardless of where on the interfacing structure 1100 the opening 1105 or openings 1105 may be, the interfacing structure 1100 may comprise a shield 1150 corresponding to the opening 1105. The shield 1150 may be constructed and arranged to fill or cover the opening 1105.

Some existing head-mounted display systems 1000 intended for non-immersive use such as augmented or mixed reality include a forehead pad but otherwise a fully open periphery. Some users may consider an interfacing structure 1100 that engages their face around the full periphery of their eye region (e.g. forehead, sphenoids and cheeks) to be more comfortable than one that engages the forehead only. This added comfort may be due to a better pressure distribution provided by a “full face” interfacing structure 1100 than a forehead pad alone.

### 5.4.6 Additional Immersive Mode Examples

In some forms of the present technology, the interfacing structure 1100 may comprise one or more alternative shields 1150 for covering, filling or otherwise blocking openings 1105 in the immersive mode of the interfacing structure 1100, or may comprise something other than a shield 1150 to substantially prevent light from passing through openings 1105.

In some examples, the shield 1150 comprises a curtain attached to the chassis portion 1101. At least a portion of the curtain may be slidable with respect to the chassis portion 1101 to substantially block the opening 1105 during conversion of the interfacing structure 1100 to the immersive mode and substantially unblock the opening 1105 during conversion of the interfacing structure 1100 to the non-immersive mode. The user may be able to pull the curtain across the opening 1105 to block the opening 1105 and may be able pull or push the curtain back across the opening 1105 to unblock the opening 1105, to convert the interfacing structure 1100 between the immersive and non-immersive modes. The curtain may be opaque, to block light. In some examples the curtain is formed from a textile material, which may help provide the interfacing structure 1100 with a comfortable appearance. The curtain may be breathable, which may help with heat and moisture dissipation in the immersive mode. In some examples the curtain is elastically stretchable, which may advantageously enable the curtain to be taut in the immersive mode. The curtain may be attached to the chassis portion 1101 under tension in the immersive mode.

In further examples, the shield 1150 is slidable with respect to the chassis portion 1101. The shield 1150 may be constructed and arranged to be moved to substantially block the opening 1105 during conversion of the interfacing structure 1100 to the immersive mode and substantially unblock the opening 1105 during conversion of the interfacing structure 1100 to the non-immersive mode. The shield 1150 may be substantially rigid and may function as an opaque window. The shield 1150 may slide on a rail or within a channel of the chassis portion 1101, as examples only.

In some examples, the shield 1150 comprises one or more rotatable portions rotatably connected to the chassis portion 1101. The one or more rotatable portions may be rotatable to a closed configuration to convert the interfacing structure 1100 to the immersive mode. Similarly, the one or more rotatable portions may be rotatable to an open configuration to convert the interfacing structure 1100 to the non-immersive mode.

In some examples, the shield 1150 comprises a hinged door openable to convert the interfacing structure 1100 to the non-immersive mode and closeable to convert the interfacing structure 1100 to the immersive mode. The door may be hinged to the chassis portion 1101 to enable the door to be pivoted open and closed to covert between the non-immersive and immersive modes. In some examples, the hinged door may be constructed to fold in on itself so as to be secure in the non-immersive mode.

In some examples, the opening 1105 is filled by an electronic screen. The screen may be controllable to be opaque in the immersive mode and substantially transparent in the non-immersive mode. Advantageously, this option may not require any direct physical interaction with the interfacing structure 1100 by the user to move a component over or away from the opening 1105. The screen in such examples may be an electro-optical device, such as an LCD screen or the like able to be operated to be transparent or opaque as desired. In some examples the screen may be provided to a clear window filling the opening.

### 5.4.7 Nasal Portion

FIGS. 10A and 10B show an interfacing structure 1100 according to another example of the present technology. In this example, the interfacing structure 1100 comprises a nasal portion 1180 configured to engage the user's nose in use. The nasal portion 1180 may be configured to at least partially block light from reaching the user's eyes from the user's nose region (e.g. block light travelling superiorly via a path proximate the surfaces of the user's nose). The nasal portion 1180 may for example be configured to engage anterior, superior and/or lateral surfaces of the user's nose in use. The nasal portion 1180 may be positioned between the cheek portions 1140 of the interfacing structure 1100 and may span between the cheek portions 1140. In this example, the nasal portion 1180 is removeable.

In the example shown in FIGS. 10A and 10B, the interfacing structure 1100 is constructed and arranged to be convertible between a non-immersive mode and an immersive mode. In the non-immersive mode, the nasal portion 1180 is removed from the interfacing structure 1100. In the immersive mode, the nasal portion is attached to the interfacing structure between the cheek portions to engage the user's nose in use and substantially block light from reaching the user's eyes from the user's nose region. In the non-immersive mode, the user may have the some peripheral vision in an inferior direction past their nose, or may at least be able to see their nose in their peripheral vision. Some users of head-mounted display systems have uses software that adds a “virtual nose” to the content displayed in order to help ground themselves and avoid motion sickness. The ability to selectively remove the nasal portion 1180 of the interfacing structure 1100 may provide a similar effect.

As shown in FIG. 10B in particular, the nasal portion 1180 of the interfacing structure 1100, in this example, comprises a nasal face engaging portion 1183 and a nasal chassis portion 1181. The nasal chassis portion 1181 may be constructed to connect to the chassis portion 1101 of the interfacing structure 1100 to attach the nasal portion 1180 to the interfacing structure 1100 during conversion to the immersive mode. The nasal chassis portion 1181 may be constructed to support the nasal face engaging portion 1183 and may be substantially rigid. The nasal face engaging portion 1183 may be flexible and the nasal chassis portion 1181 may be stiffer than the nasal face engaging portion 1183. The nasal face engaging portion 1183 may be formed from an elastomeric material such as silicone, TPE or the like, and may be formed from a material that is also used for the portions of the face engaging portion 1110 that engage the cheeks, sphenoid regions or forehead. The nasal chassis portion 1181 may be formed from ABS, polycarbonate, Hytrel, polypropylene, polyethylene, nylon or any suitable material, and may be formed form the same material as the chassis portion 1101 that engages the display unit housing 1205.

The nasal portion 1180 may comprise lateral sides which are shaped and sized to align with the cheek portions 1140 of the face engaging portion 1110 in the immersive mode to substantially prevent light passing between the nasal portion 1180 and the cheek portions 1140. Advantageously, this may provide for an immersive user experience in the immersive mode with a nasal portion 1180 that is able to be removed to convert the interfacing structure 1100 to a non-immersive mode.

The removable nasal portion 1180 described with reference to FIGS. 10A and 10B and the openings 1105 described with reference to FIGS. 7A-8C are not mutually exclusive. In examples, an interfacing structure 1100 may comprise openings 1105, a removable nasal portion 1180, or both. Advantageously, an interfacing structure 1100 with both a removable nasal portion 1180 and openings 1105 elsewhere around the interfacing structure 1100 may provide very little obstruction to the user's peripheral vision in the non-immersive mode.

Also as shown in FIGS. 10A and 10B, the nasal portion 1180 in this example comprises an inferior portion 1182, which may be positioned proximate the user's pronasale in use. the inferior portion 1182 may comprise a concave anteriorly-facing surface and may be dome shaped. For example, the inferior portion 1182 may be generally concave and dome shaped when viewed from the inferior although may comprise complex curvature rather than being perfectly hemispherical. In some examples, the inferior portion 1182 may occupy a space superior, anterior and/or laterally of the user's pronasale in use.

Additionally, the nasal portion 1180 in this example comprises a first flap 1186 and a second flap 1186 each connected to the inferior portion 1182. The first flap 1186 may be configured to engage a first lateral side of the user's nose in use and the second flap 1186 may be configured to engage a second lateral side of the user's nose in use. In this example the first flap 1186 and the second flap 1186 are separated by a slot.

The first flap 1186 and second flap 1186 may contact the user's nose along the nasal ridge, and may extend toward the user's sellion. The first flap 1186 and second flap 1186 may extend to the user's sellion or may extend only partially along the user's nasal ridge. For example, the nasal portion 1180 may be constructed and arranged to extend in an at least partially superior direction at least partially between the user's pronasale and sellion. In some examples the nasal portion 1180 may contact a majority of the user's nasal ridge in use. The first flap 1186 may be located on a first side of the mid-sagittal plane of the user's head and the second flap 1186 may be located on the second side of the mid-sagittal plane of the user's head. The first and second flaps 1186 in the examples shown in FIGS. 10A and 10B bridge between cheek portions 1140 and respective lateral sides of the user's nose in the immersive mode.

### 5.4.8 Attachment to Head-Mounted Display Unit

FIGS. 11-14 show views of an interfacing structure 1100 and components thereof according to further examples of the present technology. The interfacing structure 1100 is for a head-mounted display system 1000 comprising a head-mounted display unit 1200. The head-mounted display unit 1200 may be as described elsewhere herein, and may comprise a display unit housing 1205 comprising a display. The head-mounted display unit 1200 comprises the interfacing structure 1100 in this example. The interfacing structure 1100 may be attached to the display unit housing 1205 in use. Furthermore, the interfacing structure 1100 may be constructed and arranged to be in opposing relation to a user's face in use and may be provided around the user's eye region in use. The head-mounted display system 1000 may otherwise have any of the features, configurations, aspects, functions and the like as described elsewhere herein. For example, the head-mounted display system 1000 may comprise a positioning and stabilising structure 1300 structured and arranged to hold the head-mounted display unit 1200 in an operable position on the user's head in use.

The interfacing structure 1100 may comprise a face engaging portion 1110 configured to engage the user's face in use. The face engaging portion 1110 may be flexible and resilient. The face engaging portion 1110 may be formed at least partially from an elastomeric material, such as silicone or a TPE, for example.

It is to be understood that, unless context requires otherwise, any features of an interfacing structure and/or face engaging portion (such as described with reference to FIGS. 4A-4B, FIGS. 5A-5B or FIGS. 7A-10B) described elsewhere herein may be applied to an interfacing structure 1100 such as that shown in FIGS. 11-14. These interfacing structures 1100 may be particularly suited to use in a head-mounted display system 1000 configured for VR, such as that described with reference to FIGS. 4A-4B or FIGS. 7A-7D, for example. However, it is to be understood that the interfacing structure 1100 described with reference to FIGS. 11-14, or individual features thereof, may be applied in a head-mounted display system 1000 configured for use in any of VR, MR, AR or other artificial reality.

The face engaging portion 1110 may be formed at least partially from an elastomeric material, such as silicone or a TPE. In some examples the face engaging portion 1110 may be formed at least partially from foam.

The face engaging portion 1110 may be configured to engage the user's face around a periphery of the user's eyes in use. The face engaging portion 1110 may be configured to engage the sides of the user's face lateral of the user's eyes and engage the user's forehead in use. The face engaging portion 1110 may engage the user's cheeks, the sides of the user's face lateral of the user's eyes and the user's forehead. The face engaging portion 1110 may engage the user's face at regions overlying the user's nose, maxilla, zygomatic bones, sphenoid bones and frontal bones. The face engaging portion 1110 may engage the user's face in region shown in FIG. 4D, for example. The face engaging portions 1110 of the interfacing structure 1100 shown in FIGS. 11-14 may engage the user's face in the same regions as the face engaging portions 1110 shown in FIGS. 7A-10B.

With particular reference to FIGS. 11-14, the face engaging portion 1110 may in some forms comprise a nasal portion 1180 configured to engage the user's nose in use. The nasal portion 1180 may be configured to at least partially block light from reaching the user's eyes from the user's nose region (e.g. block light travelling via a path proximate the surfaces of the user's nose). The nasal portion 1180 may for example be configured to engage anterior, superior and/or lateral surfaces of the user's nose in use. The nasal portion 1180 may be as described with reference to any of FIGS. 7A-10B and/or may be removable as described with reference to FIGS. 10A-10B.

In the examples shown in FIGS. 11-14, the interfacing structure 1100 comprises a chassis portion 1101. The face engaging portion 1110 may be attached to the chassis portion 1101. In some examples, some or all of the face engaging portion 1110 may be permanently attached (e.g. by overmoulding, adhesion or permanent snap fitting) to the chassis portion 1101. In such forms the chassis portion 1101 and face engaging portion 1110 form a unitary component. In other examples the face engaging portion 1110 may be releasably attached to the chassis portion 1101.

The interfacing structure 1100 may comprise one or more clips 1102. The one or more clips 1102 may be attached to the chassis portion 1101 and configured to attach the interfacing structure 1100 to the display unit housing 1205 in use. In the example shown in FIGS. 11-14, the clips 1102 are formed separately from the chassis portion 1101. Advantageously, this allows for the clips 1102 to be formed from a different material and/or formed from a different manufacturing process to the chassis portion 1101. This may also simplify manufacturing of the chassis portion 1101, which may be less complex due to the lack of integral clips. In some examples, multiple interfacing structures 1100 having different shapes and/or sizes and may be produced, with all of them configured to be fitted with the clips 1102.

In some examples, the face engaging portion 1110 and chassis portion 1101 may comprise a singular component be constructed and arranged to be releasably attached to the display unit housing 1205 with the clips 1102. In some examples the face engaging portion 1110 and chassis portion 1101 may be constructed and arranged to be releasably attached to the display unit housing 1205 via another component or portion of the head-mounted display unit 1200, such as a spacer or other intermediate component.

In the examples shown in FIGS. 11-14, each of the one or more clips 1102 is permanently attached to the chassis portion 1101. In the example shown in FIG. 12, a pin 1104 retains each clip 1102 (described in more detail below). The clip 1102 may additionally or alternatively be glued to the chassis portion 1101. In the example shown in FIG. 10, the clip 1102 forms a permanent snap fit connection to the chassis portion 1101. In other examples, each of the one or more clips 1102 may be removably attached to the chassis portion 1102, for example with a removable pin 1104 or removable snap fit.

Each of the clips 1102 may be formed from a different material to chassis portion 1101 or may be formed from the same material. In some examples the clips 1102 are formed from a thermoplastic material (e.g. Acrylonitrile Butadiene Styrene (ABS), polyethylene (PE), polycarbonate (PC), nylon etc). In other examples, the clips 1102 are formed from metal (e.g. aluminium, stainless steel, spring steel, etc). In some examples the clips 1102 are formed from magnets and are configured to magnetically attach to corresponding magnets or ferromagnetic material provided to the display unit housing 1205.

In some examples, the chassis portion 1101 is formed from a different material to the face engaging portion 1110. The chassis portion 1101 is stiffer than the face engaging portion 1110 in the examples shown in FIGS. 11-14. The chassis portion 1101 may be formed from a thermoplastic material, e.g. ABS, PE, PC, nylon or the like. The face engaging portion 1110 may be formed from elastomeric and/or foam material(s), as described elsewhere. The chassis portion 1101 may function at least as a chassis for the face engaging portion 1110, such as by providing a supportive structure. The face engaging portion 1110 may be flexible, soft, and/or compressible, as described elsewhere. The chassis portion 1101 may hold the face engaging portion 1110 in a shape ready for comfortable, stable and effective (e.g. light blocking) engagement with the user's face and help hold it in good engagement with the user's face in use, even during vigorous head movements.

The interfacing structure 1100 may comprise any number of clips 1102, such as one, two, three, four or more. In some examples the interfacing structure 1100 may also comprise other components or portions that may work together with one or more clips 1102 to attach the interfacing structure 1100 to a display unit housing 1205 or other component of the head-mounted display unit 1200.

In the examples shown in FIGS. 11-14, the interfacing structure 1100 comprises a plurality of clip attachment assemblies. Each clip attachment assembly comprising a clip attachment portion and a respective clip 1102 attached to the clip attachment portion. An interfacing structure 1100 may comprise any number of clip attachment assemblies, such as one, two, three, four or more. Each clip 1102 may attach to the chassis portion 1101 as part of a clip attachment assembly.

FIGS. 12 and 14 show cross section views of interfacing structures 1100, each view being through a clip attachment assembly located in a superior portion of the respective interfacing structure 1100 (e.g. a portion configured to engage the user's forehead). In each of these examples, in each clip attachment assembly, the clip attachment portion comprises a clip receptacle 1103 configured to receive the clip therein. In these examples the clip receptacle 1103 may form a female portion of the clip attachment assembly and the clip 1102 may form a male portion. In other examples the configuration may be reversed and the clip attachment portion may form a male portion and the clip 1102 may form a female portion of the assembly.

With reference to the example shown in FIGS. 11-13, in each clip attachment assembly, each clip 1102 is attached to the clip attachment portion by a pin 1104. In particular, in each clip attachment assembly, the pin 1104 is located through a hole in the chassis portion 1101 and through a hole 1106 in the clip 1102. The clip 1102 and/or pin 1104 may also be glued to the chassis portion 1101, for example to prevent inadvertent disassembly of the clip attachment assembly. The clip receptacle 1103 in this example comprises a complementary shape to that of the portion of the clip 1102 that is received in the clip receptacle 1103. The clip receptacle 1103 may also comprise a larger size than the clip 1102 in one or more dimensions provided the clip 1102 is nevertheless able to be received in the clip receptacle 1103 and attached to the chassis portion 1101.

In each of the examples shown in FIGS. 11-14, each clip 1102 comprises a first barb 1107 configured to form a snap fit connection to the display unit housing 1205. In other examples, the barb 1107 may be replaced with another suitable snap fit feature at the end of the clip 1102, which may be selected based on how permanent the snap fit connection is intended to be, or for any other reason. It is to be understood that any suitable snap fit feature may be provided to the clip 1102 in place of or in addition to the barb 1107. As shown in FIG. 14, in this example the clip 1102 also comprises a second barb 1107 configured to form a snap fit connection to the chassis portion 1101. That is, the clip 1102 snap fits to both the chassis portion 1101 and the display unit housing 1205 (either permanently or removably).

The interfacing structure 1100 may comprise any number of clips 1102. For example, the interfacing structure 1100 may comprise at least one clip 1102 attached in use to a superior portion of the chassis portion 1101 and at least one clip 1102 attached in use to an inferior portion of the chassis portion 1101. In the example shown in FIG. 11, the interfacing structure 1100 comprises a pair of clips 1102 attached in use to a superior portion of the chassis portion 1101 (e.g. in a forehead portion) and a pair of clips 1102 attached in use to an inferior portion of the chassis portion 1101 (e.g. at cheek portions). In other examples, the interfacing structure 1100 may comprise clips 1102 at lateral portions of the interfacing structure 1100, such as at sphenoid portions of the interfacing structure 1100.

In the examples shown in FIGS. 11-14, the face engaging portion 1110 comprises a face engaging membrane 1114. The face engaging membrane 1114 is overmoulded to the chassis portion 1101 in these examples, although in other examples may be glued or may be removably attached, e.g. by way of a press fit. In these examples the face engaging membrane 1114 is formed from an elastomeric material, such as silicone or a thermoplastic elastomer. Furthermore, in these particular examples, the face engaging portion 1110 comprises a cushion 1130. The face engaging membrane 1114 is shaped in transverse cross section (e.g. the cross sections shown in FIGS. 12 and 14, transverse to the length of the face engaging portion 1110 around the periphery of the user's eye region) to curl at least partially around the cushion 1130. The cushion 1130 is formed from foam in these examples but may alternatively be formed from gel, silicone, a structure defining a sealed volume of air to function as a cushion, or the like. The face engaging membrane 1114 in these examples at least partially encases the cushion 1130. The face engaging membrane 1114 may form a face contacting region configured to contact the user's face in use. Alternatively, the face engaging membrane 1114 or more generally the face engaging portion 1110 may be as described elsewhere herein.

### 5.5 Cleaning

In some forms, the head-mounted display system 1000 or at least a portion thereof, is designed to be used by a single user, and cleaned in a home of the user, e.g., washed in soapy water, without requiring specialised equipment for disinfection and sterilisation. Specifically, the positioning and stabilizing structure 1300 and the interfacing structure 1100 are designed to be cleaned, as they are both in direct contact with the user's head.

In some other forms, the components of the positioning and stabilizing structure 1300 and interfacing structure 1100 are used in labs, clinics and hospitals wherein a single head-mounted display may be reused on multiple persons or used during medical procedures. In each of the labs, clinics and hospitals the head-mounted displays, or relevant components thereof, can be reprocessed and be exposed to, for example, processes of thermal disinfection, chemical disinfection and sterilisation. As such, the design of the positioning and stabilizing structure and interfacing structure may need to be validated for disinfection and sterilisation of the mask in accordance with ISO17664.

Materials may be chosen to withstand reprocessing. For example, robust materials may be used in the positioning and stabilizing structure 1300 to withstand exposure to high level disinfection solutions and agitation with a brush. Further, some components of the positioning and stabilizing structure are separable, and in-use may be disconnected to improve the reprocessing efficacy.

In some examples, the interfacing structure 1100 may, in use, be in contact with the user's head and therefor may become dirty (e.g., from sweat). The interfacing structure 1100 may be designed to be removed from the display unit housing 1205, to provide the ability to remove it for cleaning and/or replacement. It may be desirable to wash the interfacing structure 1100 while not getting the positioning and stabilizing structure 1300 wet. Alternatively or in addition, the positioning and stabilizing structure 1300 may be dirty from contact with the user's head, and may be removed for cleaning and/or replacement independently of the interfacing structure 1100. In either case, this may be facilitated by allowing these components to disconnect for such a purpose.

In some examples, a cover (e.g., constructed from a textile, silicone, etc.) may be removably positioned over the interfacing structure and can be removed to be cleaned and/or replaced after each use. The cover may allow the interface structure 1200 to remain fixed to the display unit housing 1205, and still provide a surface that can be easily cleaned after being used.

In some forms, the overlap of the cushion attachment portion 1120 and the cushion support flange 1164 may limit cleaning fluids from contacting the glue 1124 and/or the cushion 1130 during the cleaning process.

### 5.6 External Computer

In some forms, the head-mounted display system 1000 (e.g., VR, AR, and/or MR) may be used in conjunction with a separate device, like a computer or video game console. For example, the display interface may be electrically connected to the separate device.

In some forms, at least some processing for the head-mounted display system 1000 may be performed by the separate device. The separate device may include a larger and/or more powerful processor than could be comfortably supported by the user (e.g., the processor of the separate device may be too heavy for the user to comfortably support on their head).

### 6 GLOSSARY

For the purposes of the present technology disclosure, in certain forms of the present technology, one or more of the following definitions may apply. In other forms of the present technology, alternative definitions may apply.

### 6.1 General

Ambient: In certain forms of the present technology, the term ambient will be taken to mean (i) external of the display interface and/or user, and (ii) immediately surrounding the display interface and/or user.

For example, ambient light with respect to a display interface may be the light immediately surrounding the user, e.g. the light in the same and/or adjacent room as a user, and/or natural light from the sun.

In certain forms, ambient (e.g., acoustic) noise may be considered to be the background noise level in the room where a user is located, other than for example, noise generated by the display device or emanating from speakers connected to the display device. Ambient noise may be generated by sources outside the room.

Leak: The word leak will be taken to be an unintended exposure to light. In one example, leak may occur as the result of an incomplete seal between a display unit and a users' face.

Noise, radiated (acoustic): Radiated noise in the present document refers to noise which is carried to the user by the ambient air. In one form, radiated noise may be quantified by measuring sound power/pressure levels of the object in question according to ISO 3744.

User: A person operating the display interface and/or viewing images provided by the display interface. For example, the person may be wearing, donning, and/or doffing the display interface.

### 6.1.1 Materials

Silicone or Silicone Elastomer: A synthetic rubber. In this specification, a reference to silicone is a reference to liquid silicone rubber (LSR) or a compression moulded silicone rubber (CMSR). One form of commercially available LSR is SILASTIC (included in the range of products sold under this trademark), manufactured by Dow Corning. Another manufacturer of LSR is Wacker. Unless otherwise specified to the contrary, an exemplary form of LSR has a Shore A (or Type A) indentation hardness in the range of about 35 to about 45 as measured using ASTM D2240

Polycarbonate: a thermoplastic polymer of Bisphenol-A Carbonate.

### 6.1.2 Mechanical Properties

Resilience: Ability of a material to absorb energy when deformed elastically and to release the energy upon unloading.

Resilient: Will release substantially all of the energy when unloaded. Includes e.g. certain silicones, and thermoplastic elastomers.

Hardness: The ability of a material per se to resist deformation (e.g. described by a Young's Modulus, or an indentation hardness scale measured on a standardised sample size).
‘Soft’ materials may include silicone or thermo-plastic elastomer (TPE), and may, e.g. readily deform under finger pressure.
‘Hard’ materials may include polycarbonate, polypropylene, steel or aluminium, and may not e.g. readily deform under finger pressure.

Stiffness (or rigidity) of a structure or component: The ability of the structure or component to resist deformation in response to an applied load. The load may be a force or a moment, e.g. compression, tension, bending or torsion. The structure or component may offer different resistances in different directions. The inverse of stiffness is flexibility.

Floppy structure or component: A structure or component that will change shape, e.g. bend, when caused to support its own weight, within a relatively short period of time such as 1 second.

Rigid structure or component: A structure or component that will not substantially change shape when subject to the loads typically encountered in use. An example of such a use may be setting up and maintaining a user interface in sealing relationship.

As an example, an I-beam may comprise a different bending stiffness (resistance to a bending load) in a first direction in comparison to a second, orthogonal direction. In another example, a structure or component may be floppy in a first direction and rigid in a second direction.

### 6.2 Materials

Closed-cell foam: Foam comprising cells that are completely encapsulated, i.e. closed cells.

Elastane: A polymer made from polyurethane.

Elastomer: A polymer that displays elastic properties. For example, silicone elastomer.

Ethylene-vinyl acetate (EVA): A copolymer of ethylene and vinyl acetate.

Fiber: A filament (mono or poly), a strand, a yarn, a thread or twine that is significantly longer than it is wide. A fiber may include animal-based material such as wool or silk, plant-based material such as linen and cotton, and synthetic material such as polyester and rayon. A fiber may specifically refer to a material that can be interwoven and/or interlaced (e.g., in a network) with other fibers of the same or different material.

Foam: Any material, for example polyurethane, having gas bubbles introduced during manufacture to produce a lightweight cellular form.

Neoprene: A synthetic rubber that is produced by polymerization of chloroprene. Neoprene is used in trade products: Breath-O-Prene.

Nylon: A synthetic polyamide that has elastic properties and can be used, for example, to form fibres/filaments for use in textiles.

Open-cell foam: Foam comprising cells, i.e. gas bubbles that aren't completely encapsulated, i.e. open cells.

Polycarbonate: a typically transparent thermoplastic polymer of Bisphenol-A Carbonate.

Polyethylene: A thermoplastic that is resistant to chemicals and moisture.

Polyurethane (PU): A plastic material made by copolymerizing an isocyanate and a polyhydric alcohol and, for example, can take the form of foam (polyurethane foam) and rubber (polyurethane rubber).

Semi-open foam: Foam comprising a combination of closed and open (encapsulated) cells.

Silicone or Silicone Elastomer: A synthetic rubber. In this specification, a reference to silicone is a reference to liquid silicone rubber (LSR) or a compression moulded silicone rubber (CMSR). One form of commercially available LSR is SILASTIC (included in the range of products sold under this trademark), manufactured by Dow Corning. Another manufacturer of LSR is Wacker. Unless otherwise specified to the contrary, an exemplary form of LSR has a Shore A (or Type A) indentation hardness in the range of about 35 to about 45 as measured using ASTM D2240.

Spacer Fabric: A composite construction comprised of two outer textile substrates joined together and kept apart by an intermediate layer of monofilaments.

Spandex: An elastic fibre or fabric, primarily comprised of polyurethane. Spandex is used in trade products: Lycra.

Textile: A material including at least one natural or artificial fiber. In this specification, a textile may refer to any material that is formed as a network of interwoven and/or interlaced fibers. A type of textile may include a fabric, which is constructed by interlacing the fibers using specific techniques. These include weaving, knitting, crocheting, knotting, tatting, tufting, or braiding. Cloth may be used synonymously with fabric, although may specifically refer to a processed piece of fabric. Other types of textiles may be constructed using bonding (chemical, mechanical, heat, etc.), felting, or other nonwoven processes. Textiles created through one of these processes are fabric-like, and may be considered synonymous with fabric for the purposes of this application.

Thermoplastic Elastomer (TPE): Are generally low modulus, flexible materials that can be stretched at room temperature with an ability to return to their approximate original length when stress is released. Trade products that use TPE include: Hytrel, Dynaflex, Medalist

Thermoplastic Polyurethane (TPU): A thermoplastic elastomer with a high durability and flexibility.

### 6.3 Mechanical Properties

Resilience: Ability of a material to absorb energy when deformed elastically and to release the energy upon unloading.

Resilient: Will release substantially all of the energy when unloaded. Includes e.g. certain silicones, and thermoplastic elastomers.

Hardness: The ability of a material per se to resist deformation (e.g. described by a Young's Modulus, or an indentation hardness scale measured on a standardised sample size).
‘Soft’ materials may include silicone or thermo-plastic elastomer (TPE), and may, e.g. readily deform under finger pressure.
‘Hard’ materials may include polycarbonate, polypropylene, steel or aluminium, and may not e.g. readily deform under finger pressure.

Stiffness (or rigidity) of a structure or component: The ability of the structure or component to resist deformation in response to an applied load. The load may be a force or a moment, e.g. compression, tension, bending or torsion. The structure or component may offer different resistances in different directions.

Floppy structure or component: A structure or component that will change shape, e.g. bend, when caused to support its own weight, within a relatively short period of time such as 1 second.

Rigid structure or component: A structure or component that will not substantially change shape when subject to the loads typically encountered in use. As an example, an I-beam may comprise a different bending stiffness (resistance to a bending load) in a first direction in comparison to a second, orthogonal direction. In another example, a structure or component may be floppy in a first direction and rigid in a second direction.

### 6.4 Anatomy

The following definitions correspond to selected references identified in FIGS. 1-2.

### 6.4.1 Anatomy of the Face

Ala: the external outer wall or “wing” of each nostril (plural: alar)

Bridge (nasal): The nasal bridge is the midline prominence of the nose, extending from the Sellion to the Pronasale.

Frankfort horizontal plane: A line extending from the most inferior point of the orbital margin to the left tragion. The tragion is the deepest point in the notch superior to the tragus of the auricle.

Nares (Nostrils): Approximately ellipsoidal apertures forming the entrance to the nasal cavity. The singular form of nares is naris (nostril). The nares are separated by the nasal septum.

Pronasale: the most protruded point or tip of the nose, which can be identified in lateral view of the rest of the portion of the head.

Ridge (nasal): The nasal ridge is the midline prominence of the nose, extending from the Sellion to the Pronasale.

Sagittal plane: A vertical plane that passes from anterior (front) to posterior (rear). The midsagittal plane is a sagittal plane that divides the body into right and left halves.

Sellion: Located on the soft tissue, the most concave point overlying the area of the frontonasal suture.

### 6.4.2 Anatomy of the Skull

Frontal bone: The frontal bone includes a large vertical portion, the squama frontalis, corresponding to the region known as the forehead.

Occipital bone: The occipital bone is situated at the back and lower part of the cranium. It includes an oval aperture, the foramen magnum, through which the cranial cavity communicates with the vertebral canal. The curved plate behind the foramen magnum is the squama occipitalis.

Parietal bones: The parietal bones are the bones that, when joined together, form the roof and sides of the cranium.

Sphenoid bone: A wedge shaped bone of the base of the cranium.

Temporal bones: The temporal bones are situated on the bases and sides of the skull, and support that part of the face known as the temple.

Zygomatic bones: The face includes two zygomatic bones, located in the upper and lateral parts of the face and forming the prominence of the cheek.

### 6.5 User Interface

Frame: Frame will be taken to mean a display housing unit that bears the load of tension between two or more points of connection with a headgear and/or a hoop. The frame may seal against the user's face in order to limit and/or prevent the ingress and/or egress of light.

Hoop: Hoop will be taken to mean a form of positioning and stabilizing structure designed for use on a head. For example the hoop may comprise a collection of one or more struts, ties and stiffeners configured to locate and retain a user interface in position on a users' face for holding a display unit in an operational position in front of a user's face. Some ties are formed of a soft, flexible, elastic material such as a laminated composite of foam and fabric/textile. In some forms, the term headgear may be synonymous with the term hoop.

Membrane: Membrane will be taken to mean a typically thin element that has, preferably, substantially no resistance to bending, but has resistance to being stretched.

Seal: May be a noun form (“a seal”) which refers to a structure, or a verb form (“to seal”) which refers to the effect. Two elements may be constructed and/or arranged to ‘seal’ or to effect ‘sealing’ therebetween without requiring a separate ‘seal’ element per se.

Shell: A shell will be taken to mean a curved, relatively thin structure having bending, tensile and compressive stiffness. For example, a curved structural wall of a mask may be a shell. In some forms, a shell may be faceted. In some forms a shell may be airtight. In some forms a shell may not be airtight.

Stiffener: A stiffener will be taken to mean a structural component designed to increase the bending resistance of another component in at least one direction.

Strut: A strut will be taken to be a structural component designed to increase the compression resistance of another component in at least one direction.

Swivel (noun): A subassembly of components configured to rotate about a common axis, preferably independently, preferably under low torque. In one form, the swivel may be constructed to rotate through an angle of at least 360 degrees. In another form, the swivel may be constructed to rotate through an angle less than 360 degrees.

Tie (noun): A structure designed to resist tension.

### 6.6 Shape of Structures

Products in accordance with the present technology may comprise one or more three-dimensional mechanical structures, for example a mask cushion or an impeller. The three-dimensional structures may be bounded by two-dimensional surfaces. These surfaces may be distinguished using a label to describe an associated surface orientation, location, function, or some other characteristic. For example a structure may comprise one or more of an anterior surface, a posterior surface, an interior surface and an exterior surface. In another example, a seal-forming structure may comprise a face-contacting (e.g. outer) surface, and a separate non-face-contacting (e.g. underside or inner) surface. In another example, a structure may comprise a first surface and a second surface.

To facilitate describing the shape of the three-dimensional structures and the surfaces, we first consider a cross-section through a surface of the structure at a point, p. See FIG. 3A to FIG. 3E, which illustrate examples of cross-sections at point p on a surface, and the resulting plane curves. FIGS. 3A to 3E also illustrate an outward normal vector at p. The outward normal vector at p points away from the surface. In some examples we describe the surface from the point of view of an imaginary small person standing upright on the surface.

### 6.6.1 Curvature in One Dimension

The curvature of a plane curve at p may be described as having a sign (e.g. positive, negative) and a magnitude (e.g. 1/radius of a circle that just touches the curve at p).

Positive curvature: If the curve at p turns towards the outward normal, the curvature at that point will be taken to be positive (if the imaginary small person leaves the point p they must walk uphill). See FIG. 3A (relatively large positive curvature compared to FIG. 3B) and FIG. 3B (relatively small positive curvature compared to FIG. 3A). Such curves are often referred to as concave.

Zero curvature: If the curve at p is a straight line, the curvature will be taken to be zero (if the imaginary small person leaves the point p, they can walk on a level, neither up nor down). See FIG. 3C.

Negative curvature: If the curve at p turns away from the outward normal, the curvature in that direction at that point will be taken to be negative (if the imaginary small person leaves the point p they must walk downhill). See FIG. 3D (relatively small negative curvature compared to FIG. 3E) and FIG. 3E (relatively large negative curvature compared to FIG. 3F). Such curves are often referred to as convex.

### 6.6.2 Curvature of Two Dimensional Surfaces

A description of the shape at a given point on a two-dimensional surface in accordance with the present technology may include multiple normal cross-sections. The multiple cross-sections may cut the surface in a plane that includes the outward normal (a “normal plane”), and each cross-section may be taken in a different direction. Each cross-section results in a plane curve with a corresponding curvature. The different curvatures at that point may have the same sign, or a different sign. Each of the curvatures at that point has a magnitude, e.g. relatively small. The plane curves in FIGS. 3A to 3E could be examples of such multiple cross-sections at a particular point.

Principal curvatures and directions: The directions of the normal planes where the curvature of the curve takes its maximum and minimum values are called the principal directions. In the examples of FIG. 3A to FIG. 3E, the maximum curvature occurs in FIG. 3A, and the minimum occurs in FIG. 3E, hence FIG. 3A and FIG. 3E are cross sections in the principal directions. The principal curvatures at p are the curvatures in the principal directions.

Region of a surface: A connected set of points on a surface. The set of points in a region may have similar characteristics, e.g. curvatures or signs.

Saddle region: A region where at each point, the principal curvatures have opposite signs, that is, one is positive, and the other is negative (depending on the direction to which the imaginary person turns, they may walk uphill or downhill).

Dome region: A region where at each point the principal curvatures have the same sign, e.g. both positive (a “concave dome”) or both negative (a “convex dome”).

Cylindrical region: A region where one principal curvature is zero (or, for example, zero within manufacturing tolerances) and the other principal curvature is non-zero.

Planar region: A region of a surface where both of the principal curvatures are zero (or, for example, zero within manufacturing tolerances).

Edge of a surface: A boundary or limit of a surface or region.

Path: In certain forms of the present technology, ‘path’ will be taken to mean a path in the mathematical—topological sense, e.g. a continuous space curve from f(0) to f(1) on a surface. In certain forms of the present technology, a ‘path’ may be described as a route or course, including e.g. a set of points on a surface. (The path for the imaginary person is where they walk on the surface, and is analogous to a garden path).

Path length: In certain forms of the present technology, ‘path length’ will be taken to mean the distance along the surface from f(0) to f(1), that is, the distance along the path on the surface. There may be more than one path between two points on a surface and such paths may have different path lengths. (The path length for the imaginary person would be the distance they have to walk on the surface along the path).

Straight-line distance: The straight-line distance is the distance between two points on a surface, but without regard to the surface. On planar regions, there would be a path on the surface having the same path length as the straight-line distance between two points on the surface. On non-planar surfaces, there may be no paths having the same path length as the straight-line distance between two points. (For the imaginary person, the straight-line distance would correspond to the distance ‘as the crow flies’.)

### 6.6.3 Holes

A surface may have a one-dimensional hole, e.g. a hole bounded by a plane curve or by a space curve. Thin structures (e.g. a membrane) with a hole, may be described as having a one-dimensional hole. See for example the one dimensional hole in the surface of structure shown in FIG. 3F, bounded by a plane curve.

A structure may have a two-dimensional hole, e.g. a hole bounded by a surface. For example, an inflatable tyre has a two dimensional hole bounded by the interior surface of the tyre. In another example, a bladder with a cavity for air or gel could have a two-dimensional hole. In a yet another example, a conduit may comprise a one-dimension hole (e.g. at its entrance or at its exit), and a two-dimension hole bounded by the inside surface of the conduit. See also the two dimensional hole through the structure shown in FIG. 3H, bounded by a surface as shown.

### 6.7 Other Remarks

A portion of the disclosure of this patent document contains material which is subject to copyright protection. The copyright owner has no objection to the facsimile reproduction by anyone of the patent document or the patent disclosure, as it appears in Patent Office patent files or records, but otherwise reserves all copyright rights whatsoever.

Unless the context clearly dictates otherwise and where a range of values is provided, it is understood that each intervening value, to the tenth of the unit of the lower limit, between the upper and lower limit of that range, and any other stated or intervening value in that stated range is encompassed within the technology. The upper and lower limits of these intervening ranges, which may be independently included in the intervening ranges, are also encompassed within the technology, subject to any specifically excluded limit in the stated range. Where the stated range includes one or both of the limits, ranges excluding either or both of those included limits are also included in the technology.

Furthermore, where a value or values are stated herein as being implemented as part of the technology, it is understood that such values may be approximated, unless otherwise stated, and such values may be utilized to any suitable significant digit to the extent that a practical technical implementation may permit or require it.

Unless defined otherwise, all technical and scientific terms used herein have the same meaning as commonly understood by one of ordinary skill in the art to which this technology belongs. Although any methods and materials similar or equivalent to those described herein can also be used in the practice or testing of the present technology, a limited number of the exemplary methods and materials are described herein.

When a particular material is identified as being used to construct a component, obvious alternative materials with similar properties may be used as a substitute. Furthermore, unless specified to the contrary, any and all components herein described are understood to be capable of being manufactured and, as such, may be manufactured together or separately.

It must be noted that as used herein and in the appended claims, the singular forms “a”, “an”, and “the” include their plural equivalents, unless the context clearly dictates otherwise.

All publications mentioned herein are incorporated herein by reference in their entirety to disclose and describe the methods and/or materials which are the subject of those publications. The publications discussed herein are provided solely for their disclosure prior to the filing date of the present application. Nothing herein is to be construed as an admission that the present technology is not entitled to antedate such publication by virtue of prior invention. Further, the dates of publication provided may be different from the actual publication dates, which may need to be independently confirmed.

The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The subject headings used in the detailed description are included only for the ease of reference of the reader and should not be used to limit the subject matter found throughout the disclosure or the claims. The subject headings should not be used in construing the scope of the claims or the claim limitations.

Although the technology herein has been described with reference to particular examples, it is to be understood that these examples are merely illustrative of the principles and applications of the technology. In some instances, the terminology and symbols may imply specific details that are not required to practice the technology. For example, although the terms “first” and “second” may be used, unless otherwise specified, they are not intended to indicate any order but may be utilised to distinguish between distinct elements. Furthermore, although process steps in the methodologies may be described or illustrated in an order, such an ordering is not required. Those skilled in the art will recognize that such ordering may be modified and/or aspects thereof may be conducted concurrently or even synchronously.

It is therefore to be understood that numerous modifications may be made to the illustrative examples and that other arrangements may be devised without departing from the spirit and scope of the technology.

1. An interfacing structure for a head-mounted display system, the interfacing structure configured to attach to a display unit housing of the head-mounted display system comprising a display, the interfacing structure comprising:
a face engaging portion constructed and arranged to engage a user's face around a periphery of the user's eye region in use;
a chassis portion constructed and arranged to support the face engaging portion and constructed and arranged to connect to the display unit housing of the head-mounted display system,
wherein interfacing structure comprises a pair of cheek portions constructed and arranged to engage the user's cheeks in use, a pair of sphenoid portions constructed and arranged to engage sphenoid regions of the user's head in use, and a forehead portion constructed and arranged to engage the user's forehead in use;
wherein the chassis portion defines at least one opening positioned around the periphery of the user's eye region within the user's field of view;
wherein the interfacing structure is constructed and arranged to be convertible between:
a non-immersive mode in which the user is able to see through the opening; and
an immersive mode in which light is substantially prevented from passing through the opening.

2. The interfacing structure of claim 1, wherein the interfacing structure comprises at least one shield constructed and arranged to block light through the at least one opening, the shield being able to be manipulated by the user to convert the interfacing structure to the non-immersive mode by substantially unblocking the opening and convert the interfacing structure to the immersive mode by substantially blocking the opening.

3. The interfacing structure of claim 2, wherein the shield is attachable to the chassis portion to convert the interfacing structure to the immersive mode, and the shield is removable from the chassis portion to convert the interfacing structure to the non-immersive mode.

4. The interfacing structure of claim 3, wherein the chassis portion and shield are constructed and arranged so that the shield is magnetically attracted to the chassis portion.

5. The interfacing structure of claim 2, wherein the shield comprises at least one grip portion to aid gripping of the shield by the user, wherein the grip portion is at least partially formed by a vent constructed and arranged to allow airflow through the opening when the interfacing structure is in the immersive mode.

6. The interfacing structure of claim 2, wherein the shield comprises at least one vent constructed and arranged to allow airflow through the opening when the interfacing structure is in the closed configuration, wherein the interfacing structure comprises a vent cover portion constructed and arranged to block light through the at least one vent.

7. The interfacing structure of claim 2, wherein the shield and the chassis portion together define at least one vent opening between the chassis portion and an edge of the shield in the closed configuration, the at least one vent opening forming the at least one vent.

8. The interfacing structure of claim 7, wherein the shield and the chassis portion together form a tortuous path in the closed configuration to allow airflow through the vent while blocking light.

9. The interfacing structure of claim 8, wherein the shield comprises at least one shield protrusion protruding towards the chassis portion to at least partially form the tortuous path, and the chassis portion comprises at least one chassis protrusion protruding towards the shield to at least partially form the tortuous path.

10. The interfacing structure of claim 2, wherein the at least one opening comprises a group of openings, the shield constructed and arranged to block light through the group of openings.

11. The interfacing structure of claim 10, wherein the chassis portion comprises one or more bars, each of the one or more bars positioned between and partially defining the openings of the group of openings.

12. The interfacing structure of claim 2, wherein the shield comprises a curtain attached to the chassis portion, at least a portion of the curtain being slidable with respect to the chassis portion to substantially block the opening during conversion of the interfacing structure to the immersive mode and substantially unblock the opening during conversion of the interfacing structure to the non-immersive mode.

13. The interfacing structure of claim 2, wherein the shield is slidable with respect to the chassis portion and is constructed and arranged to be moved to substantially block the opening during conversion of the interfacing structure to the immersive mode and substantially unblock the opening during conversion of the interfacing structure to the non-immersive mode.

14. The interfacing structure of claim 2, wherein the shield comprises one or more rotatable portions rotatably connected to the chassis portion, the one or more rotatable portions being rotatable to a closed configuration to convert the interfacing structure to the immersive mode, and the one or more rotatable portions being rotatable to an open configuration to convert the interfacing structure to the non-immersive mode.

15. The interfacing structure of claim 2, wherein the shield comprises a hinged door openable to convert the interfacing structure to the non-immersive mode and closeable to convert the interfacing structure to the immersive mode.

16. The interfacing structure of claim 1, wherein the opening is filled by an electronic screen, the screen being controllable to be opaque in the immersive mode and substantially transparent in the non-immersive mode.

17. The interfacing structure of claim 1, wherein the at least one opening is located in the forehead portion of the interfacing structure.

18. The interfacing structure of claim 1, wherein the at least one opening comprises a pair of openings each located in a respective one of the sphenoid portions and/or a pair of openings each located in a respective one of the cheek portions.

19. The interfacing structure of claim 1, wherein the at least one opening comprises a lower left opening and a lower right opening, the lower left opening being located in a left cheek portion of the cheek portions and a left sphenoid portion of the sphenoid portions, the lower right opening being located in a right cheek portion of the cheek portions and a right sphenoid portion of the sphenoid portions.

20. The interfacing structure of claim 1, wherein there is no opening in the chassis portion of the interfacing structure superior to the user's eyes.
